(19) United States
(12) Patent Application Publication
(10) Pub. No.: US 2025/0083107 A1
(43) Pub. Date: Mar. 13, 2025

(54) Energy Efficient Reverse Osmosis Filtration

(71) Applicant: DD FILTER SOLUTIONS, INC., Dover, DE (US)

(72) Inventor: Daniel J. DU TOIT, Dover, DE (US)

(21) Appl. No.: 16/971,167

(22) PCT Filed: Feb. 19, 2019
(86) PCT No.: PCT/US19/18507

§ 371 Date: Aug. 19, 2020

Related U.S. Application Data
(60) Provisional application No. 62/632,163, filed on Feb. 19, 2018.

(51) Int. Cl. B01D 63/06; B01D 61/02; B01D 61/08; B01D 67/00; B01D 69/02; C02F 1/44; C02F 103/08

(52) U.S. Cl. CPC B01D 63/065; B01D 61/025; B01D 61/08; B01D 67/00933; B01D 69/02; C02F 1/441; B01D 2325/0283; B01D 2325/04; B01D 2325/24; C02F 2103/08

(57) ABSTRACT

The present disclosure provides a reverse osmosis filter elements for separating components of a fluid mixture. The filter elements comprise self-supporting membrane vanes comprising porous supporting strips and at least one reverse osmosis membrane layer laminated thereon. These filter elements have a permeate flow channel between the inner surface of the two porous supporting strips and an open feed water flow channel dispersed around the membrane vane. These filter elements can be used in new and existing filtration plants, such as desalination systems, and have a wide range of advantages over the spiral wound filter elements currently available.

### TECHNICAL FIELD

The invention relates generally to filter elements and energy efficient filtration methods and systems using them.

### BACKGROUND

Reverse osmosis is a membrane filtration processes which is used to remove salts and organic micro-pollutants from water. Because reverse osmosis is able to remove very small particles from water, fouling of the membrane easily occurs. Therefore, it is preceded by a pretreatment step to remove particulate matter such as solids, cationic surfactants, chlorides and other strong oxidizers, and organic solvents. This pretreatment can be a conventional pretreatment (coagulation, flocculation, sedimentation, and filtration) or an ultrafiltration pretreatment. In reverse osmosis, almost all dissolved particles present in the water will be retained in the concentrate, leaving the permeate (product water) with a low mineral content. Therefore, the permeate is often put through a post treatment system (limestone filtration or aeration), to correct the pH and the aggressiveness of the permeate.

The fouling of a reverse osmosis membrane is almost inevitable. Particulate matter will be retained and is an ideal nutrient for biomass, resulting in bio-fouling. Another important fouling process is scaling, the formation of salt precipitates. Both fouling processes (scaling and bio-fouling) should be avoided as much as possible to efficiently operate reverse osmosis systems.

The majority of reverse osmosis membranes are of the spiral-wound configuration. Water is fed from one side into a module via spacers (supporting layers between membrane sheets), and distributed over a membrane element. An element is a number of membrane sheets twisted around a central permeate collecting tube.

The length of a membrane element is typically one meter, which can be replaced by a single person. After passing one element, the water flows to additional elements. To withstand the high operating pressures, a pressure vessel (membrane module) is used. It is not economically feasible to have a pressure vessel for every element, therefore six to eight elements are generally placed in series within one membrane module or pressure vessel. With the current design and two-pass RO process, the number of filtration modules range from 3,500 to 18,000 RO elements for plants with capacities of 25,000 to 250,000 m³/day.

Desalination has long been confined by steep costs and environmental concerns and has therefore been a difficult choice to make when it comes to producing fresh drinking water from salt water for communities so in need, with that need growing larger and larger every year. From an environmental perspective, the main concerns about desalination are two-fold. First, desalination requires a considerable amount of power. To remove salt, water is pumped through reverse osmosis filter elements at very high pressure. Doing this with thousands of gallons of water per minute requires tremendous amounts of energy. It can cost up to $25,000 worth of electricity per month to produce enough water for 1200 homes. Second, a by-product of desalination is brine which essentially is all salt, but is concentrated into half as much water. This makes it denser than ocean water and hard to mix back in. If not done correctly, it can be deadly to sea life.

It is extremely expensive to build desalination plants due to land requirements, the length of time it takes complete the plant, time required to obtain permits, and, finally, the high operating costs due not only to the energy required to produce the water but the regular replacement of the filter elements, hence the downtime of a plant over its lifecycle.

In addition, large regions across America are experiencing severe drought and water shortages due to a lack of rainfall. Due to the larger concern of climate change and increasing population growth, 10 to 20 years from now fresh water river systems may no longer be able to supply populations with enough fresh water either. Looking abroad, global climate change impact is becoming a threat for coastal urban inhabitants who rely on their surface and ground water as their drinking supply. With rising sea levels, the drinking water is degrading and in some areas completely unsafe to drink, due to the high salinity intrusion.

Disruptions or excursions in formal filter plant operations can result membrane damage and shortened membrane life. Failure mechanisms include chemical instability of substrate, pH instability of selected layer, oxidation by chlorine, membrane delamination, abrupt pressure changes and pressure cycling seal failure at elevated temperatures, irreversible membrane fouling and damage from dehydration. Desalination membranes can encounter all of the above failure mechanisms. Therefore, there are standard practices that are followed for membrane installation commissioning and operation. If these protocols are not followed or there are uncontrolled excursions during operation, membrane damage or failure can occur.

In membrane filtration processes, three different types of flow are distinguished. The feed flow is separated by the membrane into permeate (or product) flow and into concentrate (or filtration process) flow. The salt concentration in the permeate flow is lower than the salt concentration in the feed flow. In the concentrate flow the salt concentration is higher than in the feed flow. It is not possible to have an unlimited concentration of salts in the concentrate flow, because at certain salt concentrations precipitation of salts will occur. Reverse osmosis modules are always operated in cross-flow mode. Accordingly, only a small part of the feed flow is produced as permeate (between 1 and 10% per element), while most of the feed water flows along the membrane surface and exits the membrane element as concentrate. Because of this large concentrate flow, the velocity in the membrane channels is high and the build-up of a laminar boundary layer is disturbed.

Spiral-wound membranes have a large specific area (1000 m²/m³). A disadvantage of spiral-wound membranes is the rapid fouling of the spacer channels with particulate matter that can occur. Reverse osmosis membranes cannot be hydraulically cleaned like ultrafiltration membranes and the application of large flat membranes are not practical because of the large footprint needed to obtain the necessary permeate production. Spiral-wound membrane modules are limited in their operating temperature range due to softening and delamination or failure of tapes, glues, and seals used in their construction.

Reverse osmosis membranes generally require extensive pre-treatment of water to remove components that will damage the membranes. This includes suspended solids, cationic surfactants, chlorides and other strong oxidizers, and organic solvents.

Accordingly, more efficient and effective reverse osmosis filtration methods and systems are needed in an effort to decrease the operating costs and consumables related to industrial scale reverse osmosis filtration

### SUMMARY

Provided herein are reverse osmosis filter elements for separating a first component from a fluid mixture comprising first and second components. The filter elements comprise multiple (e.g. at least about 8) self-supporting membrane vanes attached perpendicularly to a central tube and equally spaced apart to provide a minimum hydraulic diameter of the filter element of about 2.4, each membrane vane comprising two porous supporting strips, each strip comprising a reverse osmosis membrane layer laminated thereon; a permeate flow channel between the inner surface of the two porous supporting strips; and an open feed water flow channel dispersed around the membrane vane. In one embodiment, the membrane vanes do not wind around said central tube.

Also provided are methods for preparing filter elements described herein. The methods comprise (i) applying a first reverse osmosis membrane layer to a first porous supporting strip; (ii) applying a second reverse osmosis membrane layer to a second porous supporting strip; (iii) fusing the first and second porous membrane supporting strips to form a membrane vane; and (iv) attaching the membrane vane to a central tube, wherein the membrane vane is positioned over holes on the central tube for permeate or product water.

Methods of filtering components of a fluid mixture are further provided. The methods comprise passing the fluid mixture through at least one filter element described herein in a pressure vessel. In one embodiment, the fluid mixture comprises brackish water. In another embodiment the fluid mixtures comprise salt water.

Systems for filtering a fluid mixture are also provided. The systems comprise a low-pressure pump (10), at least one pretreatment filter (12), a high-pressure pump (14), at least one filter element (16) described herein, and a vessel (18) for collecting the filtered fluid mixture.

Reverse osmosis filter element for separating a first component from a fluid mixture comprising first and second components are provided. The filter element comprises at least two membrane (filtering) vanes attached to a permeate conduit and spaced apart to provide a minimum hydraulic diameter between adjacent membrane (filtering) vanes of about 2, each membrane (filtering) vane comprising a reverse osmosis membrane layer disposed on a porous substrate, the reverse osmosis membrane oriented to be adjacent to the fluid mixture when in use. The filter element also comprises at least one permeate flow channel within each membrane (filtering) vane, the permeate flow channel disposed adjacent to the porous substrate, the permeate flow channel in fluidic communication with the permeate conduit.

Methods of generating electricity from salty water are further provided. The methods comprise (i) filtering said salty water through at least one filter element of any one of claims 1 to 29 in a pressure vessel to give rise to a permeate containing less salt than said salty water, and (ii) pumping the salty water and permeate in a reverse electrodialysis process, wherein the salty water and permeate flow under pressure through a stack of alternating cation and anion exchange membranes such that the chemical potential difference between the salty water and permeate generates an electric potential (voltage) over each membrane, wherein the total electric potential of the system is the sum of the potential differences over all membranes.

Also provided are reverse electrodialysis systems for generating electricity from salty water. The systems comprise one or more filter elements described herein disposed in a pressure vessel, wherein filtering said salty water through the pressure vessel gives rise to a permeate containing less salt than said salty water. The systems also comprises a stack of alternating cation and anion exchange membranes disposed in a reverse electrodialysis vessel, wherein pumping the salty water and permeate through the vessel gives rise to a chemical potential difference between the salty water and permeate thereby generating an electric potential (voltage) over each membrane, wherein the total electric potential of the system is the sum of the potential differences over all membranes.

The general description and the following detailed description are exemplary and explanatory only and are not restrictive of the invention, as defined in the appended claims. Other aspects of the present invention will be apparent to those skilled in the art in view of the detailed description of the invention as provided herein.

### BRIEF DESCRIPTION OF THE DRAWINGS

The summary, as well as the following detailed description, is further understood when read in conjunction with the appended drawings. For the purpose of illustrating the invention, there are shown in the drawings exemplary embodiments of the invention; however, the invention is not limited to the specific methods, compositions, and devices disclosed. In addition, the drawings are not necessarily drawn to scale. In the drawings:

FIG. 1 is a diagram illustrating a cross-sectional view of a membrane vane described herein.

FIG. 2 is a diagram illustrating three views of a membrane vane described herein.

FIG. 3 is a diagram illustrating a central pipe which is designed to contain the filter element.

FIG. 4 is a diagram illustrating the assembly of the filter elements described herein.

FIG. 5 is a diagram illustrating a pressure valve system containing the filter element and central pipe.

FIG. 6 is a diagram illustrating the assembled filtered elements shown in FIG. 4.

FIG. 7 is a diagram with two views illustrating the flow of a fluid mixture through a filter element described herein. The concentrate fluid mixture is identified by large solid arrows and permeate fluid mixture is identified by large dashed arrows. The small arrows illustrate the flow channels.

FIG. 8 is a diagram of a system described herein.

FIG. 9 is a diagram of a system of FIG. 8 which is mobile.

FIG. 10 is a diagram of an industrial scale mobile component of FIG. 8 including a concentrate recycling component.

FIG. 11 is a diagram of an industrial scale mobile component of FIG. 8 lacking a concentrate recycling component.

FIG. 12 is a line graph of the permeate recovery rate per filter element with the increase of TDS in the feed flow as a function of the operational membrane pressure (psi) for a prior art filter element (x), filter element described herein (Δ), log. for a prior art filter element ( [symbol] ), and log. for filter element described herein ( [symbol] ).

FIG. 13 is a bar/line graph the distribution of flux and salinity for five serially attached filter elements described herein (SWRO-Elements 1-5). T1-T4 refer to the different transition sections between the filter elements. The vertical bars represent the fraction of permeate generation in the pressure vessel (%). The lines represent the % fraction of permeate generation in the pressure vessel [symbol] , volume feed flow rate Q_{f}(=), cumulative permeate flow rate Q_{fresh} ( [symbol] ), cumulative pressure losses ( [symbol] ), recovery rate based on 35,621 ppm TDS and linear recovery rate based on 35,621 ppm TDS ( [symbol] ).

FIG. 14 is a line graph of the energy required to produce permeate flow using (i) a prior art filter element at low pressure (x), high pressure (♦), linear low pressure (using a filter element described herein at low pressure ( [symbol] ), or linear high pressure ( [symbol] ) and (ii) a filter element described herein at low pressure (Δ), high pressure (▪), linear low pressure ( [symbol] ), and linear high pressure ( [symbol] ).

FIGS. 15A-15C are a line/bar graphs of the operational cost comparison for a prior art filter element versus a filter element described herein for a 250,000, 133,000, and 54,000 m³/day plants. The vertical bars to the left correspond to the number of prior art filter elements and the vertical bars to the right correspond to the number of filter elements described herein. Further, the cumulative operational costs (billions US$) of the prior art filter element ( [symbol] ) and filter element described herein ( [symbol] ) are shown.

FIG. 16 is a schematic showing the assembly of the components of the filtration system described herein.

FIG. 17 is a MATLAB simulation of the feed flow through the filter element described herein.

FIG. 18 shows the prototype concept that represents the geometry of the filter element described herein.

FIG. 19 is a computerized model of the filter element showing independent membrane vanes, the central tube, pressure vessel, and end caps.

FIG. 20 is a magnified side view of a prototype filter element showing attachment of the membrane vanes to the central tube.

FIG. 21 is a front-end view of a prototype filter element showing the multitude of membrane vanes attached to the central tube.

FIG. 22 is an assembled side view of the filter element housed in a cylinder and thereby connected in series to a water source and a reverse electrodialysis instrument.

FIG. 23 is the filter element of FIG. 22 attached to the water source.

FIG. 24 is the end of the filter element of FIG. 22 attached to the water source.

FIG. 25 shows the assembly of the instrument of FIG. 22.

FIGS. 26A-26C show (i) a computerized version of the filter element as a front view along the x-axis of the central tube (A), a computerized version of the filter element as a cross-sectional side view along the x-axis (B), and block diagram of a side view along the x-axis (C).

FIG. 27 is a graph of the pressures measured in Example 10.

FIGS. 28A-28C show a prototype of the filter element as a front view along the x-axis of the central tube (A), computerized version of the filter element as a cross-sectional side view along the x-axis (B) showing the central pipe, permeate spacer, feed spaces, folded membrane, half-membrane sheet, membrane leaf, and glue line, with arrows showing the flow of the permeate and feed streams, and block diagram of a side view along the x-axis (C).

FIG. 29 is a graph of the pressures measured in Example 11.

FIG. 30 is a graph of the pressures measured in Example 12.

### DETAILED DESCRIPTION OF ILLUSTRATIVE EMBODIMENTS

The present invention may be understood more readily by reference to the following detailed description taken in connection with the accompanying figures and examples, which form a part of this disclosure. It is to be understood that this invention is not limited to the specific devices, methods, applications, conditions or parameters described and/or shown herein, and that the terminology used herein is for the purpose of describing particular embodiments by way of example only and is not intended to be limiting of the claimed invention. Also, as used in the specification including the appended claims, the singular forms “a,” “an,” and “the” include the plural, and reference to a particular numerical value includes at least that particular value, unless the context clearly dictates otherwise. The term “plurality,” as used herein, means more than one. When a range of values is expressed, another embodiment includes from the one particular value and/or to the other particular value. Similarly, when values are expressed as approximations, by use of the antecedent “about,” it will be understood that the particular value forms another embodiment. All ranges are inclusive and combinable.

It is to be appreciated that certain features of the invention which are, for clarity, described herein in the context of separate embodiments, may also be provided in combination in a single embodiment. Conversely, various features of the invention that are, for brevity, described in the context of a single embodiment, may also be provided separately or in any sub combination. Further, reference to values stated in ranges includes each and every value within that range.

The present invention may be understood more readily by reference to the following description taken in connection with the accompanying Figures and Examples, all of which form a part of this disclosure. It is to be understood that this invention is not limited to the specific products, methods, conditions or parameters described and/or shown herein, and that the terminology used herein is for the purpose of describing particular embodiments by way of example only and is not intended to be limiting of any claimed invention. Similarly, unless otherwise stated, any description as to a possible mechanism or mode of action or reason for improvement is meant to be illustrative only, and the invention herein is not to be constrained by the correctness or incorrectness of any such suggested mechanism or mode of action or reason for improvement. Throughout this text, it is recognized that the descriptions refer both to the features and methods of making and using the coatings and films described herein.

In the present disclosure the singular forms “a,” “an,” and “the” include the plural reference, and reference to a particular numerical value includes at least that particular value, unless the context clearly indicates otherwise. Thus, for example, a reference to “a material” is a reference to at least one of such materials and equivalents thereof known to those skilled in the art, and so forth.

When a value is expressed as an approximation by use of the descriptor “about” or “substantially” it will be understood that the particular value forms another embodiment. In general, use of the term “about” or “substantially” indicates approximations that can vary depending on the desired properties sought to be obtained by the disclosed subject matter and is to be interpreted in the specific context in which it is used, based on its function. The person skilled in the art will be able to interpret this as a matter of routine. In some cases, the number of significant figures used for a particular value may be one non-limiting method of determining the extent of the word “about” or “substantially”. In other cases, the gradations used in a series of values may be used to determine the intended range available to the term “about” or “substantially” for each value. Where present, all ranges are inclusive and combinable. That is, references to values stated in ranges include every value within that range.

When a list is presented, unless stated otherwise, it is to be understood that each individual element of that list and every combination of that list is to be interpreted as a separate embodiment. For example, a list of embodiments presented as “A, B, or C” is to be interpreted as including the embodiments, “A,” “B,” “C,” “A or B,” “A or C,” “B or C,” or “A, B, or C.”

It is to be appreciated that certain features of the invention which are, for clarity, described herein in the context of separate embodiments, may also be provided in combination in a single embodiment. That is, unless obviously incompatible or excluded, each individual embodiment is deemed to be combinable with any other embodiment(s) and such any combinations is considered to be another embodiment. Conversely, various features of the invention that are, for brevity, described in the context of a single embodiment, may also be provided separately or in any sub-combination. It is further noted that the claims may be drafted to exclude any optional element. As such, this statement is intended to serve as antecedent basis for use of such exclusive terminology as “solely.” “only” and the like in connection with the recitation of claim elements, or use of a “negative” limitation. Finally, while an embodiment may be described as part of a series of steps or part of a more general structure, each said step may also be considered an independent embodiment in itself.

The following abbreviations are utilized throughout the specification: GPD (gallons per day), TDS (total dissolved solids), RO (reverse osmosis), ERD (energy recovery device), SPSP (split partial second pass), PV (pressure vessel), FOP (fluctuating operational pressure), Cf (feed concentration), Cp (permeate concentration), Qf (feed flow), Qc (concentration flow), Qp (permeate flow), Pf (feed pressure), Pc (concentration pressure), Pp (permeate pressure), NTU (nephelometric turbidity units), PP (permeate pressure), NDP (net drive pressure), SSP (salt passage), DP (differential pressure), WTC (water transport coefficient), STC (salt transport coefficient), POP (permeate operational pressure), DP (differential pressure), SFX (filtration system sold by Polygroup), SSR (solid salt residue), TCF (total concentration factor), ASPn (absolute salt percentage [increase of the brine/salt]), AISI (American Iron and Steel Institute), TMP (transmembrane pressure), FEV (future equivalent value), and BSP (British standard pipe).

In view of the deficiencies entailed in the use of spiral wound membranes in reverse osmosis processes, the present disclosed invention provides a reverse osmosis filter element with a novel geometric design which has led to improved fluid mechanics of a fluid mixture which is fed over the filter element. This improved design has resulted in an overall improvement of the energy efficiency of the reverse osmosis filter element and, therefore, the filter system in general. In doing so, the filter element described herein assists in overcoming the high cost and technical/environmental difficulties of the existing filter processes in both low and high-pressure environments.

As compared with the filter elements currently in the art, the advantages gained by the filter element described herein permit the use of lower transmembrane pressure (TMP) since the TMP acts as the driving force for a membrane filter process. By doing so, this can require up to about 80% less pressure to produce the same amount of permeate. This, thereby, results in the use of substantially less energy. In one embodiment, the filter elements result in the consumption of about 0.05 to about 1 Kw/h/m³ of energy. However, the filter elements, if needed, are capable of withstanding pressures up to about 100 psi. The filter elements also result in improvements on operational performance in areas such as reduced fouling and concentration polarization and a mass balance of flow. The systems employing the filter elements described herein are also capable of using a fluctuating energy supply without damaging the reverse osmosis membrane of the filter element, thereby permitting the use of renewable energy resources and lowering of operation costs.

These advantages may be due to a variety of factors and combinations thereof. Without being bound to any theory of operation, it is believed that the advantages may be due to one or more of improved design, fluid mechanics, more effective membranes, and better filter element design, among others.

The filter element design permits increased membrane flux, improved membrane osmotic pressure performance, reduced pressure losses and decreased overall elemental operational pressures. Accordingly, the filter element that operates under lower pressures result in a substantially energy savings due to an average feed pressure reduction of about 90% and an average lowering of TMP per filter element of about 80%. Further, the generation of an effective feed stream channel geometry configuration over the filter element described herein provides a high mass transfer rate from the membrane wall to the feed stream in order to reduce the wall concentration. This results in the lowering operating pressures required to produce the same amount of permeate as current membrane and, therefore, increased overall energy savings.

The filter elements also have improved membrane operational performances and result in lower biofouling, thereby being more environmentally friendly since they can be cleaned with water or compress air and, ultimately, fewer chemicals. The filter element also has a reduction in rejection rates and flux rates filter element and longer working life than current filter elements. Specifically, the filter elements can last up to 3 times longer, i.e., 15 years as compared to 3-5 years. Therefore, less landfill is created since the filter elements are replaced less often. It was also found that the filter elements can operate on a fluctuating energy supply without fouling of the membrane which makes it more suitable to be used with renewable energy resources. This can, thereby, result in a highly efficient energy system and advantageously feed electricity back into the filtration system, rather than relying solely on it.

The filter elements also are not affected by high temperatures and are less prone to damage from all components of the feed water. Therefore, it can require a much less robust pretreatment regime before being passed through the membrane filter due to its lower fouling potential, the solids that do pass through the filter membrane may be cleaned easily using either water or compressed air, with very few chemicals. Finally, the filter element is physically durable, non-biodegradable, constructed of recyclable material, chemically resistant, and inexpensive.

### I. The Filter Element

As discussed above, a novel reverse osmosis filter element is provided. The filter element has a unique geometric design and robust membrane composition. The filter element is made from durable construction materials for use in any application such as aggressive environments. The filter element is useful for separating a first component from a fluid mixture comprising first and second components. The average hydraulic diameter of the filter element results from the combination of components and design, as discussed below. In one embodiment, the average hydraulic diameter is about 1 to about 20 mm. In further embodiments, the average hydraulic diameter is about 6 to about 10 mm. In yet other embodiments, the average hydraulic diameter is about 10 to about 15 mm. In still further embodiments, the average hydraulic diameter is about 2 to about 5 mm. In another embodiment, the average hydraulic diameter is about 2 to about 4.5 mm.

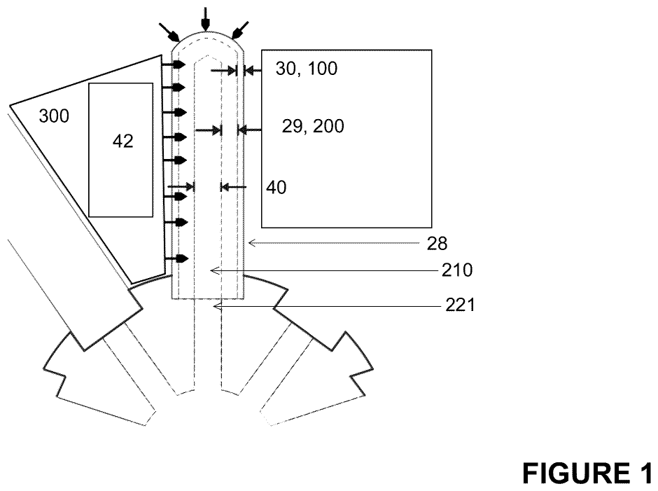

FIG. 1 is a diagram illustrating a cross-sectional side view of a membrane vane described herein. Each membrane vane (28) contains a porous layer or porous strip (29, 200) and reverse osmosis layer (30, 100). Product stream (40) is formed in the permeate channel (210). The area of the TMP over the active membrane area is show in (42).

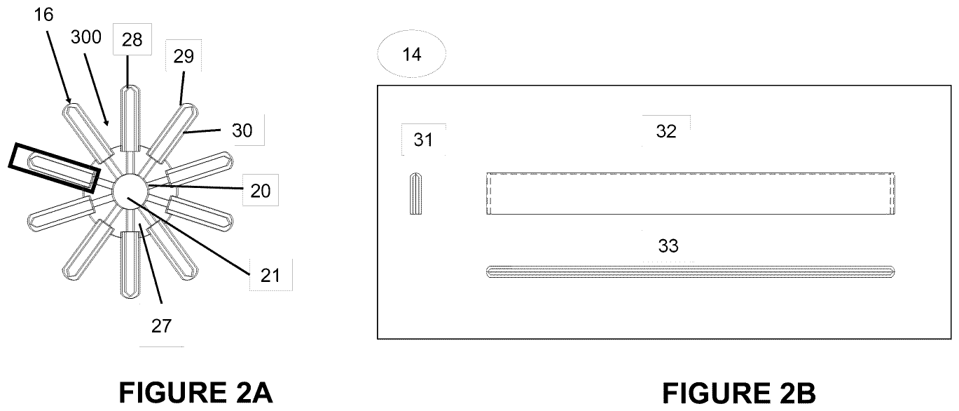

FIG. 2 is a diagram illustrating two views of a membrane vane described herein. FIG. 2A is a cross-sectional frontal view of a filter element (16). Each membrane vane (28) contains a porous layer (30) and reverse osmosis layer (29). Each membrane vane (28) is attached to a central pipe (27) which contains holes (20) leading into a permeate collection area (21). FIG. 2B contains three cross-sectional views (14) of membrane vane (28), i.e., frontal (31), longitudinal (32), and top (33).

The dimensions of the filter element (16) may be selected by one skilled in the art depending on a number of factors including, without limitation, the application of the filter element (16), scale of the filter element (16), composition of the membrane, mixture being filtered. In one embodiment, the diameter of the filter element (16) is about 50 to about 500 mm. In a further embodiment, the diameter of the filter element (16) is about 100 to about 400 mm. In another embodiment, the diameter of the filter element (16) is about 200 to about 300 mm.

The filter element (16) of the disclosure comprises the membrane vanes (28) (which are attached perpendicularly to a central tube. The term “self-supporting” as used herein refers the ability of the vane to remain affixed to the central tube without additional means. The term “perpendicularly” as used herein refers to the attachment of the membrane vane to the central tube. In one embodiment, perpendicular refers the formation of a right angle, i.e., 90°, when the membrane vane is attached to the central tube. In another embodiment, the membrane vane is affixed to the central tube at a 90 to 100° angle.

The tube (401) (e.g. central tube) is the supporting structure of the membrane vanes (28). The central tube (401) contains one or more pipes (27) that are serially attached. In one embodiment, “n” pipes are serially attached so that there are 2 end pipes and “n−2” middle pipes. In another embodiment, two or more pipes, i.e., two end pipes, are serially attached. In a further embodiment, three, four, five, six, seven, eight, nine, ten or more pipes are serially attached. The pipes are adapted for serially attaching them together. Accordingly, the pipes all contain one protruding threaded end and one open threaded end. By way of example, the protruding threaded end for one middle pipe is compatible and fits into the open threaded end for a second middle pipe.

One of skill in the art would readily be able to select a suitable central pipe (27) depending on the use of the filter element (16). In some embodiments, the central pipe (27) is substantially the same length as the filter element (16). In other embodiments, the diameter and gauge of the central pipe (27) is sufficiently side enough to accept the membrane vanes (28) and house the same without interfering with their use. In other embodiments, the central pipe (27) is comprised of a material which has high anti-corrosive properties and low friction loss properties. Regardless of the material, the central pipe (27) comprises holes (20) along the length of the central pipe (27) to form a permeate conduit. The holes are designed to permit the flow of the permeate, filtered fluid mixture, or a combination thereof. The membrane vanes are positioned over these holes. The size of the holes may also be determined by one skilled in the art. In some embodiments, the size of the holes depends on the type of application of the filter element. In other embodiments, the size of the holes depends on the osmotic pressure, flux generation, or a combination thereof which provides the desired permeate flow through the holes. The central tube also comprises an inner canal (400) having an outer diameter. In one embodiment, the outer diameter of the inner canal side is about 30 to about 250 mm. In another embodiment, the outer diameter of the inner canal side is about 35 to about 55 mm. In a further embodiment, the outer diameter of the inner canal side is about 80) to about 120 mm. In yet another embodiment, the outer diameter of the inner canal side is about 180) to about 22 mm. The central tube may be constructed of any material suitable for use in filtering fluid mixtures. In some embodiments, the central tube is constructed of carbon fiber, titanium, tungsten, brass, polyurethane carbon fiber (machinable), resin and composites/combinations thereof.

The filter element (16) contains a sufficient number of membrane vanes (28) which are equally spaced apart to provide the required minimum hydraulic diameter of the filter element. One of skill in the art would be able to determine a suitable number of membrane vanes (28) and/or minimum hydraulic diameter depending on the application of the filter element (16), scale of the filter element (16), composition of the membrane, mixture being filtered, among others. In some embodiments, the filter element (16) contains at least two membrane vanes (28). In one embodiment, the filter element (16) contains at least about 4 membrane vanes (28). In another embodiment, the filter element (16) contains at least about 8 membrane vanes (28). In a further embodiment, the filter element (16) contains about 8 to about 96 membrane vanes (28). In other embodiments, the filter element (16) contains about 8 to about 24 membrane vanes (28). In yet further embodiments, the filter element (16) contains about 35 to about 52 membrane vanes (28). In still another embodiment, the filter element (16) contains or about 79 to about 96 membrane vanes (28).

The membrane vanes (28) are spaced apart to provide a minimum hydraulic diameter between adjacent membrane vanes. In some embodiments, the membrane vanes (28) are equally spaced apart. In other embodiments, the membrane vanes (28) are spaced apart to provide a minimum hydraulic diameter (annular space for q_{feed} at the inner diameter) of the filter element (16) of about 2 to about 3 mm. In a further embodiment, the minimum hydraulic diameter of the filter element (16) is about 2 mm. In another embodiment, the minimum hydraulic diameter of the filter element (16) is about 2.4 mm.

The membrane vanes (28) are of a height and width sufficient to effect filtration of a desired mixture. Selection of the membrane vane height depends on a number of factors including application of the filter element (16), scale of the filter element (16), composition of the membrane, mixture being filter, among others. In one embodiment, the height of the membrane vane (28) is about 28 to about 100 mm. In another embodiment, the height of the membrane vane (28) is about 21 to about 31 mm. In a further embodiment, the height of the membrane vane (28) is about 37 to about 57 mm. In still another embodiment, the height of the membrane vane (28) is about 84 to about 104 mm. In yet a further embodiment, the membrane vane (28) has a thickness of about 1 to about 4 mm. In another embodiment, the thickness of the membrane vane is about 2 to about 3 mm.

The total cross sectional area of the membrane vane (28) is greater than the filter elements in the art. In one embodiment, the total cross sectional area of the membrane vane (28) is about 0.001 to about 0.05 m². In another embodiment, the total cross sectional area of the membrane vane (28) is about 0.0015 to about 0.04 m². In a further embodiment, the total cross sectional area of the membrane vane (28) is about 0.0017 to about 0.0018 m². In yet another embodiment, the total cross sectional area of the membrane vane (28) is about 0.009 to about 0.01. In a further embodiment, the total cross sectional area of the membrane vane (28) is about 0.0093 to about 0.0099 m². In still a further embodiment, the total cross sectional area of the membrane vane (28) is about 0.038 to about 0.40 m².

Advantageously, the membrane vanes have little flexibility. In one embodiment, the self-supporting membrane vanes have zero flexibility. In another embodiment, the self-supporting membrane vanes may have an about 0 to about 25° flex. Accordingly, the membrane vanes do not wind around the central tube. By doing so, pressurized feed flow enters the pressure vessel and one or more channels are formed. In one embodiment, a permeate flow channel is formed within each membrane vane. In another embodiment, a permeate flow channel (210) between the inner surface of the two porous supporting strips (200) is formed, a feed water flow channel (300) (e.g. open feed water flow channel) dispersed around the membrane vane (11) is formed, or combinations thereof. In a further embodiment, the permeate flow channel is disposed adjacent to the porous substrate. In still another embodiment, the permeate flow channel is in fluidic communication with the central tube/permeate conduit. Advantageously, this avoids the need to use spacer elements in the channels. This also results in a filter element which has enhanced concentrate flow movement and potential energy recovery.

As noted, the permeate flow channel is forward between the inner surface of the two porous supporting strips. It is opened at a vane permeate outlet (221) which opens towards the central tube.

The open feed water flow channel (300) is dispersed inside of the feed water flow channel. The feed water flow channel is closed and sealed at areas remote from the central permeate tube 401. In one embodiment, feed water flow channel is sealed at two sides adjacent to the membrane. By doing so, the feed water flow channel forms a sealed structure respectively at the central tube 401 at the two sides and a concentrate outlet.

Each membrane vane contains at least two components. By doing so, a filter element having active membrane area is provided. In one embodiment, the active membrane area is about 0.4 to about 16 m². In another embodiment, the active membrane area is about 0.4. In a further embodiment, the active membrane area is about 0.90 to about 1 m². In yet another embodiment, the active membrane area is about 0.90 to about 0.96 m². In still a further embodiment, the active membrane area is about 3 to about 4 m². In another embodiment, the active membrane area is about 3.65 to about 3.8 m². In a further embodiment, the active membrane area is about 15 to about 16 m². In still another embodiment, the active membrane area is about 15.25 to about 15.6 m².

The first component of the membrane vane is a porous supporting strip (200). By careful selection and sequencing, a porous medium can be engineered to fit almost any specification including, without limitation, pore size, pore density, tortuosity, mechanical strength, permeability, corrosion resistance, and acoustical resistance.

In some embodiments, the porous supporting comprises a material which has high anti-corrosive properties, high tensible strength, high flux generation capability, or a combination thereof. In one embodiment, the porous supporting strip comprises a metal. In a further embodiment, the porous supporting strip comprises stainless steel, titanium, tungsten, carbon fibre, ceramics or a combination thereof. In yet another embodiment, the porous supporting strips comprises 100% AISI type 316 stainless steel. In a further embodiment, the porous supporting strip comprises a wire mesh. In another embodiment, the porous supporting strip is laminated by precision sintering and calendaring.

The thickness of the porous supporting strips may be determined by those skilled in the art depending on application of the filter element, scale of the filter element, composition of the membrane, mixture being filter, among others. In one embodiment, the thickness of the porous supporting strips is about 0.1 to about 10 mm. In further embodiments, the thickness of the porous supporting strip is about 1 to about 3 mm. In other embodiments, the thickness of the porous supporting strip is about 1.5 to about 2.5 mm. In another embodiment, the thickness of the porous supporting strips is about 2 mm. In a further embodiment, the thickness of the porous supporting strips is about 1.9 mm.

The pore size of the porous supporting strip also may be selected by those skilled in the art. In one embodiment, the pore size of the porous supporting strip is about 0.1 to about 50μ. In another embodiment, the pore size of the porous supporting strip is about 1 to about 45μ. In a further embodiment, the pore size of the porous supporting strip is about 5 to about 40μ. In still another embodiment, the pore size of the porous supporting strip is about 10 to about 30μ. In yet a further embodiment, the pore size of the porous supporting strip is about 20 to 25μ.

Accordingly, the total active membrane area of the porous supporting strip is about 0.4 to about 1 m². In one embodiment, the total active membrane area of the porous supporting strip is about 0.5 to about 0.9. In a further embodiment, the total active membrane area of the porous supporting strip is about 0.6 to about 0.8.

Each supporting strip may comprise a finer porous layer which optimizes the performance of the flux generation and the osmotic pressure application for the different TDS levels of the feed water that needs to be filtered. In one embodiment, the supporting strip is coarser than the outer membrane layer.

The finer porous medium that can be engineered to fit almost any osmotic specification for the microscopic layer, pore size, pore density, tortuosity, mechanical strength, permeability, corrosion resistance, and acoustical resistance. In one embodiment, the finer porous layer is a reverse osmosis membrane layer (100). In another embodiment, the finer porous layer is laminated onto the supporting strip, i.e., the reverse osmosis layer is the outer layer of the membrane vane. By doing so, the reverse osmosis layer is oriented to be adjacent to the fluid mixture when in use. In some embodiments, the membrane vane comprises a reverse osmosis membrane layer disposed on a porous substrate.

The reverse osmosis membrane layer may be selected by those skilled in the art depending on the application of the filter element, scale of the filter element, composition of the membrane, mixture being filtered, among others. The reverse osmosis layer may be the same on each supporting strip or may differ. In one embodiment, the reverse osmosis membrane has a high tensile strength. In another embodiment, the reverse osmosis membrane layer comprises a corrosion resisting alloy. In another embodiment, the reverse osmosis membrane layer comprises carbon composites, ceramic composites, polymer type composites, polyamides, or combinations thereof. In further embodiments, the reverse osmosis membrane layer is a cellulosic derivative, polyamide derivative, polysulfone, polyethersulfone, polyvinylidene fluoride, polypropylene or combinations thereof.

In some embodiments, the reverse osmosis membrane is a cellulosic derivative. Examples of cellulosic derivatives include, without limitation, hydrophilic cellulosic derivatives such as cellulose acetate. Cellulose acetate is the most hydrophilic of common industrial-grade membrane materials, which helps to minimize fouling and maintain high flux levels. In some embodiments, cellulose acetate membranes are tolerant of continuous exposure to free chlorine doses of 1 mg/L or lower, which can prevent biological degradation, and intermittent chloride doses as high as 50 mg/L.

In other embodiments, the reverse osmosis membrane is a polyamide. A variety of polyamide derivatives may be selected for use as the reverse osmosis membrane layer. In some embodiments, the polyamide layer may be very thin film, e.g., a few thousand angstroms. Such a layer may be formed on a polysulfide substrate by interfacial polymerization monomers containing amine and carbocyclic acid chloride functional groups.

In further embodiments, the reverse osmosis membrane is a polysulfone or polyethersulfone. Polysulfones and polyethersulfones are moderately hydrophobic, durable and have excellent chemical and biological resistance. Polysulfones and polyethersulfones can withstand free chlorine up to about 200 mg/L, a variety of pH values, e.g., between about 1 and about 13, and temperatures up to about 75° C. As a result, cleaning and disinfecting can be aggressive without degrading the membrane material.

In other embodiments, the reverse osmosis membrane is a polyvinylidene fluoride. Polyvinylidene fluoride is moderately hydrophobic and has excellent durability, chemical tolerance, and biological resistance. Polyvinylidene fluorides can withstand continuous free chlorine contact to any concentration, pH values between about 2 and about 10, and temperatures up to about 75° C. As a result, cleaning and disinfecting can be aggressive without degrading the membrane material.

In still further embodiments, the reverse osmosis membrane is a polypropylene. Polypropylene is very hydrophobic, durable, chemically and biologically resistant, and tolerant of moderately high temperatures and pH values between about 1 and about 13, which allows aggressive cleaning regimes.

The pore size of the reverse osmosis membrane depends on several factors including, without limitation, application of the filter element, scale of the filter element, composition of the membrane, mixture being filtered, among others. In one embodiment, the pore size of the porous supporting strip is larger than the pore size of the reverse osmosis membrane. In another embodiment, the pore size of the reverse osmosis membrane is about 0.001μ to about 10μ. In a further embodiment, the pore size of the reverse osmosis membrane is about 0.005 to about 5μ. In still another embodiment, the pore size of the reverse osmosis membrane is about 0.01μ to about 1μ.

The tensile strength of the reverse osmosis membrane layer is about 25,000 to about 50,000 psi. In another embodiment, the tensile strength of the reverse osmosis membrane layer is about 30,000 to about 45,000 psi. In a further embodiment, the tensile strength of the reverse osmosis membrane layer is about 35,000 to about 40,000 psi. The yield strength at 0.2% offset of the reverse osmosis membrane layer is about 15,000 to about 30,000 psi. In a further embodiment, the yield strength at 0.2% offset of the reverse osmosis membrane layer is about 20,000 to about 25,000 psi.

The elongation of the reverse osmosis membrane layer may also be selected by those skilled in the art. In one embodiment, the elongation of the reverse osmosis membrane layer is about 5 to about 20%. In another embodiment, the elongation of the reverse osmosis membrane layer is about 10 to about 15%. The tensile modulus of elasticity of the reverse osmosis membrane layer is about 10×10⁶ to about 15×10⁶ psi. In one embodiment, the tensile modulus of elasticity of the reverse osmosis membrane layer is about 11×10⁶ to about 14×10⁶ psi. In another embodiment, the tensile modulus of elasticity of the reverse osmosis membrane layer is about 12×10⁶ to about 13×10⁶ psi.

The thickness of the reverse osmosis membrane layer can vary depending on its use. In one embodiment, the thickness of the reverse osmosis membrane layer is about 0.1 to about 10 mm. In other embodiments, the thickness of the reverse osmosis membrane layer is about 0.2 to about 5 mm. In further embodiments, the thickness of the reverse osmosis membrane layer is about 1 to about 4 mm. In another embodiment, the thickness of the reverse osmosis membrane layer is about 2 to about 3 mm

### II. Methods for Preparing the Filter Element

The filter elements discussed herein may be prepared using a novel infusion process which provides superior filtration. The methods include applying a reverse osmosis membrane layer to a porous supporting strip. Such methods include applying a first reverse osmosis membrane layer to a first porous supporting strip and applying a second reverse osmosis membrane layer to a second porous supporting strip. The first and second porous supporting may be the same or may differ as determined by one skilled in the art. Similarly, the first and second reverse osmosis membrane layers may be the same or may differ as determined by one skilled in the art. The reverse osmosis layer is molded to the porous membrane supporting strip.

The first and second porous membrane supporting strips containing the reverse osmosis layers are fused to form the membrane vane. The fusion is performed using an epoxy to create a waterproof seal and provide a durable seal on the edges. In one embodiment, the coated porous membrane supporting strips are fused along their edges. In another embodiment, the coated porous membrane supporting strips are fused along three edges.

Each membrane vane is then attached to central pipe. By doing so, a channel between each membrane vane is formed where the feed water may flow into the central pipe. The permeate, thereby, passes through the porous membrane vanes into the permeate channel (210).

The central pipe may contain grooves configured to accept the membrane vanes. The membranes are then fused to the central tube using epoxy. The use of an epoxy infusion process provides a water tight, strong and durable filter element.

Each membrane vane may also be positioned over the holes on the central tube. By doing so, an open feed water flow guiding channel is provided inside the permeate flow channel 220) and enhances concentrate flow movement. Not only does this decrease fouling, but is provides enhanced energy recovery potential. The holes located on the central tube permit the flow of the fluid mixture into a permeate collection area located within the central tube.

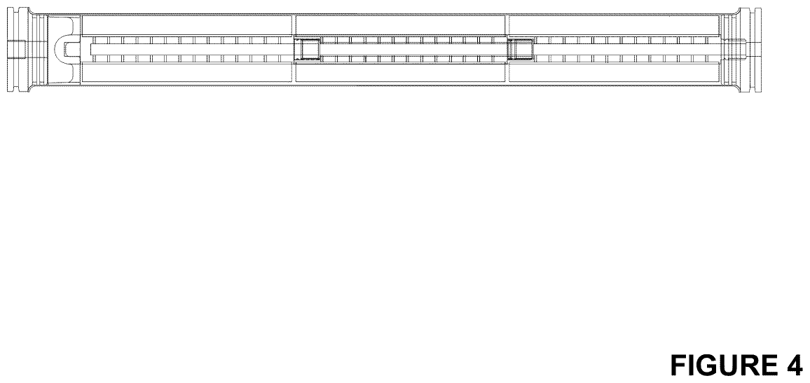

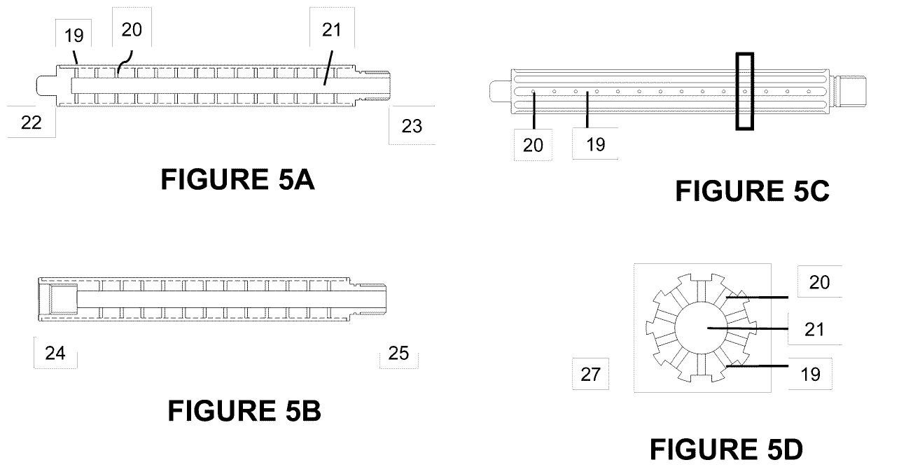

FIG. 5 is a diagram illustrating a central pipe of FIG. 4 which is designed to contain the filter element. FIG. 5A is a cross-sectional longitudinal view of the middle central pipe of FIG. 4. The middle central pipe contains grooves (19) where the membrane vanes of the filter elements are designed to fit. The middle central pipe also contains holes (20) leading into the permeate collection area (21). The middle central pipe contains an open end (22) and threaded end (23). FIG. 5B is a cross-sectional longitudinal view of the end central pipe of FIG. 4. The end central pipe contains grooves wherein the membrane vanes of the filter elements are designed to fit. The end central pipe also contains holes leading into the permeate collection area. The end central pipe contains an open end (24) and a connecting point (25) to the end cover of the end central pipe. FIG. 5C is an external view (27) of the central pipe of FIG. 4 containing grooves (19) wherein the membrane vanes of the filter elements are designed to fit and holes (20) leading into the permeate collection area (21). FIG. 5D is a cross-sectional frontal view of the boxed area of the end central pipe of FIG. 5C showing groove (19), holes (20) and permeate collection area (21).

After the central tubes are serially attached, if needed, they are enclosed within a means for applying a pressure. In some embodiments, the means for applying a pressure is a pressure vessel. The pressure vessel may be of any type or size as determined by one skilled in the art. In some embodiments, the pressure vessel is fabricated from stainless steel, polyvinylchloride, or glass such as fiber glass, carbon fiber or composite technologies thereof.

The pressure vessel is adapted to contain any components required to utilize the filter described herein. In some embodiments, the pressure vessel contains one or more of an inlet, outlet, control valve, pressure tapping, flow meter, flow diffuser unit, digital mass measuring scale, pressure sensor, and analysis system. In other embodiments, the pressure vessel contains one or more of an inflow control valve, outflow control valve, or permeate flow control valve. In further embodiments, the pressure tapping is located at one or more positions along the length of the pressure vessel. In yet other embodiments, the flow meter is a mechanical flow meter such as a rotamer to measure the flow at the inlet side of the pressure vessel, outlet side of the pressure vessel, inlet from the filter element, outlet from the filter element, or combinations thereof. In still further embodiments, the pressure sensor is located at one or more positions along the pressure vessel to measure pressures losses. In other embodiments, the pressure sensor is a Futek PMP 942 pressure sensor. In further embodiments, the analysis system monitors and records the performance of the filter element. In other embodiments, the analysis system may be used in combination with a multichannel controller, software, or a combination thereof. In still other embodiments, the software is LabView software such as a NI-DAQ system.

In one embodiment, the front end of the pressure vessel contains a concentrate inlet which permits entry of the fluid mixture to be filtered. In another embodiment, the rear end of the pressure vessel contains the concentrate outlet, which permits removal of the “waste”, and a permeate outlet which permits collection of the filtered fluid mixture.

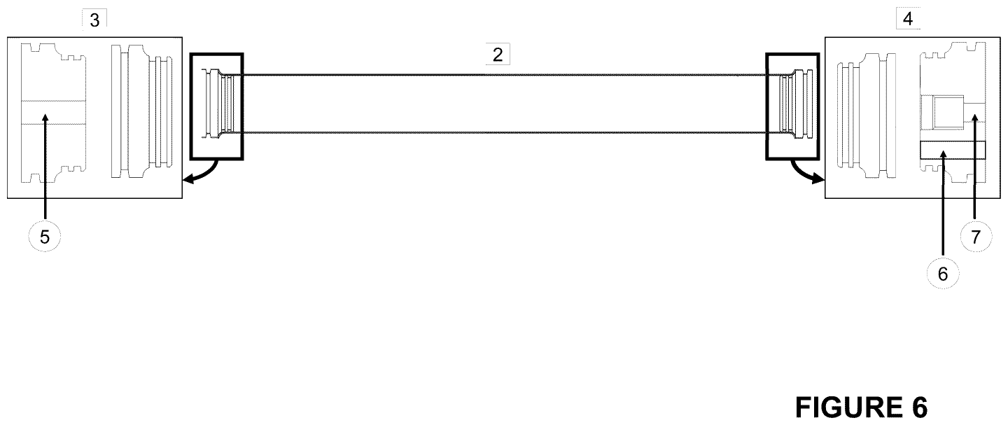

FIG. 6 is a diagram illustrating a pressure valve system containing the filter element and central pipe. Pressure vessel (2) contains a front end (3) and rear end (4). Front end (3) contains the concentrate inlet (5). Rear end (4) contains the concentrate outlet (6) and permeate outlet (7).

Once the membrane vanes are attached to the central tube and provided within the pressure vessel, the feed water flow channel is sealed. The channel blocks the outer areas of the two end surfaces of the filter element, respectively, after the membrane vanes are assembled around the central permeate tube. By doing so, a gap is provided between the central permeate tube and each of the end covers to form water inlets. In one embodiment, the free water flow channel is sealed with end covers, i.e., front and back end covers. The end covers permit the feed flow to enter from one end of the filter element and the permeate and concentrate to exit from the other end of the filter element. The front end covers may include a concentrate inlet and the back end cover may include a concentrate outlet and permeate outlet. In another embodiment, the free water flow channel is sealed with annular end covers. In a further embodiment, the free water flow channel is sealed using epoxy. In yet another embodiment, one or both of the end caps is coated with epoxy. In yet a further embodiment, the inside of one or both of the end caps is coated with epoxy.

The pressure vessel is designed to accommodate one or more of the filter elements described herein. Accordingly, the one or more filter elements may be positioned within the pressure vessel. In one embodiment, the pressure vessel is designed to contain at least about 5 filter elements. In another embodiment, the pressure vessel is designed to contain at least about 8 filter elements. The pressure vessel has a diameter which permits the use of the net driving pressures discussed herein. In one embodiment, the diameter of the pressure vessel is about 50 mm to about 500 mm. In another embodiment, the diameter of the pressure vessel is about 100 to about 450 mm. In a further embodiment, the diameter of the pressure vessel is about 150 to about 400 mm. In yet another embodiment, the diameter of the pressure vessel is about 200 to about 350 mm. In still a further embodiment, the diameter of the pressure vessel is about 250 to about 300 mm.

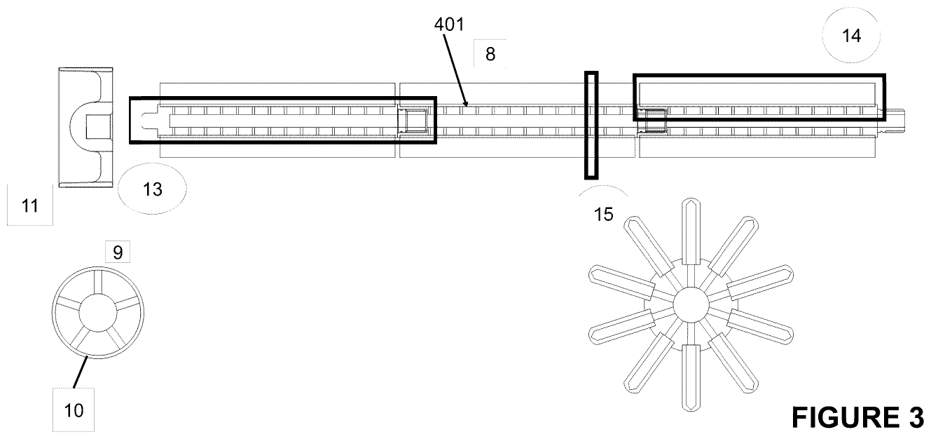

FIG. 3 is a diagram illustrating a cross-sectional view of the embodiment of using the filter element described herein. The methods utilize a central pipe (8) which contains one middle (8) and two end pipes (13) and (14). Each pipe contains a plurality of filter elements containing membrane vanes (14), a front end cover (9) shown as a frontal view, an open space (10) where water flows there through, and a front end cover (11) or flow diffuser unit for feed flow distribution into the different feed channels (15).

FIG. 4 is a diagram illustrating the assembled embodiment FIG. 4. Shown are the pressure vessel, 2 end pipes and a middle pipe, two end covers, and a plurality of filter elements contained in each pipe.

### III. Methods of Using the Filter Element

The filter elements described herein are useful in methods for filtering fluid mixtures. Accordingly, a feed flow of the fluid mixture, i.e., a concentrate, flows through the channels between the membrane elements as described above. This produces a permeate, i.e., product, from feed flow by removing any ionic and particulate matter contained in the concentrate. The methods may be performed on bench scales, pilot scales, or industrial scales as determined by those skilled in the art. A variety of fluid mixtures may be filtered and include, without limitation, brackish water, i.e., salt water, salty water, seawater, saline, industrial fluids such as oil and gas fluid mixtures, such as those utilized in offshore and gas industries. Accordingly, the filter elements described herein are designed to provide high salt rejection for tap water and light brackish water. In one embodiment, the fluid mixture is brine, thereby reducing the amount of brine that is returned to the water system and resulting in less of an environmental impact. In another embodiment, the fluid mixture is a by-product in the offshore oil and gas industry where the goal of water treatment methods in the use of enhanced oil recovery. In further embodiments, the fluid mixture contains about 1,000 to about 50,000 ppm of TDS. In other embodiments, the fluid mixture contains about 15,000 to 35,000 ppm of TDS. By using the filter elements described herein, operating costs may be minimized, footprint and energy efficiencies may be maximized, all while maintaining production and/or increasing oil recovery rates and being environmentally friendly due to better water treatment management.

The fluid mixtures may have a variety of feed concentrations. In one embodiment, the feed concentration of the fluid mixture is low, i.e., dilute. In another embodiment, the feed concentration of the fluid mixture is high, i.e., concentrated. In a further embodiment, the feed concentration of the fluid mixture is about 1,000 to about 50,000 ppm per filter element. In yet another embodiment, the feed concentration of the fluid mixture is about 5,000 to about 45,000 per filter element. In still a further embodiment, the feed concentration of the fluid mixture is about 10,000 to about 40,000 per filter element. In another embodiment, the feed concentration of the fluid mixture is about 15,000 to about 35,000 per filter element. In a further embodiment, the feed concentration of the fluid mixture is about 20,000 to about 30,000 per filter element. By doing so, potable water may be generated by removing the ionic and particulate matter contained in the feed flow.

The methods, thereby, include passing the fluid mixture through at least one filter element described herein. In one embodiment, the methods utilize at least about 5 filter elements. In another embodiment, the methods utilize at least about 8 filter elements. The filter elements may be arranged in a number of different configurations, within the concentric pressure vessel spatial domain, depending on their application. In one embodiment, the filter elements are arranged serially.

In a further embodiment, the total length of the filter elements is about 1000 mm.

The methods described herein result in a high permeate flow rate per day. In one embodiment, the permeate flow rate per element is about 2 to about 500 m³/day. In another embodiment, the permeate flow rate per element is about 25 to about 450 m³/day. In a further embodiment, the permeate flow rate per element is about 50 to about 400 m³/day. In yet another embodiment, the permeate flow rate per element is about 100 to about 350 m³/day. In still a further embodiment, the permeate flow rate per element is about 150 to about 300 m³/day. In another embodiment the permeate flow rate per element is about 200 to about 250 m³/day.

The methods also permit maximizing the working area of each filter element. In one embodiment, the area per filter element is about 0.1 to about 25 m². In another embodiment, the area per filter element is about 5 to about 20 m². In a further embodiment, the area per filter element is about 10 to about 15 m².

The inventors found that minimizing the hydraulic pressure losses across the filter element by maintaining a constant osmotic pressure over the active membrane area resulted in a lower trans-membrane pressure. In one embodiment, the methods permit the loss of about 1 to about 5 psi (5 to 35 psi) of hydraulic pressure when using the filter elements described herein. Accordingly, lower operational pressures and net driving pressures could be utilized. In one embodiment, the net driving pressure is about 2 to about 25 bar. In another embodiment, the net driving pressure is about 5 to about 20 bar. In a further embodiment, the net driving pressure is about 10 to about 15 bar. However, one of skill in the art would readily be able to select a suitable net driving pressure.

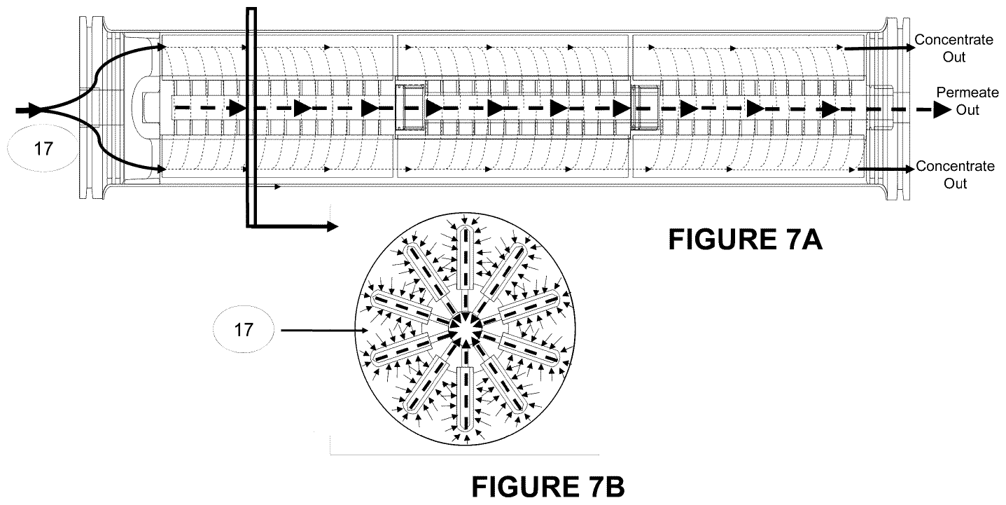

FIGS. 7A and 7B illustrate two views of the flow of a fluid mixture through a filter element described herein. The concentrate fluid mixture is identified by large solid arrows and the permeate fluid mixture is identified by large dashed arrows. FIG. 7A is a longitudinal view and FIG. 7B is a cross-sectional view of the boxed section of FIG. 7A. In both figures, the fluid mixture (17) is fed into the space surrounding the membrane vanes of filter element. The concentrate and permeate fluid mixtures then flow to exit the filter element. The small arrows denote the feed low in the feed channels which are created by the number of vanes.

In one embodiment, the methods utilize about 5 filter elements. The total length of the filter elements is about 1000 mm, the diameter of each filter element is about 75 to about 125 mm, the feed concentration is about 1400 to about 1600 ppm, the permeate flow rate per filter element is about 10 to about 20 m³ day, the area per filter element is about 0.75 to about 1.25 m², and the pressure is about 2 to about 3 bar.

In another embodiment, the methods utilize about 5 filter elements. The total length of the filter elements is about 1000 mm, the diameter of each filter element is about 175 to about 225 mm, the feed concentration is about 1400 to about 1600 ppm, the permeate flow rate per filter element is about 55 to about 70 m³ day, the area per filter element is about 3 to about 5 m², and the pressure is about 2 to about 3 bar.

In a further embodiment, the methods utilize about 5 filter elements. The total length of the filter elements is about 1000 mm, the diameter of each filter element is about 375 to about 425 mm, the feed concentration is about 1400 to about 1600 ppm, the permeate flow rate per filter element is about 240 to about 260 m³ day, the area per filter element is about 10 to about 20 m², and the pressure is about 2 to about 3 bar.

In yet another embodiment, the methods utilize about 5 filter elements. The total length of the filter elements is about 1000 mm, the diameter of each filter element is about 75 to about 125 mm, the feed concentration is about 14000 to about 16000 ppm, the permeate flow rate per filter element is about 5 to about 12 m³ day, the area per filter element is about 0.75 to about 1.25 m², and the pressure is about 7 to about 13 bar.

In still a further embodiment, the methods utilize about 5 filter elements. The total length of the filter elements is about 1000 mm, the diameter of each filter element is about 175 to about 225 mm, the feed concentration is about 14000 to about 16000 ppm, the permeate flow rate per filter element is about 30 to about 40 m³ day, the area per filter element is about 3 to about 5 m², and the pressure is about 7 to about 13 bar.

In another embodiment, the methods utilize about 5 filter elements. The total length of the filter elements is about 1000 mm, the diameter of each filter element is about 375 to about 425 mm, the feed concentration is about 14000 to about 16000 ppm, the permeate flow rate per filter element is about 130 to about 140 m³ day, the area per filter element is about 10 to about 20 m², and the pressure is about 7 to about 13 bar.

In yet a further embodiment, the methods utilize about 5 filter elements. The total length of the filter elements is about 1000 mm, the diameter of each filter element is about 75 to about 125 mm, the feed concentration is about 30000 to about 40000 ppm, the permeate flow rate per filter element is about 2 to about 3.5 m³ day, the area per filter element is about 0.75 to about 1.25 m², and the pressure is about 17 to about 23 bar.

In still another embodiment, the methods utilize about 5 filter elements. The total length of the filter elements is about 1000 mm, the diameter of each filter element is about 175 to about 225 mm, the feed concentration is about 30000 to about 40000 ppm, the permeate flow rate per filter element is about 7 to about 15 m³ day, the area per filter element is about 3 to about 5 m², and the pressure is about 17 to about 23 bar.

In a further embodiment, the methods utilize about 5 filter elements. The total length of the filter elements is about 1000 mm, the diameter of each filter element is about 375 to about 425 mm, the feed concentration is about 30000 to about 40000 ppm, the permeate flow rate per filter element is about 40 to about 50 m³ day, the area per filter element is about 10 to about 20 m², and the pressure is about 17 to about 23 bar.

The filter elements described herein are also useful in methods of generating electricity from salty water. These methods include filtering the salty water through at least one filter element described herein to provide a permeate containing less salt than said salty water. The term “less salt” as described herein refers to a mixture which contains at least about 10% less salt than is found in brackish water. In some embodiments, “less salt” refers to at least about 20% less salt than is found in brackish water. In other embodiments, “less salt” refers to at least about 30% less salt than is found in brackish water. In further embodiments, “less salt” refers to at least about 40% less salt than is found in brackish water. In still other embodiments, “less salt” refers to at least about 50% less salt than is found in brackish water. In yet further embodiments, “less salt” refers to at least about 60% less salt than is found in brackish water. In other embodiments, “less salt” refers to at least about 70% less salt than is found in brackish water. In further embodiments, “less salt” refers to at least about 80% less salt than is found in brackish water. In yet other embodiments, “less salt” refers to at least about 90% less salt than is found in brackish water. In still further embodiments, “less salt” refers to at least about 95% less salt than is found in brackish water.

After the salty water is filtered, the salty water and permeate pumped through a reverse electrodialysis process. The salty water and permeate flow under pressure through a stack of alternating cation and anion exchange membranes. Such cation and anion exchange membranes are known in the art and may be selected by one skilled to do so. By doing so, the chemical potential difference between the salty water and permeate generates an electric potential (voltage) over each membrane. The total electric potential of the system is the sum of the potential differences over all membranes.

### IV. Systems Including the Filter Elements

The filter elements discussed herein may be employed in a variety of systems for filtering fluid mixtures. The filter elements may be utilized or adapted for use in current systems/plants, thereby improving their operation costs by reducing the energy required to run the plant and reducing the cost of downtime and maintenance due to less fouling of the membrane and increased lifespan, therefore replacing the filter elements less frequently. The filter elements may also be designed for use in new systems/plants for filtering fluid mixtures. The systems may include the filter element described herein and any additional components deemed needed by one of skill in the art. In one embodiment, the system may include one or more of pumps, i.e., low-pressure, medium-pressure, or high-pressure, filters such as pre-treatment or post-treatment, or vessels. In another embodiment, the system includes a low-pressure pump, at least one pretreatment filter, a high-pressure pump, at least one filter element described herein, and a vessel for the collected filtered fluid mixture.

The inventor discovered that energy could be conserved using the filter elements and systems described herein via a duel energy recovery system. It was found that the two-phase flow in the flow channel creates a vorticity increase over the membrane and acts as an energy reducing catalyst over the membrane. The vorticity increase reduces the fouling over the membrane. The higher velocities and Reynold's numbers due to the two-phase flow increased momentum in the concentrate flow stream which increased the energy recovery potential.

Specifically, the inventor determined that the concentrate stream could be split into two separate streams. One stream flowed to an energy recovery device. The energy recovery device facilitates recycling energy from the outgoing concentrate and feeding the energy back into the system. By doing so, this results in a lowering of the external energy required to power the pumps of the system. In one embodiment, the energy recovery device is in fluid communication with the first and second pump via one or more conduits. The other concentrate stream flowed to an energy generation system.

The combination of the lower operational pressure (energy) and the increased energy recovery potential provides the option to store this additional energy in one or more energy storage devices, thereby resulting in a highly efficient system. The term highly efficient means that at least about 90% of the energy required to operate the system is consumed. Accordingly, the system may also include a device for storing the recovered or generated energy and/or a device for recycling the fluid mixture. In one embodiment, the energy storage device is portable. In another embodiment, the energy storage device is a battery or fuel cell. In a further embodiment, the energy storage device is in fluid communication with the filter element via one or more conduit. In another embodiment, the energy recovery device is in fluid communication with the energy storage device, the recycling device, or combinations thereof via one or more conduits.

The energy storage device in combination with the filter element described herein, optionally with an energy recovery device, results in a self-sustaining system. In one embodiment, the system can operate in the absence of an external power grid. In another embodiment system permits feeding power back into the system, making it an energy positive system.

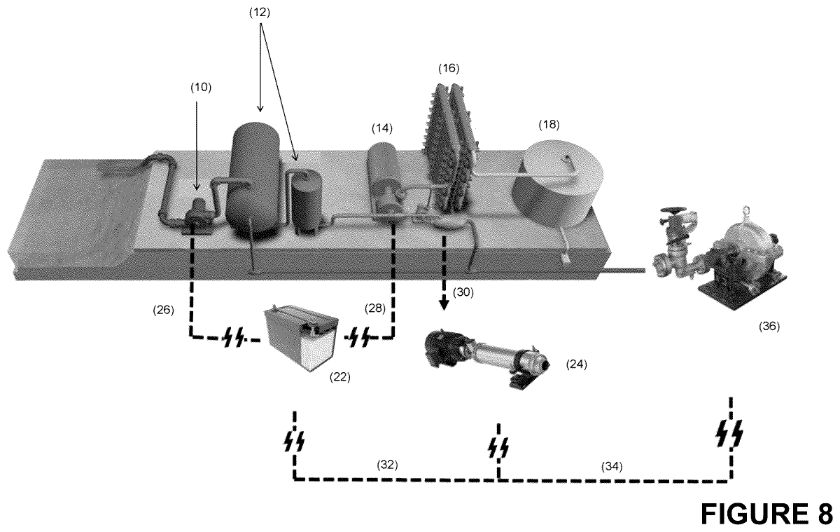

FIG. 8 is a diagram of a system described herein. The system includes a low-pressure pump (10), one pretreatment filter (12), (c) a high-pressure pump (14), a filter element (16) described herein, and a vessel (18) for collected filtered fluid mixture. The system may contain one or more of an energy recovery device (24), energy storage device (22), or fluid mixture recycling device (36). The energy recovery device (24) is in fluid communication with the first and second pumps (10) and (14) via a first conduit (26) and a second conduit (28), respectively. The energy storage device (22) is in fluid communication with the filter element via storage conduit (30). The energy recovery device (24) is in fluid communication with the energy storage device (24), the device (36), or combinations thereof via first recovery conduit (32) or second recovery conduit (34).

Also provided are reverse electrodialysis systems for generating electricity from salty water. The systems include one or more filter elements described herein disposed in a pressure vessel described herein. The salty water is filtered through the pressure vessel to provide a permeate containing less salt than salty water. The systems also include a stack of alternating cation and anion exchange membranes disposed in a reverse electrodialysis vessel. By doing so, the salty water and permeate are pumped through the vessel to provide a chemical potential difference between the salty water and permeate thereby generating an electric potential (voltage) over each membrane. The total electric potential of the system is the sum of the potential differences over all membranes.

### V. Mobile Systems

In addition to using the filter elements discussed herein in industrial settings, the filter elements are useful on smaller scales for addressing a number of issues. In one embodiment, use of the filter element described herein may permit access of water to communities without having to pay increasingly higher water rates. In another embodiment, the filter elements may permit communities to feed electricity back onto their systems, therefore saving overall on residents' power bills. In a further embodiment, by using the filter element in recycling brine, the collected useable salt may be sold and result in further funding to a self-sustaining community. In yet another embodiment, the filter elements may be utilized in mobile system for use by communities located next to a water coastline.

In additional to domestic advantages in using the filter elements described herein, there are further benefits for communities abroad. Specifically, the filter elements are useful for use by developing countries which have little to no access to electricity or a small amount of useable space. Such communities may also benefit from the extra electricity that the filter element described herein can produce by powering other things that enhance quality of life.

A mobile system using the filter element described herein may contain the same components of the larger plant, but all can encased in a container for transport. Such a mobile system is self-sustaining and does not require and external power source, thereby making it a solution for such communities.

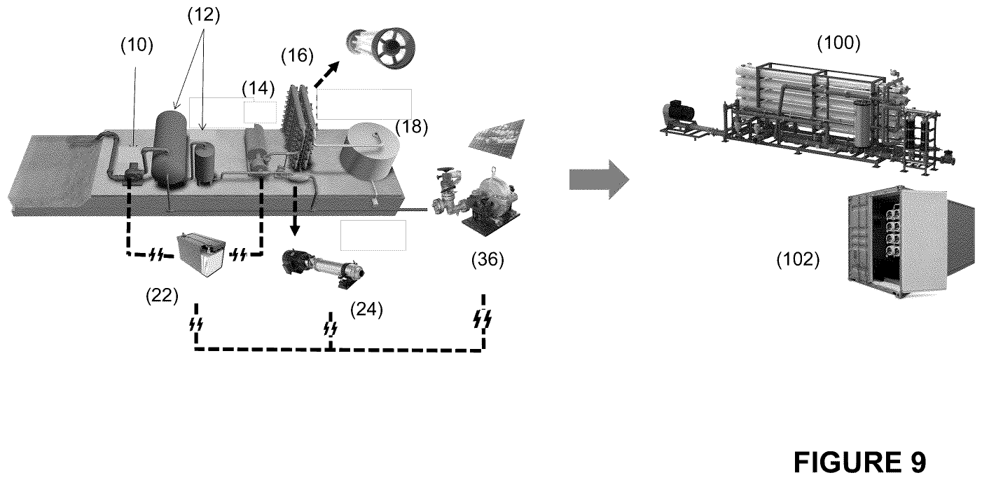

FIG. 9 is a diagram of a system of FIG. 8 which is mobile. Specifically, all of the components of FIG. 8 are affixed to a unit (100) which may be transported. The unit may optionally be enclosed within a container (102).

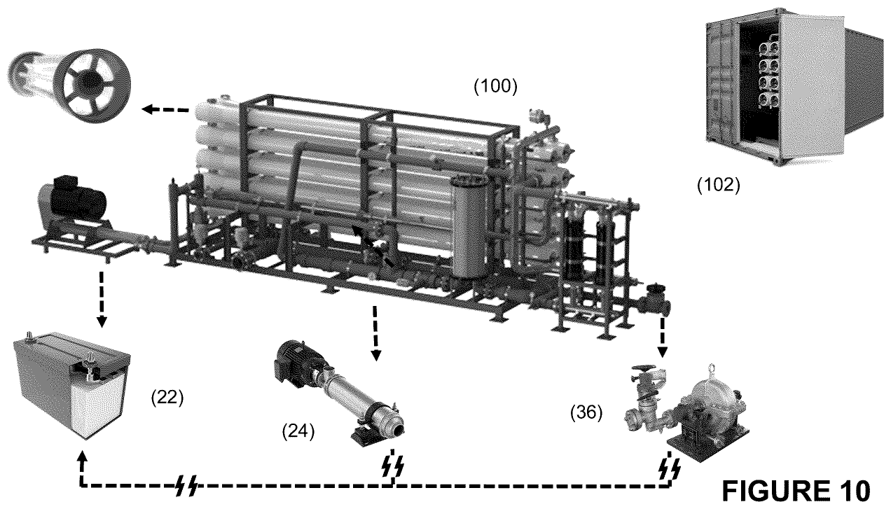

FIG. 10 is a diagram of an industrial scale mobile component of FIG. 8 including a concentrate recycling component. Specifically, all of the components of FIG. 8 are affixed to a unit (100) which may be transported. The unit may optionally be enclosed within a container (102).

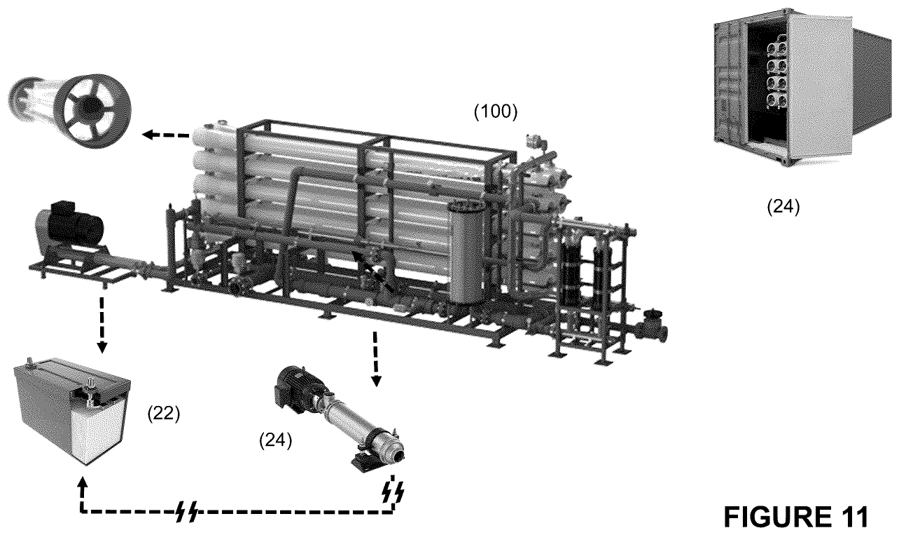

FIG. 11 is a diagram of an industrial scale mobile component of FIG. 8 lacking a fluid mixture recycling device (36). Specifically, all of the components of FIG. 8 absent the fluid mixture recycling device are affixed to a unit (100) which may be transported. The unit may optionally be enclosed within a container (102).

### EXAMPLES

The following examples were performed as independently described and using the information provided in DJ du Toit, Alternative Solution to improve the energy efficiency of the Reverse Osmosis Filter System, 2013, which is attached hereto as Appendix A.

### Example 1: Production of the Filter Element

Each membrane vane was prepared by cutting a pre-manufactured rigid sheet of porous stainless steel into specified membrane vane heights with a water saw. The central tube was then cut into 3 tubes to fit into a 1 m pressure vessel. Channels and holes were drilled into central tube and the membrane vanes were assembled around central permeate tube using a pre-fabricated mold. Epoxy was applied along three edges of the membrane vanes to seal the edges and fix onto central tube. A pre-manufactured reverse osmosis membrane was then wrapped around each membrane vanes. The membranes were sealed with end caps on either side (same geometric shape as filter) and glued along the length of central permeate pipe. Three filter elements were fitted together to form a filter element one meter in length. A flow diffuser unit was fitted to front end of filter element.

The feed water flow channel is closed and sealed by annular end covers (coated with glue inside and having the same geometric shape as the filter), blocking outer areas of the two end surfaces of the filter element respectively after the water purification membrane vanes are assembled around the central permeate tube. A gap is provided between the central permeate tube and each of the end covers to form raw water inlets. The annular end covers are configured to allow the feed flow to enter from one end and the permeate and concentrate to exit from the other end. (See FIG. 1).

### Example 2: Assembly of the Filter Elements

Filter elements described herein may be utilized in methods of filtering fluid mixtures. Comparative data using an Axeon HF4-4040 extra low energy 2500 GPD filter element Membrane (100 psi) was also generated.

Specifically, a number of filter elements described herein were placed into a pressure vessel was fitted with inflow, outflow and permeate flow control valves as well as a number of pressure tappings for pressure measurement along its length. The 4″×40″ stainless steel pressure vessel operated at a pressure of 250 psi. The pressure vessel also contained rotameters to measure the flow at the inlet and outlet side of the test pressure vessel (and thus at the inlet and outlet from the test filters). The control valves were at ¾ inch in diameter with BSP connections to work at 125 psi. The specifications for the rotamers include (i) connection type: ¾ BSP, (ii) device type flow indicator, (iii) maximum flow rate: 22 L/min, (iv) maximum operating temperature: 60° C., (v) maximum pressure: 10 bar, (vi) media monitored liquid, and (vii) minimum flow rate: 4 L/min. The inlet side represents the feed flow and the outlet side represents the concentrate flow: The permeate flow was measured by accurate mass flow measured over the timed test period using a digital mass measuring scale. The pressure vessel was also equipped with a Futek PMP 942 pressure sensor which formed a multi-point measuring manifold to measure the pressure losses over the different filter elements while exposed to the same parameters of the flow in the pressure vessel (velocity, viscosity, density, pressure, losses and flux).

Data was evaluated using a NI-DAQ data logging and analysis system. Pressure sensor readings were transferred via the amplifier into the multichannel controller which was processed using LabView software into a data logger stack. The absolute pressure sensors were digitally characterized and the readings subtracted within the sensors software to produce a high accuracy differential pressure reading. A fully configurable touchscreen display permitted the choice of parameters to display on the NI-DAQ data acquisition system and data logger and in which graphical format such as chart, bar graph, dials or numeric values. The operational pressure to produce maximum product water or permeate, total pressure losses under different operational pressures, feed flow as applied to energy efficiency and recovery potential, and permeate (product water) was monitored.

Pressurized water with a 100 meter water head from existing water main (tap water at 550 ppm) was delivered the feed flow to the pressure vessel containing the respective filter elements. With regulating valves, the feed flow flowed through the flow meter to regulate the testing operational flow, to produce pressure loss at different flow rates at fixed operational time periods for the experiment.

The pressurized feed water, at a fixed applied pressure of 88.08 Psi (6.1 bar), pushed the experimental feed water at a velocity of 0.6 to 1.1 m/sec and up to 5.6 bar (100 psi) pressure, over the filter element described herein located within the pressure vessel and a porous medium prior art filter element over a period of 8 minutes at a Q_{feed} flow rate of 4, 6, 8, 10 or 12 L/min. Permeate (product water) was produced, collected into a water container on a measuring scale to measure the flux rates of the two cases. The concentrate flowed from the filter elements through the flow meter and control valve, to the discharge opening at atmospheric pressure.

Twenty five readings were taken @100 mHz per second with the NI-DAQ software, which registered within the Futek 942 pressure sensors software, to produce high accuracy differential pressure readings. This gave a total reading sample of 58,000 readings per test, for that particular flow rate. To evaluate the divergence the total readings for all the tests were 290,000 readings (for the prior art filter element) and 232,000 readings for the novel filter element described in Example 1.

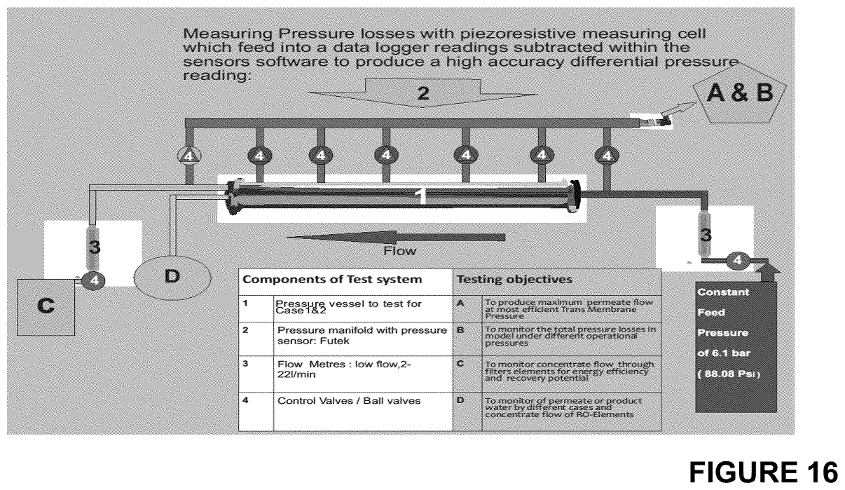

A fully configurable screen display allowed the operator to choose which parameters to display on the NI-DAQ data acquisition system and data logger. This helped with assessment and interruptions of the test results. For the divergence comparisons between the cases, the test points were at the same locations. See, FIG. 16.

### Example 3: Filtration Using the Filter Elements

A. Performance Specification for the Novel Filter Element Described in Example 1 (Test Model/Prototype: 1500 ppm)

### (i) Key Concepts for Case 2: DDT-Filter

### (a) Flow Over Porous Media: Feed Water

The alternative RO membrane filter (DDT-Filter) was developed using Navier-Stokes equations (Koutsou et al. 2004, 2009; Philip Darzin et al, 2005) to a generalized form of Darcy's law, employed in the simulations for capturing the essential features of the flow field over porous media and work done by Beatrice Riviere (Rivière Bétrice, 2008). The equations governing the incompressible fluid flow, boundary conditions and complex flows over porous medium was based on Adler's work (Adler, P. M, 1992; A. E. P. Veldman, 2012). The challenges of the optimization of conceptual design process for the DDT-Filter were:
Lower Trans membrane pressure (TMP) because the TMP acts as the driving force for a membrane filter process and
Improvement on membrane operational performance in this following area:
   Overcoming fouling constraints through the development of an alternative membrane geometry;
   High volume flux generation and
   Mass balance of Flow

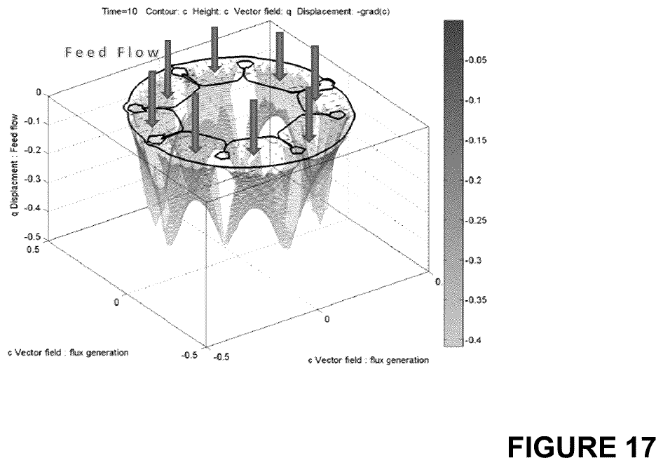

The Geometry flow concept through the filter ELEMENT is described below. The fluid mechanics modelling was based on the application of the Partial Differential Equation Toolbox from Matlab (The Math Works Inc., PDE Tool Box, 2013). The equations below were used to produce the MATLAB Simulation results of feed flow through the filter. FIG. 17 is a MATLAB simulation of the feed flow through the filter element described herein used in the development stage for the optimization of the Trans Membrane Pressure performance over the membrane. The figure shows the velocity field in a snap shot over a 10 second time slice (The Math Works Inc., PDE Tool Box, 2013).

An effective feed stream channel geometry configuration over the filter element membrane described herein provides a high mass transfer rate from the membrane wall to the feed stream in order to reduce the wall concentration. This was based on the eigenvalue coefficients used from the technical specifications for the different components to simulate velocity field with the different boundary conditions (The Math Works Inc., PDE Tool Box, 2013; Dean G Duffy, 2011; A. E. P. Veldman, 2012).

The elliptic and parabolic equations were used for modelling the flows over porous media, diffusion problems and potential feed flow. The basic equation addressed by the software is the PDE expressed in Ω in Equation 18 (The Math Works Inc., PDE Tool Box, 2013).

$$Valued Stream Function \qquad Equation 18$$

$$- ∇ \cdot ( c \cdot ∇ \cdot u ) + a \cdot u = f$$

Matlab refers to this as the elliptic equation, regardless of whether its coefficients and boundary conditions make the PDE problem elliptic in the mathematical sense. The spatial operators for the first and second order time derivatives, respectively Ω is a bounded domain in the plane. c, a, f, and the unknown u are scalar, complex valued functions defined on Ω. The Ω. represents the geometry in Section (ii). The coefficient c can be a 2-by-2 matrix function on Ω.

The eigenvalue problems are used for determining flow over the membranes. The basic equation used in the PDE Toolbox for the eigenvalue problem is expressed in Equation 19 (The Math Works Inc., PDE Tool Box, 2013).

$$Eigenvalue Problem \qquad Equation 19$$

$$- ∇ \cdot ( c \cdot ∇ \cdot u ) + a \cdot u = λ \cdot d \cdot u$$

where d is a complex valued function on Ω, and λ is an unknown eigenvalue. The Ω. represents the geometry in section (ii).

### (ii) Geometry

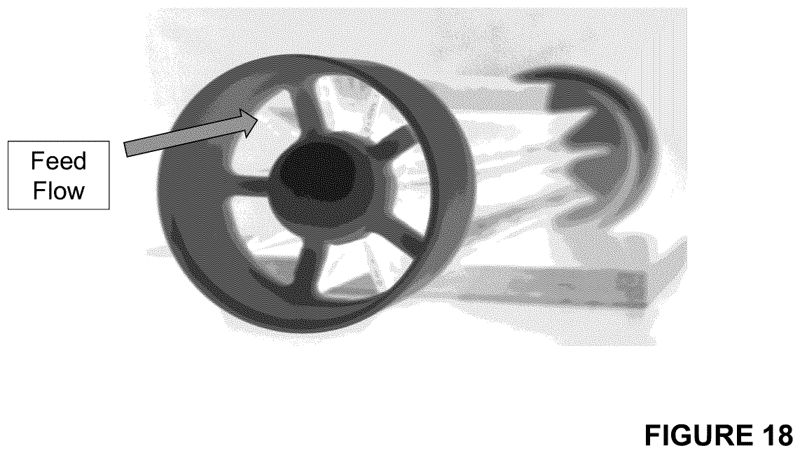

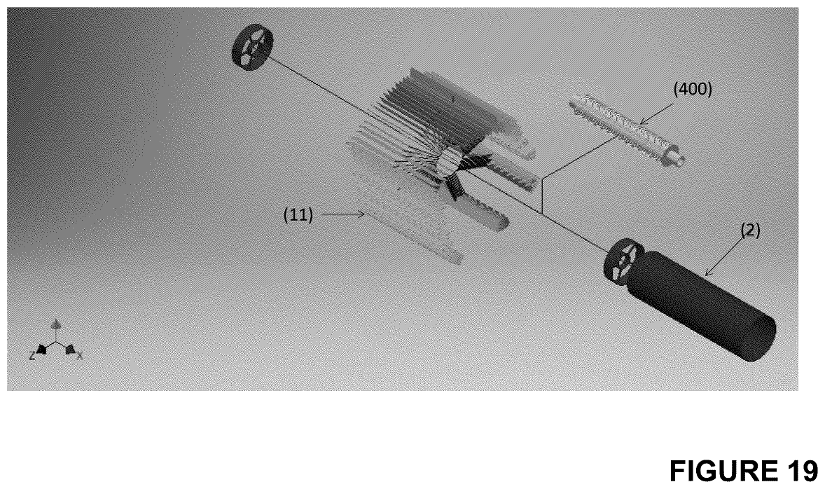

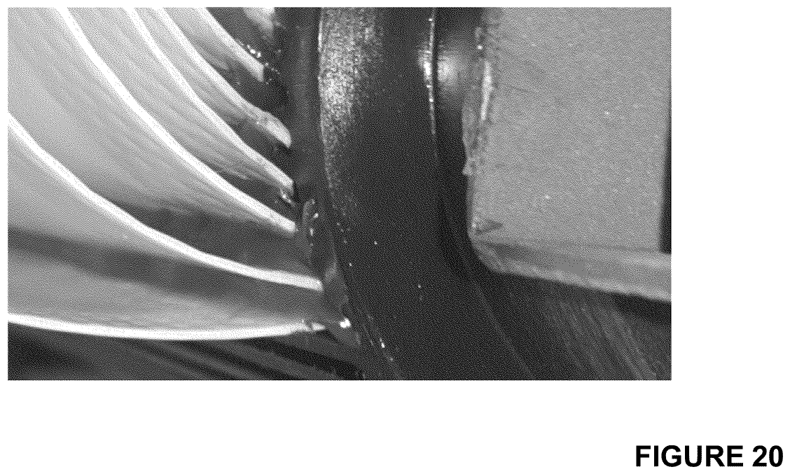

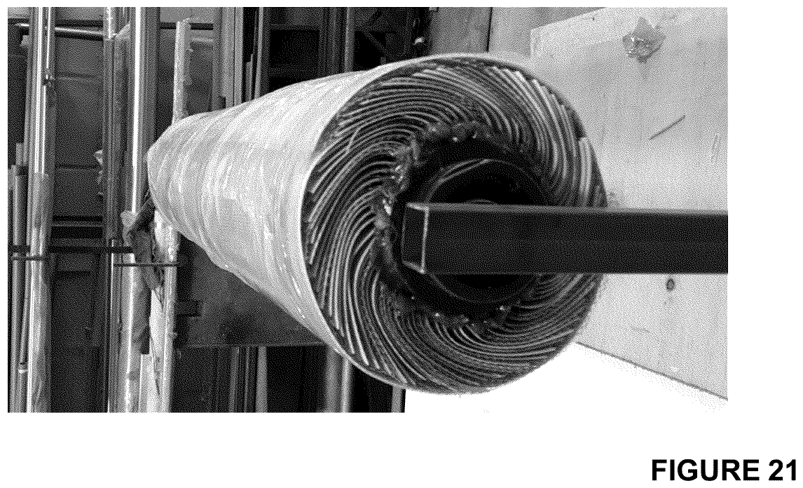

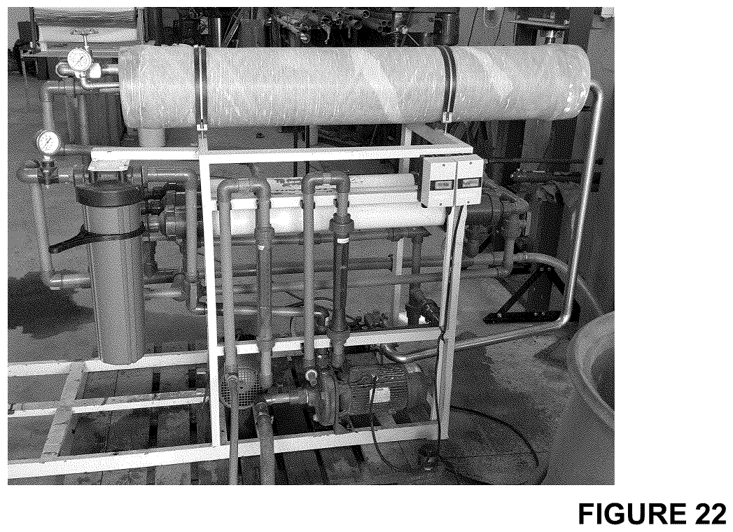

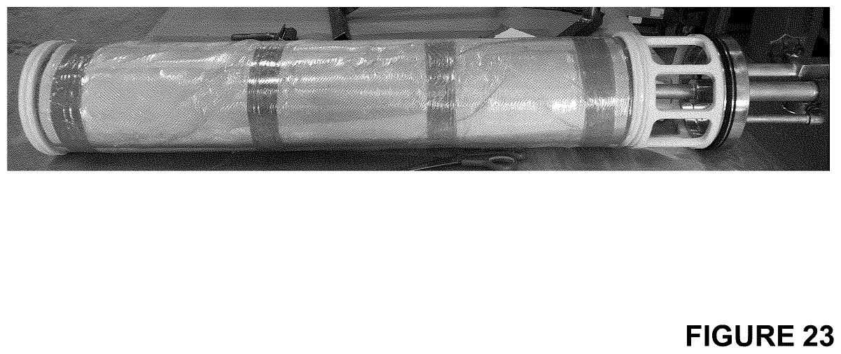

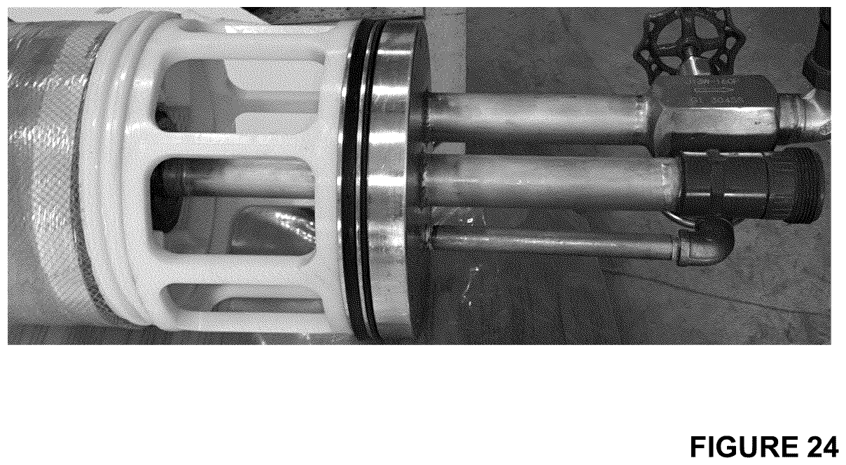

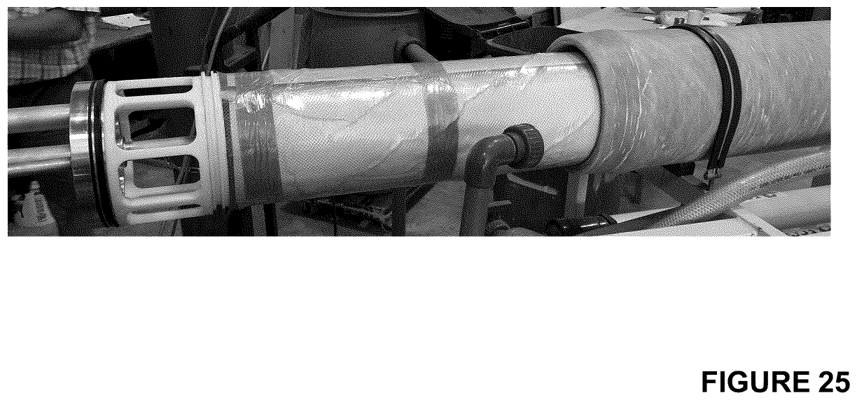

The geometry definition of the different membrane elements can be arranged in a number of configurations, within the concentric pressure vessel spatial domain, depending on application, as shown in FIG. 18 for the filter element described herein.

In the filter element described herein, membrane elements are used to produce potable water from feed water by filtering out the ionic and particulate matter contained in the feed flow and indicative illustrations in FIGS. 17 and 18. Pressurized feed flow enters the pressure vessels and flows through the channels between the membrane elements. The laminate geometric mat design of the membrane elements are to produce permeate (product water) from feed flow by filtering out the ionic and particulate matter contained in the concentrate flow.

The application of the filter element for a desalination plant's modular design and plant size is scaled according to potable water demand. The same modular design approach has been applied to the filtration of the plant.

The filter element was developed to produce a greater flux at lower TMP pressures. Table 1 shows the performance specification from the filter element of Example 1 and is based on 100 psi applied pressure. Permeate flow and salt rejection was based on the following test conditions: 550 ppm, softened tap water at 25° C., 15% permeate recovery, 6.5-7.0 pH range, data taken after 30 minutes of operation. Minimum salt rejection is 96%. Permeate flow for individual elements may vary±20%.

TABLE 1

| Description (per element) | Parameter |
|---|---|
| Permeate flow rate | 3,500 gpd |
| Dimension | Diameter = 100 mm |
| | Length = 1000 mm |
| Hydraulic diameter | 5 mm in average in Feed Channel in |
| | concentrate side of porous medium or |
| | laminate membrane compensate structure. |
| Minimum concentrate flow | 25% of feed flow |
| Flux (l/m/m²) | 13.20 |
| Max permeate flow rate | 55% of feed flow |
| Hydraulic pressure loss | 2.5 to 5.5 psi |
| Energy Use | 0.20 to 0.44 Kw/h/m³ |

### B. Operational Data for the Novel Filter Element Described in Example 1 (TDS=15,000 to 35,627 ppm TDS)

The indicative operating data for the Seawater RO-plant utilizing a filter described herein is given below. To derive the SWRO Plant's operational indicators for a filter described herein, the following assumptions were made to set the parameters for the SWRO Plants operational criteria or highest TDS value:
(a) For Osmotic pressure, calculations were based on 35,627.0 ppm TDS and Equation 7 was applied;
(b) The indicative operational pressure was derived by multiplying the theoretical osmotic pressure by 2 as recommended by the Industry for an indication or indicative reference (US EPA's Office of Water, 2005);
(c) Flow modelling and geometry concepts described herein were applied in operational flow model;
(d) Recovery rates used were the same as the comparative spiral wound membrane for a conservative approach for operational performance for a filter described herein.
(e) Design for flux and salinity distribution: Flux rates were based on technical data for porous sizes <0.01 microns. To lower the salinity in the pressure vessel and with the higher flux rates, 5 filter elements were used in a pressure vessel;
(f) Design concept: Applying the split partial second pass with a partial two pass RO configuration. The key factor is to lower the number of filter elements and operating osmotic pressure.
(g) ERD: Calculations were based on the PX-220 ERD device in the energy performance and energy use for a filter described herein. This ERD was selected, the cost and availability of power (Kwh) or potential energy to be harvested at the concentrate flow of the plant. This must be balanced with the capital cost of the device(s), the design and cost of any necessary peripherals and detailed consideration of life-cycle cost issues such as maintenance downtime and operational flexibility (Lifetime Durability of Ceramic PX™ Energy Recovery Devices, 2011).

### (i) Osmotic Calculation

The osmotic pressure is based on theoretical calculations and gives the reader an indication about the operational pressure of a reverse osmosis system. The osmotic pressure was calculated using Equation 7.

$$π = \sum \frac{R \cdot T \cdot {c}_{i} {z}_{i}}{{M}_{i}} \qquad ( 7 )$$

where:
π=osmotic pressure (Pa)
R=gas constant (J/K·mol)
T=temperature (° K)
Mᵢ=molecular weight ion (g/mol)
cᵢ=concentration ion (g/m³)
zᵢ=valence ion (−)

The indicative osmotic data from a seawater plant in Table 2 below, gives an indication for an operational filter element system. Table 2 below outlines the osmotic input and the output values for the indicative operational pressure for a filter described herein.

TABLE 2

| Input: Element of | Concentration | | |
|---|---|---|---|
| Sea Water | (mg/L) | Output of Calculations | |
| Potassium (K⁺) | 390.0 | TDS (ppm) | 35,627.0 |
| Sodium (Na⁺) | 10,900.0 | Total molality (mol/kg) | 1,135.7 |
| Magnesium (Mg²⁺) | 1,310.0 | Osmotic pressure (bar) | 25.696 |
| Calcium (Ca²⁺) | 410.0 | Indication about of | 53.963 |
| Strontium (Sr²⁺) | 13.0 | operational pressure (bar) | |
| Barium (Ba²⁺) | 0.05 | | |
| Bicarbonate (HCO₃⁻) | 152.0 | | |
| Nitrate (NO₃⁻) | 0.6 | | |
| Chloride (Cl⁻) | 19,700.0 | | |

| | |
|---|---|
| Fluoride (F⁻) | 1.4 |
| Sulfate (SO₄²⁻) | 2,740.0 |
| Silica (SiO²) | 5.0 |
| Boron (B) | 5.0 |

### (ii) Flux Calculation

In the flow model, the recovery rate for the filter element at a 35,621 ppm TDS is required. The hydraulic conductivity gradient of the industry (comparative spiral wound membrane) was used to represent the decrease in flux rate recovery rate and porous size of membrane filtration when the TDS and osmotic pressures increased.

The objective was to make a realistic assumption for the recovery rate of a filter described herein to be used in the operational flow model. All recovery rates for industry (comparative spiral wound membrane) were obtained through pilot testing. Therefore, the recovery rates for the comparative spiral wound membrane are based on current operational data from operational plants.

The two critical assumptions are the recovery rate and the osmotic pressure for the filter element. The flow model was run for both Cases.

For the prior art comparative spiral wound membrane's simulation, the input data was based on actual data from Hydranautics and based on their flow model.

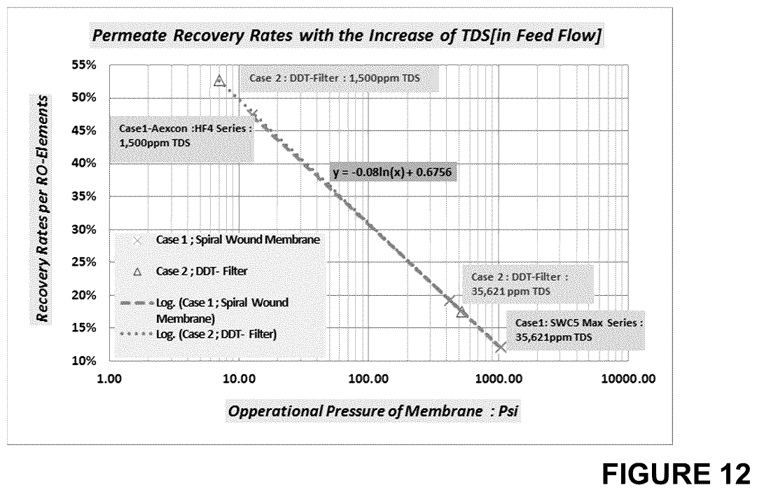

For simulation of a filter described herein, the osmotic pressure, operational pressure and the cross flow with a recovery rate was determined to be 21%. See FIG. 12 for the filter element recovery assumptions for operational simulation. Test results shown in FIG. 12 indicate consistency in recovery rate with operational pressure across both the filter element of the disclosure and the Axeon spiral-wound—therefore recovery rates and osmotic pressures from the comparative spiral wound membrane will be assumed same for the DD-filter.

(iii) Design for Flux and Salinity Distribution

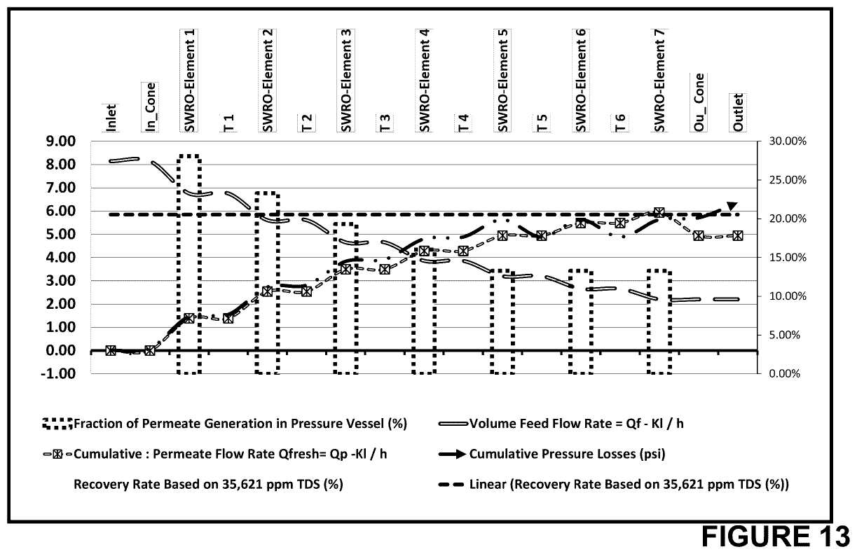

In the operation of a prior art spiral wound RO plant with multiple RO elements working in a pressure vessel, the front RO elements produced higher flow of low salinity permeate than elements at the back of the pressure vessel. FIG. 13 indicates the combined salinity and flux distribution in the pressure vessel for a filter described herein with 5 high flow seawater DD filters in series.

The flux and salinity distribution for a filter described herein was based on assumptions discussed below using the filter element described herein on seawater feed. The first 3-4 elements in the pressure vessel produced about 70-85% of the total permeate flow with an estimated combined salinity just above 300 mg/l. The last 1 to 2 elements produced the remaining permeate flow with a combined salinity of above 1500 mg/l. This information was used in the Operational Flow model. See Table 3 below and FIG. 13.

TABLE 3

| | | | Cumula- | | Recovery | Cumula- | | | | | |
|---|---|---|---|---|---|---|---|---|---|---|---|
| | | | tive | Volume | Rate | tive | | Fraction of | | | Average |
| | | | Time: | Feed | based on | Permeate | | Permeate | | Cumula- | Fluctuating |
| | | Cumula- | Filter | Flow | 35,621 | Flow Rate | Permeate | Generation | Energy | tive | Operational |
| | | tive | Section | Rate | ppm TDS | Q_{fresh} | Flow Rate | in Pressure | Use | Pressure | Pressure |
| | Length | Length | (sec) | (KI/h) | (%) | (KI/h) | (KI/h) | Vessel | (Kwh/m³) | Loss (%) | (psi) |
| Inlet | 0.15 | 0.15 | 0.03 | 7.82 | — | 0.00 | — | — | 7.96 | 0.01 | 390.00 |
| In_Cone | 0.10 | 0.25 | 0.05 | 7.82 | — | 0.00 | — | — | 7.96 | 0.09 | 389.91 |
| Filter | 1.000 | 1.25 | 0.16 | 6.49 | 20.54 | 1.44 | 1.33 | 28.07 | 6.58 | 1.47 | 388.53 |
| Element 1 | | | | | | | | | | | |
| T1 | 0.10 | 1.35 | 0.18 | 6.49 | — | 1.33 | — | — | 6.58 | 1.55 | 388.45 |
| Filter | 1.000 | 2.35 | 0.29 | 5.38 | 20.54 | 2.44 | 1.11 | 23.29 | 5.44 | 2.73 | 387.27 |
| Element 2 | | | | | | | | | | | |
| T2 | 0.10 | 2.45 | 0.31 | 5.38 | — | 2.44 | — | — | 5.44 | 2.81 | 387.19 |
| Filter | 1.000 | 3.45 | 0.42 | 4.47 | 20.54 | 3.36 | 0.92 | 19.32 | 4.50 | 3.84 | 386.16 |
| Element 3 | | | | | | | | | | | |
| T3 | 0.10 | 3.55 | 0.44 | 4.47 | — | 3.36 | — | — | 4.50 | 3.92 | 386.08 |
| Filter | 1.000 | 4.55 | 0.55 | 3.70 | 20.54 | 4.12 | 0.76 | 16.03 | 3.73 | 4.80 | 385.20 |
| Element 4 | | | | | | | | | | | |
| T4 | 0.10 | 4.65 | 0.57 | 3.70 | — | 4.12 | — | — | 3.73 | 4.88 | 385.12 |
| Filter | 1.000 | 5.65 | 0.68 | 3.07 | 20.54 | 4.75 | 0.63 | 13.3 | 3.08 | 563 | 384.37 |
| Element 5 | | | | | | | | | | | |
| Ou_Cone | 0.10 | 5.75 | 0.70 | 3.07 | — | 4.75 | — | — | 3.08 | 5.71 | 384.29 |
| Outlet | 0.15 | 5.90 | 1.04 | 3.07 | — | 4.75 | — | — | 3.08 | 6.36 | 383.64 |

### (iv) Operational Flow Data for Filter Element

The operational outputs for a filter described herein and prior art filter element are summarized in Tables 4A and 4B, respectively. The plants use split partial second pass design.

TABLE 4A

| | | | |
|---|---|---|---|
| | 250,000 | 133,000 | 54,000 |
| Plant Capacity | m³/day | m³/day | m³/day |

Filter Elements

| | | | |
|---|---|---|---|
| # trains-1^{st} pass | 16 | 8 | 4 |
| # trains-2^{nd} pass | 8 | 4 | 2 |
| # PV-filter element per train | 142 | 142 | 142 |
| filter elements per PV | 5 | 5 | 5 |
| 1^{st} pass element type: high flow | 16250 | 16250 | 13586 |
| filter element (gpd) | | | |
| active membrane area (m²) | 16.109 | 16.109 | 16.109 |
| dimension of the filter element | diameter = | diameter = | diameter = |
| (inches) | 16 | 16 | 16 |
| | length = 40 | length = 40 | length = 40 |
| # of filter elements/train | 710 | 710 | 710 |
| total number of filter elements | 11360 | 5600 | 2840 |

Operation of Filter elements

| | | | |
|---|---|---|---|
| Total Concentrate Flow (m³/day) | 445937 | 173397 | 54343 |
| Total Permeate flow (m³/day) | 256326 | 128163 | 54343 |
| feed pressure (psi) | 520 | 520 | 520 |
| concentrate pressure (psi) | 422 | 438 | 449 |
| permeate pressure (psi) | 15 | 15 | 15 |
| net driving pressure (psi) | 158.7 | 153.7 | 135 |
| average fluctuating operational | 378 | 387 | 390 |
| pressure (psi) | | | |
| concentrate factor | 1.53 | 1.54 | 1.55 |
| concentration after 1^{st} pass (ppm) | 45101 | 46343 | 49609 |
| water transport coefficient (kPa) | 1.5 × 10⁻⁸ | 1.52 × 10⁻⁸ | 1.48 × 10⁻⁸ |
| salt transport coefficient (m/s) | 4.33 × 10⁻⁷ | 4.21 × 10⁻⁷ | 3.30 × 10⁻⁷ |
| system flux (gfd) | 32 | 32 | 27 |

1^{st} pass permeate flow

| | | | |
|---|---|---|---|
| 1^{st} pass permeate flow @ 21° C. | 16250 | 16250 | 13586 |
| per train (m³/day) | | | |
| 1^{st} pass permeate recovery per | 36.50 | 42.50 | 50 |
| PV (%) | | | |
| 1^{st} pass feed pressure (psi) | 956 | 956 | 1044 |
| at 21° C. | | | |
| 1^{st} pass flux per train (Vm²/h) | 59.20 | 59.20 | 49.49 |

2^{nd} Pass Permeate Flow

| | | | |
|---|---|---|---|
| 2^{nd} pass permeate flow @ 21° C. | 13764 | 13764 | 11507 |
| per train (m³/day) | | | |
| 2^{nd} pass permeate recovery per | 90 | 90 | 96 |
| PV (%) | | | |
| 2^{nd} pass feed pressure (psi) | 135 | 135 | 135 |
| at 21° C. | | | |
| 2^{nd} pass flux per train (Vm²/h) | 330 | 330 | 330 |

Energy Use (Kwh/m³)

| | | | |
|---|---|---|---|
| Power = [(Q * SG* TDH/102 * | 740331 | 324990 | 120022 |
| Pn)/Mn] * 24 hours (kWh/day) | | | |
| Q = feed flow (L/sec) | 9402.47 | 4127.49 | 1524.32 |
| SG = fluid spec gravity | 1.02 | 1.02 | 1.02 |
| (kg/L) = 1 | | | |
| TDH = total head developed in | 365.60 | 365.60 | 365.60 |
| meter water | | | |
| pump efficiency (Pn: %) | 85 | 85 | 85 |
| motor efficiency (Mn; %) | 95 | 95 | 95 |
| Production of Permeate (Kwh/m³) | 2.89 | 2.54 | 2.21 |
| ERD: power savings | 421989 | 188494 | 72013 |
| SPSP design energy savings @, | 34055 | 14950 | 5521 |
| 4.6% | | | |
| plant pump requirement | 318342 | 139746 | 51609 |
| Production of permeate with ERD | 1.11 | 0.95 | 0.78 |
| option (Kwh/m³) | | | |

TABLE 4B

| | | | |
|---|---|---|---|
| | 250,000 | 133,000 | 54,000 |
| Plant Capacity | m³/day | m³/day | m³/day |

Filter Elements

| | | | |
|---|---|---|---|
| # trains-1^{st} pass | 16 | 8 | 4 |
| # trains-2^{nd} pass | 8 | 4 | 2 |
| # PV-filter element per train | 163 | 165 | 112 |
| filter elements per PV | 7 | 7 | 8 |
| 1^{st} pass element type: high flow | 9900 | 9900 | 7000 |
| filter element (gpd) | | | |
| active membrane area (m²) | 40.4 | 40.4 | 37.2 |
| dimension of the filter element | diameter = 8 | diameter = 8 | diameter = 8 |
| (inches) | length = 40 | length = 40 | length = 40 |
| # of filter elements/train | 1141 | 1155 | 896 |
| total number of filter elements | 18256 | 9240 | 3584 |

Operation of Filter elements

| | | | |
|---|---|---|---|
| Total Concentrate Flow (m³/day) | 441941 | 175794 | 54375 |
| Total Permeate flow (m³/day) | 256326 | 128163 | 54343 |
| feed pressure (psi) | 1048.35 | 1048.35 | 1048.35 |
| concentrate pressure (psi) | 946.85 | 946.85 | 946.85 |
| permeate pressure (psi) | 14.5 | 14.5 | 14.5 |
| net driving pressure (psi) | 460.84 | 445.38 | 404.60 |
| average fluctuating operational | 534.73 | 550.19 | 590.97 |
| pressure (psi) | | | |
| concentrate factor | 1.25 | 1.30 | 1.39 |
| concentration after 1^{st} pass (ppm) | 45099.58 | 46342.80 | 49607.35 |
| water transport coefficient (kPa) | 2.41 × 10⁻⁹ | 2.54 × 10⁻⁹ | 2.49 × 10⁻⁹ |
| salt transport coefficient (m/s) | 1.56 × 10⁻⁷ | 1.52 × 10⁻⁷ | 1.19 × 10⁻⁷ |
| system flux (gfd) | 11.69 | 11.69 | 9.82 |

1^{st} pass permeate flow

| | | | |
|---|---|---|---|
| 1^{st} pass permeate flow @ 21° C. | 16250 | 16250 | 13586 |
| per train (m³/day) | | | |
| 1^{st} pass permeate recovery per | 36.50 | 42.5 | 50.0 |
| PV (%) | | | |
| 1^{st} pass feed pressure (psi) at | 1048 | 1048 | 1048 |
| 21° C. | | | |
| 1^{st} pass flux per train (Vm²/h) | 14.69 | 14.51 | 16.98 |

2^{nd} Pass Permeate Flow

| | | | |
|---|---|---|---|
| 2^{nd} pass permeate flow @ 21° C. | 15662 | 15662 | 7831 |
| per train (m³/day) | | | |
| 2^{nd} pass permeate recovery per | 90 | 90 | 96 |
| PV (%) | | | |
| 2^{nd} pass feed pressure (psi) at | 135 | 135 | 135 |
| 21° C. | | | |
| 2^{nd} pass flux per train (Vm²/h) | 35.24 | 35.24 | 35.24 |

Energy Use (Kwh/m³)

| | | | |
|---|---|---|---|
| Power = [(Q * SG* TDH/102 * | 1513106 | 673552 | 228520 |
| Pn)/Mn] * 24 hours (kWh/day) | | | |
| Q = feed flow (L/sec) | 9531.96 | 4243.11 | 1439.58 |
| SG = fluid spec gravity | 1.02 | 1.02 | 1.02 |
| (kg/L) = 1 | | | |
| TDH = total head developed in | 737.06 | 737.06 | 737.06 |
| meter water | | | |
| pump efficiency (Pn: %) | 85 | 85 | 85 |
| motor efficiency (Mn; %) | 95 | 95 | 95 |
| Production of Permeate (Kwh/m³) | 5.90 | 5.26 | 4.21 |
| ERD: power savings | 474359 | 211159 | 71641 |
| SPSP design energy savings @ | 69603 | 30983 | 10512 |
| 4.6% | | | |
| plant pump requirement | 650636 | 289627 | 98264 |
| Production of permeate with ERD | 4.05 | 3.61 | 2.89 |
| option (Kwh/m³) | | | |

Table 4C below provides a comparison of data for a 250.000 m³/day plant capacity from Tables 4A and 4B.

TABLE 4C
Filter Elements

| | | Filter Element |
|---|---|---|
| | Prior Art | Described herein |
| # trains-1^{st} pass | 16 | 16 |
| # trains-2^{nd} pass | 8 | 8 |
| # PV-filter element per train | 163 | 142 |
| filter elements per PV | 7 | 5 |
| 1^{st} pass element type: high flow filter | 9900 | 16250 |
| element (gpd) | | |
| active membrane area (m²) | 40.4 | 16.109 |
| dimension of the filter element (inches) | diameter = 8 | diameter = 16 |
| | length = 40 | length = 40 |
| # of filter elements/train | 1141 | 710 |
| total number of filter elements | 18256 | 11360 |

Operation of Filter elements

| | | |
|---|---|---|
| Total Concentrate Flow (m³/day) | 441941 | 7 |
| Total Permeate flow (m³/day) | 256326 | 128163 |
| feed pressure (psi) | 1048.35 | 520 |
| concentrate pressure (psi) | 946.85 | 438 |
| permeate pressure (psi) | 14.5 | 15 |
| net driving pressure (psi) | 460.84 | 153.7 |
| average fluctuating operational pressure | 534.73 | 387 |
| (psi) | | |
| concentrate factor | 1.25 | 1.54 |
| concentration after 1^{st} pass (ppm) | 45099.58 | 46343 |
| water transport coefficient (kPa) | 2.41 × 10⁻⁹ | 1.52 × 10⁻⁸ |
| salt transport coefficient (m/s) | 1.56 × 10⁻⁷ | 4.21 × 10⁻⁷ |
| system flux (gfd) | 11.69 | 32 |

1^{st} pass permeate flow

| | | |
|---|---|---|
| 1^{st} pass permeate flow @ 21° C. per | 16250 | 16250 |
| train (m³/day) | | |
| 1^{st} pass permeate recovery per PV (%) | 36.50 | 36.50 |
| 1^{st} pass feed pressure (psi) at 21° C. | 1048 | 956 |
| 1^{st} pass flux per train (Vm²/h) | 14.69 | 59.20 |

2^{nd} Pass Permeate Flow

| | | |
|---|---|---|
| 2^{nd} pass permeate flow @ 21° C. per | 15662 | 13764 |
| train (m³/day) | | |
| 2^{nd} pass permeate recovery per PV (%) | 90 | 90 |
| 2^{nd} pass feed pressure (psi) at 21° C. | 135 | 135 |
| 2^{nd} pass flux per train (Vm²/h) | 35.24 | 330 |

Energy Use (Kwh/m³)

| | | |
|---|---|---|
| Power = [(Q * SG* TDH/102 * Pn)/ | 1513106 | 740331 |
| Mn] * 24 hours (kWh/day) | | |
| Q = feed flow (L/sec) | 9531.96 | 9402.47 |
| SG = fluid spec gravity (kg/L) = 1 | 1.02 | 1.02 |
| TDH = total head developed in meter | 737.06 | 365.60 |
| water | | |
| pump efficiency (Pn: %) | 85 | 85 |
| motor efficiency (Mn; %) | 95 | 95 |
| Production of Permeate (Kwh/m³) | 5.90 | 2.89 |
| ERD: power savings | 474359 | 421989 |
| SPSP design energy savings @ 4.6% | 69603 | 34055 |
| plant pump requirement | 650636 | 318342 |
| Production of permeate with ERD | 4.05 | 1.11 |
| option (Kwh/m³) | | |

In summary, to produce almost the same amount Permeate flow of 250,000 m³/day, the average FOP was reduced from 534.71 psi (37.1 bar) psi to 378.0 Psi (26.1 bar), while energy use was reduced from 4.05 Kwh/m³ to 1.11 Kwh/m³.

The filter described herein also has the capacity to lower the energy use further by 50% due to the lower FOP and to utilize the reminder of uncaptured energy in the system. This can be confirmed with pilot testing and the deeming of actual flux rates to optimize the operational performance.

### Example 4

This example was performed using a filter element of Example 1 in a filtration process. Table 5 shows the processing details for the filter element for duration=24 hours, temperature=21° C., pH=7, SDI=2, turbidity NTU=1, Cf=35,627 ppm, Cp=1100 ppm, Pf=35.87 bar, and Pp=1.00 bar

TABLE 5

| | | | | | Normalized Data for Train Application | | | | |
|---|---|---|---|---|---|---|---|---|---|
| | | | | | | | | Water | Salt |
| | Flows | | | Concentrate | Salt | Permeate | Differential | Transport | transport |
| Plant Capacity | Feed | Concentrate | Permeate | Pressure | Passage | Flow | pressure | Coefficient | coefficient |
| (mL/day/Train) | (m³/h) | (m³/h) | (m³/h) | (bar) | (%) | (m³/h) | (bar) | (m/s - kPa) | (m/s) |
| 250 - 1^{st} pass | 3479.45 | 2128.00 | 1351.45 | 29.08 | 198.66 | 1202 | 0.91 | 1.503 × 10⁻⁸ | 4.329 × 10⁻⁷ |
| 133 | 3189.46 | 1838.00 | 1351.46 | 30.21 | 193.34 | 1208 | 0.89 | 1.524 × 10⁻⁸ | 4.210 × 10⁻⁷ |
| 54 | 2249.40 | 1113.00 | 1135.40 | 30.96 | 151.73 | 1147 | 1.06 | 1.483 × 10⁻⁸ | 3.299 × 10⁻⁷ |
| 25 | 1135.40 | 567.70 | 567.70 | 32.10 | 76.20 | 536 | 0.83 | 6.915 × 10⁻⁹ | 1.657 × 10⁻⁷ |
| 15 - lower Re | 3798.65 | 2447.20 | 1351.45 | 28.68 | 203.48 | 1167 | 0.83 | 1.44 × 10⁻⁸ | 4.436 × 10⁻⁷ |
| 16 - lower Re | 4165.73 | 2814.28 | 1351.45 | 29.01 | 208.03 | 1104 | 0.68 | 1.36 × 10⁻⁸ | 4.538 × 10⁻⁷ |

Table 6 shows the output operational data for the filter element for a fluid mixture containing 15,000 to 35,627 ppm TDS, days=1, Tₒᵤₜₗₑₜ=21° C., outlet Cf=35,627 ppm, outlet Cp=1100 ppm, Pf=520 psi, outlet Pp=15 psi; outlet PP=12 psi, TCF=0.88, permeate flux=32 gfd, area=200 ft², Qp=7000 GPD, constant K=27000, net drive pressure=299.01 psi, Cf=32000 ppm, elements/vessel=5, and #vessels=240.

TABLE 6

| | | | | | | | | FOP | | | | | | |
|---|---|---|---|---|---|---|---|---|---|---|---|---|---|---|
| Plant Capacity | Rec | DP | Qcp | Qpo | Pco | ConF | Cfₐᵥₑ | ave | DPo | NDP | SFX | SSP | SSR | ASPn |
| (mL/day/Train) | (%) | (bar) | (gpm) | (gpm) | (psi) | (ppm) | (ppm) | (psi) | (psi) | (psi) | (gfd) | (%) | (%) | (%) |
| 250 - 1^{st} pass | 38.84 | 6.80 | 9369 | 5950 | 422 | 1.27 | 45101 | 310 | 98.53 | 158.67 | 32 | 2.44 | 97.56 | 2.81 |
| 133 | 42.37 | 5.66 | 8092 | 5950 | 438 | 1.30 | 46343 | 319 | 82.11 | 157.92 | 32 | 2.37 | 97.63 | 2.74 |
| 54 | 50.50 | 4.91 | 4900 | 4999 | 449 | 1.39 | 49609 | 343 | 71/.16 | 139.73 | 27 | 2.22 | 97.78 | 2.15 |
| 25 | 50.00 | 3.78 | 2500 | 2499 | 465 | 1.39 | 49389 | 341 | 54.74 | 149.54 | 14 | 2.23 | 97.77 | 1.08 |
| 15 - lower Re | 35.58 | 7.19 | 10775 | 5950 | 416 | 1.24 | 44032 | 302 | 104.26 | 163.49 | 32 | 2.50 | 97.50 | 2.88 |
| 16 - lower Re | 32.44 | 6.86 | 12391 | 5950 | 421 | 1.21 | 43069 | 296 | 172.77 | 172.77 | 32 | 2.55 | 97.45 | 2.95 |

### Example 5

This example was performed to analyze some geometric criteria for the filter element described herein. Accordingly, mathematical calculations were performed and active membrane areas for different applications were correlated with trans membrane pressure performance criteria. Geometric shape applications=low TMP for the filter element.

Proto-Type: Pressure Vessel Dimension: 4 Inch or Outside Diameter Casing = 0.100 m

| Inner Diameter of Filtration Element for | | | | | |
|---|---|---|---|---|---|
| Permeate Flow (m) | 35 | 40 | 42.5 | 50 | 55 |
| Membrane L1 thickness (m) | 0.0019 | 0.0019 | 0.0019 | 0.0019 | 0.0019 |
| Membrane L2 thickness (m) | 0.004 | 0.004 | 0.004 | 0.004 | 0.004 |
| Membrane Vanes thickness (m) | 0.0078 | 0.0078 | 0.0078 | 0.0078 | 0.0078 |
| Minimum Annular space for Q_{feed} @ Inner | 0.006 | 0.006 | 0.006 | 0.006 | 0.006 |
| Diameter of Filter Element (m) | | | | | |
| Membrane Vane Height (m) | 0.028 | 0.025 | 0.024 | 0.020 | 0.018 |
| # Membrane Vanes | 8 | 9 | 10 | 11 | 13 |
| Membrane Area per meter (m²) | 0.416 | 0.433 | 0.437 | 0.433 | 0.416 |
| Active Membrane Area per 1000 mm | 0.4164855 | 0.4327122 | 0.4367689 | 0.4327122 | 0.4164855 |
| Filtration Element (m²) | | | | | |
| Ratio between Pressure Vessel/Casing & | 0.350 | 0.400 | 0.425 | 0.500 | 0.550 |
| inner diameter | | | | | |
| Area 1: Total Cross Section Area of the | 0.007701 | 0.007701 | 0.007701 | 0.007701 | 0.007701 |
| Pressure Vessel (m²) | | | | | |
| Area 2: Cross Section Area of the Inner | 0.000963 | 0.001257 | 0.001419 | 0.001964 | 0.002377 |
| Diameter of Filter Element for Permeate Flow | | | | | |
| (m²) | | | | | |
| Area 3: Total Cross Section Area of Vanes in | 0.0017098 | 0.0017764 | 0.0017931 | 0.0017764 | 0.0017098 |
| Filter Element (m²) | | | | | |
| Annular feed flow Area: Total Cross Section | 0.0050285 | 0.0046672 | 0.0044885 | 0.0039601 | 0.0036142 |
| Area for Retentate/Concentrate Flow in | | | | | |
| Filter Element (m²) | | | | | |
| Area 4: Cross Section Area of the Porous | 0.0010259 | 0.0010658 | 0.0010758 | 0.0010658 | 0.0010259 |
| Area of the Laminate Vane | | | | | |
| Area 5: Long Section of Flow Direction: | 0.4164855 | 0.4327122 | 0.4367689 | 0.4327122 | 0.4164855 |
| Total # Vanes per Filter Element | | | | | |

Commercial Model for 4 Inch (100 mm) Pressure Vessel

| Inner Diameter of Filtration Element for | | | | | |
|---|---|---|---|---|---|
| Permeate Flow (m) | 35 | 40 | 42.5 | 50 | 55 |
| Membrane L1 thickness (m) | 0.0019 | 0.0019 | 0.0019 | 0.0019 | 0.0019 |
| Membrane L2 thickness (m) | 0.001 | 0.001 | 0.001 | 0.001 | 0.001 |
| Membrane Vanes thickness (m) | 0.0048 | 0.0048 | 0.0048 | 0.0048 | 0.0048 |
| Minimum Annular space for Q_{feed} @ Inner | 0.0024 | 0.0024 | 0.0024 | 0.0024 | 0.0024 |
| Diameter of Filter Element (m) | | | | | |
| Membrane Vane Height (m) | 0.031 | 0.029 | 0.027 | 0.024 | 0.021 |
| # Membrane Vanes | 15 | 17 | 19 | 22 | 24 |
| Membrane Area per meter (m²) | 0.900 | 0.945 | 0.961 | 0.975 | 0.958 |
| Active Membrane Area per 1000 mm | 0.8998611 | 0.9454762 | 0.9605084 | 0.9745040 | 0.9579167 |
| Filtration Element (m²) | | | | | |
| Ratio between Pressure Vessel/Casing & | 0.350 | 0.400 | 0.425 | 0.500 | 0.550 |
| inner diameter | | | | | |
| Area 1: Total Cross Section Area of the | 0.007701 | 0.007701 | 0.007701 | 0.007701 | 0.007701 |
| Pressure Vessel (m²) | | | | | |
| Area 2: Cross Section Area of the Inner | 0.000963 | 0.001257 | 0.001419 | 0.001964 | 0.002377 |
| Diameter of Filter Element for Permeate Flow | | | | | |
| (m²) | | | | | |
| Area 3: Total Cross Section Area of Vanes in | 0.0022733 | 0.0023886 | 0.0024265 | 0.0024619 | 0.0024200 |
| Filter Element (m²) | | | | | |
| Annular feed flow Area: Total Cross Section | 0.0044650 | 0.0040551 | 0.0038550 | 0.0032746 | 0.0029040 |
| Area for Retentate/Concentrate Flow in | | | | | |
| Filter Element (m²) | | | | | |
| Area 4: Cross Section Area of the Porous | 0.0013640 | 0.0014331 | 0.0014559 | 0.0014771 | 0.0014520 |
| Area of the Laminate Vane | | | | | |
| Area 5: Long Section of Flow Direction: | 0.8998611 | 0.9454762 | 0.9605084 | 0.9745040 | 0.9579167 |
| Total # Vanes per Filter Element | | | | | |

Commercial Model for 8 Inch (200 mm) Pressure Vessel
Pressure Vessel Dimension: 8 Inch or Outside Diameter casing = 0.200 m

| | Inner Diameter of Filtration Element for Permeate Flow (m) | | | | | | | | |
|---|---|---|---|---|---|---|---|---|---|
| | 80 | 85 | 90 | 95 | 100 | 105 | 110 | 115 | 120 |
| Membrane L2 | 0.001 | 0.001 | 0.001 | 0.001 | 0.001 | 0.001 | 0.001 | 0.001 | 0.001 |
| thickness (m) | | | | | | | | | |
| Membrane Vanes | 0.0048 | 0.0048 | 0.0048 | 0.0048 | 0.0048 | 0.0048 | 0.0048 | 0.0048 | 0.0048 |
| thickness (m) | | | | | | | | | |
| Minimum | 0.0024 | 0.0024 | 0.0024 | 0.0024 | 0.0024 | 0.0024 | 0.0024 | 0.0024 | 0.0024 |
| Annular space for | | | | | | | | | |
| Q_{feed} @ Inner | | | | | | | | | |
| Diameter of Filter | | | | | | | | | |
| Element (m) | | | | | | | | | |
| Membrane Vane | 0.057 | 0.055 | 0.052 | 0.050 | 0.047 | 0.045 | 0.042 | 0.040 | 0.037 |
| Height (m) | | | | | | | | | |
| # Membrane | 35 | 37 | 39 | 41 | 44 | 46 | 48 | 50 | 52 |
| Vanes | | | | | | | | | |
| Membrane Area | 3.782 | 3.842 | 3.881 | 3.982 | 3.898 | 3.875 | 3.832 | 3.767 | 3.682 |
| per meter (m²) | | | | | | | | | |
| Active Membrane | 3.7819048 | 3.8420337 | 3.8814286 | 3.9821964 | 3.8980159 | 3.8752083 | 3.8316667 | 3.7673909 | 3.6823810 |
| Area per | | | | | | | | | |
| 1000 mm | | | | | | | | | |
| Filtration Element | | | | | | | | | |
| (m²) | | | | | | | | | |
| Ratio between | 0.533 | 0.567 | 0.600 | 0.633 | 0.667 | 0.700 | 0.733 | 0.767 | 0.800 |
| Pressure | | | | | | | | | |
| Vessel/Casing & | | | | | | | | | |
| inner diameter | | | | | | | | | |
| Area 1: Total | 0.029571 | 0.029571 | 0.029571 | 0.029571 | 0.029571 | 0.029571 | 0.029571 | 0.029571 | 0.029571 |
| Cross Section | | | | | | | | | |
| Area of the | | | | | | | | | |
| Pressure Vessel | | | | | | | | | |
| (m²) | | | | | | | | | |
| Area 2: Cross | 0.0050286 | 0.0056768 | 0.0063643 | 0.0070911 | 0.0078571 | 0.0086625 | 0.0095071 | 0.0103911 | 0.0113143 |
| Section Area of | | | | | | | | | |
| the Inner | | | | | | | | | |
| Diameter of Filter | | | | | | | | | |
| Element for | | | | | | | | | |
| Permeate Flow | | | | | | | | | |
| (m²) | | | | | | | | | |
| Area 3: Total | 0.0095543 | 0.0097062 | 0.0098057 | 0.0098529 | 0.0098476 | 0.0097900 | 0.0096800 | 0.0095176 | 0.0093029 |
| Cross Section | | | | | | | | | |
| Area of Vanes in | | | | | | | | | |
| Filter Element | | | | | | | | | |
| (m²) | | | | | | | | | |
| Annular feed flow | 0.0149883 | 0.0141882 | 0.0134011 | 0.0126272 | 0.0118664 | 0.0111186 | 0.0103840 | 0.0096625 | 0.0089540 |
| Area: Total Cross | | | | | | | | | |
| Section Area for | | | | | | | | | |
| Retentate/ | | | | | | | | | |
| Concentrate Flow | | | | | | | | | |
| in Filter Element | | | | | | | | | |
| (m²) | | | | | | | | | |
| Area 4: Cross | 0.0057326 | 0.0058237 | 0.0058834 | 0.0059117 | 0.0059086 | 0.0058740 | 0.0058080 | 0.0057106 | 0.0055817 |
| Section Area of | | | | | | | | | |
| the Porous Area | | | | | | | | | |
| of the Laminate | | | | | | | | | |
| Vane | | | | | | | | | |
| Area 5: Long | 3.7819048 | 3.8420337 | 3.8814286 | 3.9821964 | 3.8980159 | 3.8752083 | 3.8316667 | 3.7673909 | 3.6823810 |
| Section of Flow | | | | | | | | | |
| Direction: Total # | | | | | | | | | |
| Vanes per Filter | | | | | | | | | |
| Element | | | | | | | | | |

Pressure Vessel Dimension: 16 Inches or Outside Diameter casing = 0.400 m

| | Inner Diameter of Filtration Element for Permeate Flow (m) | | | | |
|---|---|---|---|---|---|
| | 180 | 185 | 190 | 195 | 200 |
| Membrane L1 | 0.0019 | 0.0019 | 0.0019 | 0.0019 | 0.0019 |
| thickness (m) | | | | | |
| Membrane L2 | 0.001 | 0.001 | 0.001 | 0.001 | 0.001 |
| thickness (m) | | | | | |
| Membrane | 0.0048 | 0.0048 | 0.0048 | 0.0048 | 0.0048 |
| Vanes | | | | | |
| thickness (m) | | | | | |
| Minimum | 0.0024 | 0.0024 | 0.0024 | 0.0024 | 0.0024 |
| Annular space | | | | | |
| for Q_{feed} @ | | | | | |
| Inner Diameter | | | | | |
| of Filter | | | | | |
| Element (m) | | | | | |
| Membrane Vane | 0.104 | 0.102 | 0.099 | 0.097 | 0.094 |
| Height (m) | | | | | |
| # Membrane | 79 | 81 | 83 | 85 | 87 |
| Vanes | | | | | |
| Membrane Area | 15.526 | 15.573 | 15,600 | 15.607 | 15.592 |
| per meter (m²) | | | | | |
| Active | 15.5257143 | 15.5734028 | 15.6003571 | 15.6065774 | 15.5920635 |
| Membrane Area | | | | | |
| per 1000 mm | | | | | |
| Filtration | | | | | |
| Element (m²) | | | | | |
| Ratio between | 1.200 | 1.233 | 1.267 | 1.300 | 1.333 |
| Pressure | | | | | |
| Vessel/Casing & | | | | | |
| inner diameter | | | | | |
| Area 1: Total | 0.118285 | 0.118285 | 0.118285 | 0.118285 | 0.118285 |
| Cross Section | | | | | |
| Area of the | | | | | |
| Pressure Vessel | | | | | |
| (m²) | | | | | |
| Area 2: Cross | 0.0254571 | 0.0268911 | 0.0283643 | 0.0298768 | 0.0314286 |
| Section Area of | | | | | |
| the Inner | | | | | |
| Diameter of | | | | | |
| Filter Element | | | | | |
| for Permeate | | | | | |
| Flow (m²) | | | | | |
| Area 3: Total | 0.0392229 | 0.0393433 | 0.0394114 | 0.0394271 | 0.0393905 |
| Cross Section | | | | | |
| Area of Vanes in | | | | | |
| Filter Element | | | | | |
| (m²) | | | | | |
| Annular feed | 0.0536046 | 0.0520502 | 0.0505089 | 0.0489806 | 0.0474655 |
| flow Area: | | | | | |
| Total Cross | | | | | |
| Section Area for | | | | | |
| Retentate/ | | | | | |
| Concentrate | | | | | |
| Flow in Filter | | | | | |
| Element (m²) | | | | | |
| Area 4: Cross | 0.0392229 | 0.0459635 | 0.0394114 | 0.0394271 | 0.0393905 |
| Section Area of | | | | | |
| the Porous Area | | | | | |
| of the Laminate | | | | | |
| Vane | | | | | |
| Area 5: Long | 15.5257143 | 15.5734028 | 15.6003571 | 15.6065774 | 15.5920635 |
| Section of Flow | | | | | |
| Direction: Total | | | | | |
| # Vanes per | | | | | |
| Filter Element | | | | | |

| | Inner Diameter of Filtration Element for Permeate Flow (m) | | | |
|---|---|---|---|---|
| | 205 | 210 | 215 | 220 |
| Membrane L1 | 0.0019 | 0.0019 | 0.0019 | 0.0019 |
| thickness (m) | | | | |
| Membrane L2 | 0.001 | 0.001 | 0.001 | 0.001 |
| thickness (m) | | | | |
| Membrane | 0.0048 | 0.0048 | 0.0048 | 0.0048 |
| Vanes | | | | |
| thickness (m) | | | | |
| Minimum | 0.0024 | 0.0024 | 0.0024 | 0.0024 |
| Annular space | | | | |
| for Q_{feed} @ | | | | |
| Inner Diameter | | | | |
| of Filter | | | | |
| Element (m) | | | | |
| Membrane Vane | 0.092 | 0.089 | 0.087 | 0.084 |
| Height (m) | | | | |
| # Membrane | 89 | 92 | 94 | 96 |
| Vanes | | | | |
| Membrane Area | 15.557 | 15.501 | 15.424 | 15.327 |
| per meter (m²) | | | | |
| Active | 15.5568155 | 15.5008333 | 15.4241171 | 15.3266667 |
| Membrane Area | | | | |
| per 1000 mm | | | | |
| Filtration | | | | |
| Element (m²) | | | | |
| Ratio between | 1.367 | 1.400 | 1.433 | 1.467 |
| Pressure | | | | |
| Vessel/Casing & | | | | |
| inner diameter | | | | |
| Area 1: Total | 0.118285 | 0.118285 | 0.118285 | 0.118285 |
| Cross Section | | | | |
| Area of the | | | | |
| Pressure Vessel | | | | |
| (m²) | | | | |
| Area 2: Cross | 0.0330196 | 0.0346500 | 0.0363196 | 0.0380286 |
| Section Area of | | | | |
| the Inner | | | | |
| Diameter of | | | | |
| Filter Element | | | | |
| for Permeate | | | | |
| Flow (m²) | | | | |
| Area 3: Total | 0.0393014 | 0.0391600 | 0.0389662 | 0.0387200 |
| Cross Section | | | | |
| Area of Vanes in | | | | |
| Filter Element | | | | |
| (m²) | | | | |
| Annular feed | 0.0459635 | 0.0444746 | 0.0429987 | 0.0415360 |
| flow Area: | | | | |
| Total Cross | | | | |
| Section Area for | | | | |
| Retentate/ | | | | |
| Concentrate | | | | |
| Flow in Filter | | | | |
| Element (m²) | | | | |
| Area 4: Cross | 0.0393014 | 0.0391600 | 0.0389662 | 0.0387200 |
| Section Area of | | | | |
| the Porous Area | | | | |
| of the Laminate | | | | |
| Vane | | | | |
| Area 5: Long | 15.5568155 | 15.5008333 | 15.4241171 | 15.3266667 |
| Section of Flow | | | | |
| Direction: Total | | | | |
| # Vanes per | | | | |
| Filter Element | | | | |

### Example 7: Energy Use to Produce Permeate Flow

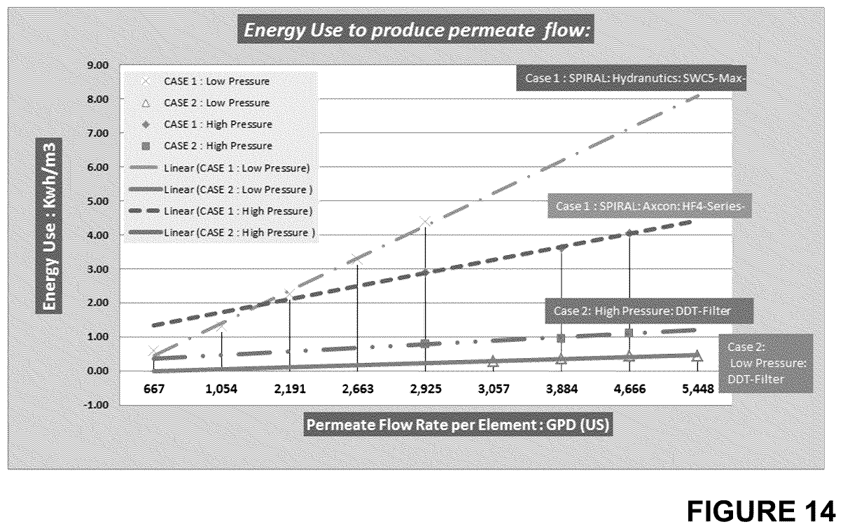

The filter element prepared as described in Example 1 was utilized to demonstrate the energy savings as compared to a prior art filter element. FIG. 14 presents the results from both cases for energy requirement to produce permeate flow. The plant operational simulation represents the high pressure scenario, while the experimental test results represent the low pressure scenario. Therefore the NDP or TMP comparisons for both cases are summarized in FIG. 14.

This section compares the two Cases with each other and evaluates the differences in performance. FIG. 14 indicates the improved performance of a filter described herein against a prior art filter, for the comparison to produce 2,925 GPD (7.59 l/min) permeate. The improvements are clear and substantial. To produce almost the same amount Permeate flow, the energy use for the low pressure membranes was reduced from 3.0 to 0.2 Kwh/m³, while energy use for the high pressure membrane reduced from 4.4 to 0.90 Kwh/m³. FIG. 14 shows that significantly less energy is required to produce permeate with the filter described herein in the high and low pressure environment.

### Example 8: Operational Cost Comparison for SWRO-Elements

The filter element prepared as described in Example 1 was utilized to estimate the low cost water production predicted when using the filter element described herein in pilot plants.

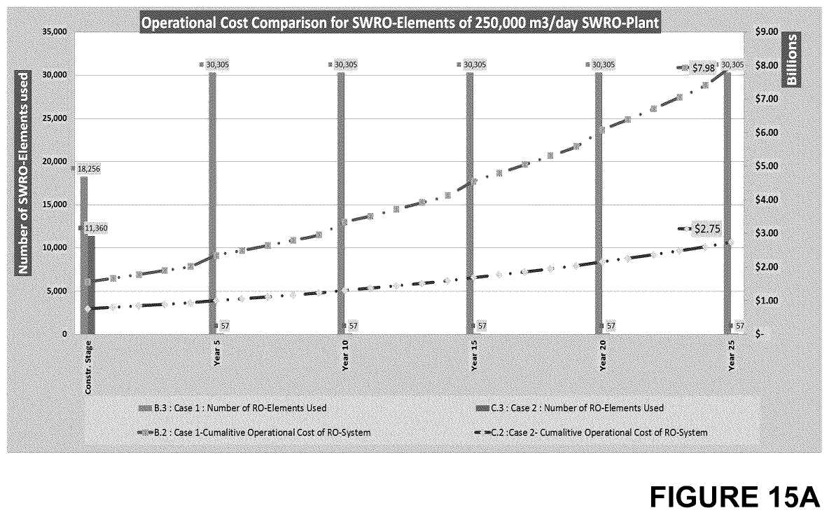

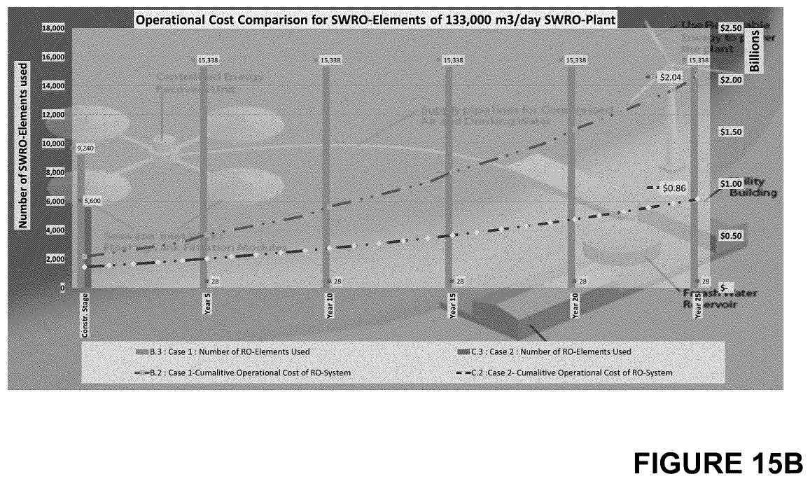

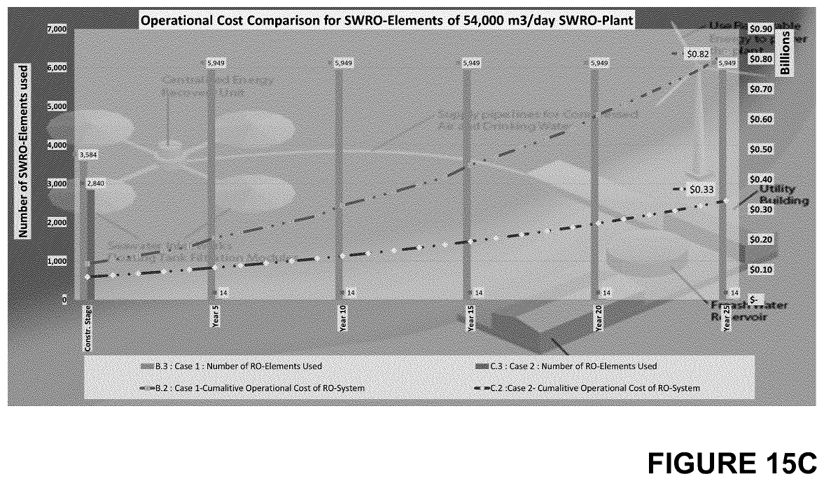

FIG. 15 represents the above advantages the filter element herein can bring to lower the operation and downtime cost of a system for 3 plant sizes, i.e., 250,000 m³/day (FIG. 15A), 133,000 m³/day (FIG. 15B), and 54,000 m³/day (FIG. 15C). From FIG. 15, it is clear that increasing the profit margin for water services providers and making investment more attractive by lowering the energy use and operating expenses.

FIG. 15 shows the FEV for a system to maintain and replace RO elements over the life span of the plant (approximately 25 years) (William G. Sullivan et al., 2012). FIG. 15 also shows the substantial improvement of novel filter element described herein over the prior art spiral-wound filter element. The total operational expenditure is expressed in the FEV for a 250,000 m³/day plant, where the present filter element's FEV is only US $2.75 billion compared to US $7.98 billion for the prior art filter element. On a 250,000 m³/day plant, the inventor's filter element shows a cost saving in the region of US $5.23 billion dollars. With this cost saving, a whole new plant can be built using the innovative design of the filter element herein.

### Example 9

| | | | | | | | |
|---|---|---|---|---|---|---|---|
| | | | | Cumulative | Permeate | Permeate | |
| Flow | Flow | Concentrate | Flow | Flow | flow | flow | Flux/ |
| In | Calibration | Flow | Calibration | Filtered | Rate | Rate | Permeate |
| (l/m)¹ | Correction | (l/m)¹ | Correction | (kg) | (L/min) | (GPD) | (l/m/m²) |

Test 1: Flow ~10 l/m (3804 GPD) at 88.08 Psi (Operational)

| 0 | 10.00 | 1.47 | 4.50 | 1.67 | 2.34 | | | |
|---|---|---|---|---|---|---|---|---|
| 120 | 10.00 | 1.47 | 4.50 | 1.67 | 16.25 | 6.96 | 2646 | 12.55 |
| Switch | Switch over from A to B(Flux) Permeate | | | | | | | |
| 180 | 10.00 | 1.47 | 4.50 | 1.67 | 23.17 | | | |
| 300 | 10.00 | 1.47 | 4.50 | 1.67 | 37.08 | 6.96 | 2,646 | 12.55 |
| Switch | Switch over from B to P5(Concentrate) | | | | | | | |
| 360 | 10.00 | 1.47 | 4.50 | 1.67 | 43.85 | | | |
| 480 | 10.00 | 1.47 | 4.50 | 1.67 | 57.76 | 6.96 | 2,646 | 12.55 |

Test 2: Flow ~12 l/m (4565 GPD) at 88.08 Psi (Operational)

| 0 | 12.00 | 1.44 | 5.80 | 1.53 | 1.50 | | | |
|---|---|---|---|---|---|---|---|---|
| 120 | 12.00 | 1.44 | 5.80 | 1.53 | 18.68 | 8.59 | 3,268 | 15.51 |
| Switch | Switch over from A to B(Flux) Permeate | | | | | | | |
| 180 | 12.00 | 1.44 | 5.80 | 1.53 | 27.01 | | | |
| 300 | 12.00 | 1.44 | 5.80 | 1.53 | 44.19 | 8.59 | 3,268 | 15.51 |
| Switch | Switch over from B to P5(Concentrate) | | | | | | | |
| 360 | 12.00 | 1.44 | 5.80 | 1.53 | 52.38 | | | |
| 480 | 12.00 | 1.44 | 5.80 | 1.53 | 69.56 | 8.59 | 3,268 | 15.51 |

Test 3: Flow ~14 l/m (5325 GPD) at 88.08 Psi (Operational)

| 0 | 14 | 1.41 | 6 | 1.60 | 0.75 | | | |
|---|---|---|---|---|---|---|---|---|
| 120 | 14 | 1.41 | 6 | 1.60 | 20.69 | 9.97 | 3,793 | 18.00 |
| Switch | Switch over from A to B(Flux) Permeate | | | | | | | |
| 180 | 14 | 1.41 | 6 | 1.60 | 30.66 | | | |
| 300 | 14 | 1.41 | 6 | 1.60 | 50.60 | 9.97 | 3,793 | 18.00 |
| Switch | Switch over from B to P5(Concentrate) | | | | | | | |
| 360 | 14 | 1.41 | 6 | 1.60 | 60.57 | | | |
| 480 | 14 | 1.41 | 6 | 1.60 | 80.51 | 9.97 | 3,793 | 18.00 |

Test 4: Flow ~16 l/m (6086 GPD) at 88.08 Psi (Operational)

| 0 | 16 | 1.35 | 0 | 1.60 | 2.98 | | | |
|---|---|---|---|---|---|---|---|---|
| 120 | 16 | 1.35 | 0 | 1.60 | 25.68 | 11.35 | 4,318 | 20.49 |
| Switch | Switch over from A to B(Flux) Permeate | | | | | | | |
| 180 | 16 | 1.35 | 6 | 1.60 | 36.26 | | | |
| 300 | 16 | 1.35 | 6 | 1.60 | 58.96 | 11.35 | 4,318 | 20.49 |
| Switch | Switch over from B to P5(Concentrate) | | | | | | | |
| 360 | 16 | 1.35 | 6 | 1.60 | 71.58 | | | |
| 180 | 16 | 1.35 | 6 | 1.60 | 94.28 | 11.35 | 4,318 | 20.49 |

| | | | | | Applied | |
|---|---|---|---|---|---|---|
| | | | | | Pressure | |
| | Secondary | Pressure | Pressure | Pressure | conversion | |
| | Gauge | at Point | at Point | at Point | (mV to | |
| | (Psi) | A (mV) | B (mV) | P5 (mV) | Psi) | Comments |
| | Test 1: Flow ~10 l/m (3804 GPD) at 88.08 Psi (Operational) | | | | | |
| 0 | 4 | 0.21951 | | | 5.38 | Feed Inlet |
| 120 | 4 | 0.16884482 | | | 5.38 | potion; Feed |
| | | | | | | pressure (Psi) |
| Switch | Switch over from A to B(Flux) Permeate | | | | | |
| 180 | 4 | | 0.13528316 | | 3.09 | Permeate |
| 300 | 4 | | 0.13528316 | | 3.09 | pressure (Psi) |
| Switch | Switch over from B to P5(Concentrate) | | | | | |
| 360 | 4 | | | 0.13955826 | 3.20 | Concentrate |
| 480 | 4 | | | 0.1798874 | 3.20 | pressure (Psi) |
| | Test 2: Flow ~12 l/m (4565 GPD) at 88.08 Psi (Operational) | | | | | |
| 0 | 5 | 0.249801 | | | 6.20 | Feed Inlet |
| 120 | 5 | 0.249801 | | | 6.20 | potion; Feed |
| | | | | | | pressure (Psi) |
| Switch | Switch over from A to B(Flux) Permeate | | | | | |
| 180 | 5 | | 0.17635094 | | 4.20 | Permeate |
| 300 | 5 | | 0.17635094 | | 4.20 | pressure (Psi) |
| Switch | Switch over from B to P5(Concentrate) | | | | | |
| 360 | 5 | | | 0.18337338 | 4.39 | Concentrate |
| 480 | 5 | | | 0.18337338 | 4.39 | pressure (Psi) |
| | Test 3: Flow ~14 l/m (5325 GPD) at 88.08 Psi (Operational) | | | | | |
| 0 | 6 | 0.2828401 | | | 7.10 | Feed Inlet |
| 120 | 6 | 0.2828401 | | | 7.10 | potion; Feed |
| | | | | | | pressure (Psi) |
| Switch | Switch over from A to B(Flux) Permeate | | | | | |
| 180 | 6 | | 0.19711385 | | 4.77 | Permeate |
| 300 | 6 | | 0.19711385 | | 4.77 | pressure (Psi) |
| Switch | Switch over from B to P5(Concentrate) | | | | | |
| 360 | 6 | | | 0.18948021 | 4.56 | Concentrate |
| 480 | 6 | | | 0.18948021 | 4.56 | pressure (Psi) |
| | Test 4: Flow ~16 l/m (6086 GPD) at 88.08 Psi (Operational) | | | | | |
| 0 | 8 | 0.31587919 | | | 7.99 | Feed Inlet |
| 120 | 8 | | | | 7.99 | potion; Feed |
| | | | | | | pressure (Psi) |
| Switch | Switch over from A to B(Flux) Permeate | | | | | |
| 180 | 8 | | 0.21787677 | | 5.33 | Permeate |
| 300 | 8 | | 0.21787677 | | 5.33 | pressure (Psi) |
| Switch | Switch over from B to P5(Concentrate) | | | | | |
| 360 | 8 | | | 0.19558703 | 4.73 | Concentrate |
| 180 | 8 | | | 0.19558703 | 4.73 | pressure (Psi) |

1 Rotamer Reading

### Example 10

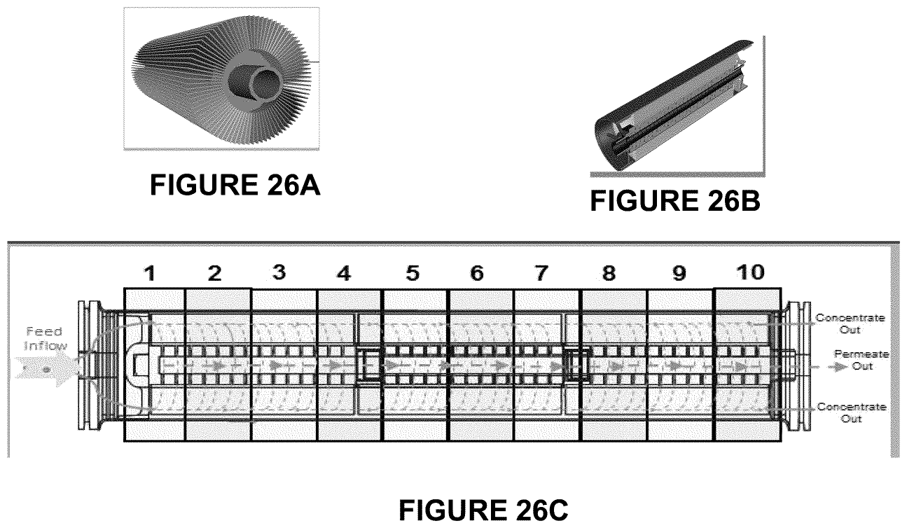

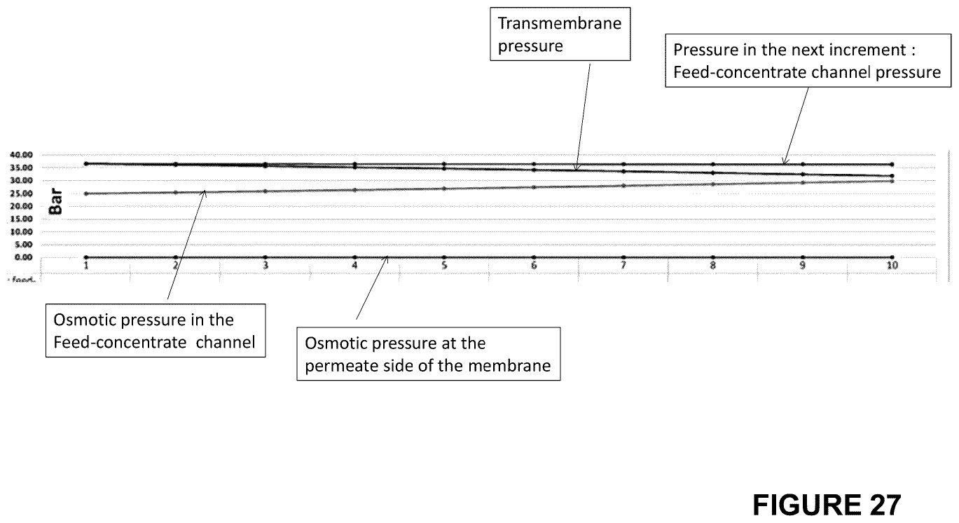

This example was performed by passing water through a using a 8 inch/200 mm filter element described herein using a permeate flow of about 21.56 L/m (8,197 GPD). FIGS. 26A-26C show (i) a computerized version of the filter element as a front view along the x-axis of the central tube (A), a computerized version of the filter element as a cross-sectional side view along the x-axis (b), and block diagram of a side view along the x-axis. Arrows illustrate the water flow within the filter element. See, MWH Global, Inc., revised by John C. Crittenden, R. Rhodes Trussell, David W. Hand, Kerry J. Howe, George Tchobanoglous; Water Treatment: Principles of Design; 2nd edition; United States of America, 2005; Chapter 12, Chapter 17, Chapter 20 to Chapter 22, which is incorporated herein by reference. The parameters identified in the following tables were then obtained.

| | | | Refrence: MWH Global, | | |
|---|---|---|---|---|---|
| | | | Inc. revised by | | |
| | | | John C. Crittenden, R. | | |
| | | | Rhodes Trussell, David W. | | |
| | | | Hand, Kerry J. Howe, | | |
| | | | George Tchobanoglous; | | |
| | | | Water Treatment: Principles | | |
| | | | of Design: 2nd edition: | | |
| | Incre- | | United States of America, | | |
| | ment | | 2005; Chapter 12, Chapter 17, | | |
| Description | Z | Unit | Chapter 20 to Chapter 22. | 1 | 2 |
| Mass Feed Flow in Feed- | Qrc,z | m3/s | Eg. 17.4 | 2.034684E−03 | 1.978745E−03 |
| Concentrate Channel | | | Q_{FC.z} = Q_{F} − Q_{P,Z} | | |
| r: Recovery : Qp/Q^{f} | r_{,RecoveryZ} | uinitless | r_{,Recovery} = Q_{P,Z}/Q_{F,Z} | 1.78% | 1.82% |
| Velocity in Feed -Concentrate | V_{.Z} | m/s | Eq. 17.4 | 1.897211E−01 | 3.863367E−01 |
| Channel | | | ${V}_{Z} = \frac{{Q}_{FC , Z}}{hW}$ | | |

| | | |
|---|---|---|
| Qfeed_inlet: Energy Use : Kw | 4.58 | 4.29 |
| per hour / m\hat{ }3 | | |

| | | | | | |
|---|---|---|---|---|---|
| Determine the pressure in the | P_{FC.Z} | bar | Eq. 17.20 & 57 | 36.6073 | 36.5804 |
| next increment : feed- | | | P_{FC.Z} = P_{F} − δ_{H,L} · V_{z}² · dz | | |
| concentrate | | | | | |
| channel pressures ; bar | | | | | |
| PCF : feed-concentrate channel | PCF_{FC,Z} | bar | Eq. 17.20 | 30.9782 | 30.8665 |
| pressures : bar | | | PCF_{FC,Z} = P_{F} − 0.5h [symbol] − | | |
| | | | P_{F} − π_{FC} + π_{P} | | |
| Trans membrane pressure : bar | ΔP_{NETT} | bar | Eq. 17.8 | 30.9921 | 30.9078 |
| | | | ΔP_{NETT,Z} = (PCF_{F,Z} − | | |
| | | | P_{F,Z}) − (π_{FC,2} − π_{P,Z}) | | |
| Osmotic pressure difference | Δπ_{NETT,Z} | bar | Δπ_{NETT,Z} = (π_{FC,2} − π_{F,Z}) | 4.64 | 4.73 |
| over membrane : bar | | | | | |
| Hydralic Head Loss of Feed- | h [symbol] | bar | Eq. 17.57 | 0.0278 | 0.0268 |
| Concentrate Channel | | | h_{L,Z} = δ_{H,2} · V₂² · dz | | |
| Concentration in Feed- | C_{FC,Z} | mg/L | Eq. 17.53 | 36.256 | 36.915 |
| Concertation Channel | | | ${C}_{FC , Z} = \frac{{Q}_{F} \cdot {C}_{F -} {M}_{S , Z}}{{Q}_{FC , Z}}$ | | |
| Osmotic Pressure in Feed- | π_{FC,Z} | bar | Eq. 17.7 | 4.64 | 4.73 |
| Concentrate Channel | | | π_{FC,Z} = iØCRT | | |
| Permeate Flow Rate per | | | | | |
| increment | | | | | |
| Permeate Flow Rate per | Q_{P,Z} | m3/s | Q_{P,Z} = j [symbol] (W)(dz) | 3.595-05 | 3.59E−05 |
| increment | | | | | |
| Permeate Flow Rate per | Q_{P,Z} | L/m | Q_{P,Z} = j_{w,s}(W)(dz) | 2.16 | 2.16 |
| increment | | | | | |
| Pressure at the Permeate side | P_{P,Z} | bar | Measured from Experiment | 1.00 | 1.00 |
| of Membrane | | | | | |
| Pcf : Calculate the average | C_{P,Z} | mg/L | Eq. 17.58 | 0.18 | 0.17 |
| solute concentration in the permeate : mg/ [symbol] | | | ${C}_{P , Z} = \frac{{J}_{S , Z}}{{J}_{W , Z}}$ | | |
| Active Membrane Area of | | sqm | | 3.9822 | 3.9822 |
| Element : sqm | | | | | |
| w : The with can be determined | | m | Eq. 17.4 | 4.4247 | 4.4247 |
| bydivinding the membrane ares by the elements length : m | | | $w = \frac{a}{L}$ | | |
| Osmotic Pressure at the | π_{P,Z} | bar | Eq. 17.7 | 0.0000 | 0.0000 |
| Permeate side of Membrane | | | π_{PC,Z} = iØCRT | | |
| DL : Diffusion coefficient for | | | | 1.3500E−09 | 1.3500E−09 |
| solute in water : m2/s | | | | | |
| Reynous Number in Feed- | Re_{reynolds} | Unitless | Eq. 17.36 | 909 | 893 |
| Concentrate Channel | | | $Re = \frac{ρ ν {d}_{H}}{μ}$ | | |
| Schimit Number in Feed- | SC_{Schmidt} | Unitless | Eq. 17.37 | 750 | 750 |
| Concentrate Channel | | | $Sc = \frac{μ}{ρ {D}_{L}}$ | | |
| Concentration Polarization | k_{CP,Z} | m/s | Eq. 17.35 | 1.64091E−05 | 1.63658E−05 |
| mass transfer coefficient | | | $\begin{matrix}{k}_{CP , Z} = 0.023 \cdot \frac{{D}_{L}}{{d}_{H}} \cdot \\ {( Re )}^{0.83} {Sc}^{0.33}\end{matrix}$ | | |

| Description | 3 | 4 | 5 | 6 |
|---|---|---|---|---|
| Mass Feed Row in Feed- | 1.942806E−03 | 1.906866E−03 | 1.870927E−03 | 1.834968E−03 |
| Concentrate Channel | | | | |
| r · Recovery · Qₚ/Qf | 1.85% | 1.88% | 1.92% | 1.96% |
| Velocity in Feed-Concentrate | 1.829623E−01 | 1.296680E−01 | 1.781836E−01 | 1.227992E−01 |
| Channel | | | | |
| Qfeed_inlet: Energy Use : Kw per | 4.20 | 4.11 | 4.02 | 4.93 |
| hour/m\hat{ }3 | | | | |
| Determine the pressure in the | 38.5540 | 30.5297 | 36.5097 | 36.4826 |
| next increment : feed-concentrate | | | | |
| channel pressures : bar | | | | |
| PCF : food-concentrate channel | 30.7527 | 30.6366 | 30.5179 | 30.3965 |
| pressures : bar | | | | |
| Trans membrane pressure : bar | 30.8203 | 30.7296 | 30.6353 | 30.5374 |
| Osmotic pressure difference over | 4.83 | 4.93 | 5.00 | 5.30 |
| Hydralic Head loss of Feed- | 0.0258 | 0.0248 | 0.0260 | 0.0231 |
| Concentrate Channel | | | | |
| Concentration in Feed- | 32.598 | 38.306 | 39.062 | 39.807 |
| Concentration Channel | | | | |
| Osmotic Pressure in Feed- | 4.81 | 4.91 | 5.00 | 5.10 |
| Concentration Channel | | | | |
| Premeate Flow Rate per increment | | | | |
| Permeate Flow Rate per increment | 3.59E−05 | 3.59E−05 | 3.59E−05 | 3.59E−05 |
| Permeate Flow Rate per increment | 2.16 | 2.16 | 2.16 | 2.16 |
| Pressure at the Permeate | 1.06 | 1.06 | 1.06 | 1.00 |
| side of Membrane | | | | |
| Pcf - Calculate the average schite | 0.17 | 0.36 | 0.36 | 0.35 |
| concentration in the | | | | |
| permeate : mg/ [symbol] | | | | |
| Active Membrane Area of | 3.9822 | 3.9822 | 3.9822 | 3.9822 |
| Element : sqm | | | | |
| w : the with [symbol] undetermined by | 4.4247 | 4.4247 | 4.247 | 4.4243 |
| divinding the membrane area by | | | | |
| the elements length : m | | | | |
| Osmotic Pressure of the Permeate | 0.0000 | 0.0000 | 0.0000 | 0.0000 |
| side of Membrane | | | | |
| [symbol] : Diffusion coefficient for | 1.3800E−09 | 1.3500E−09 | 1.3500E−09 | 1.3508E−09 |
| solute in water : m2/s | | | | |
| Reynolds Number in Feed- | 876 | 860 | 844 | 838 |
| Concentrate Channel | | | | |
| Schimt Number in Feed- | 750 | 750 | 750 | 750 |
| Concentrate Channel | | | | |
| Concentration Polarization | 1.59217E−06 | 1.56269E−05 | 1.54312E−05 | 1.51848E−05 |
| mass transfer coefficient | | | | |

| Description | 7 | 8 | 9 | 10 |
|---|---|---|---|---|
| Mass Feed Row in Feed- | 1.799048E−03 | 1.763109E−03 | 1.727170E−03 | 1.691280E−08 |
| Concentrate Channel | | | | |
| r · Recovery · Qₚ/Qf | 2.00% | 2.04% | 2.08% | 2.13% |
| Velocity in Feed-Concentrate | 1.6941E−01 | 1.660308E−01 | 1.626481E−01 | 1.692617E−01 |
| Channel | | | | |
| Qfeed_inlet: Energy Use : Kw per | 3.84 | 3.75 | 3.87 | 3.58 |
| hour/m\hat{ }3 | | | | |
| Determine the pressure in the | 36.4604 | 36.4391 | 36.4187 | 36.3991 |
| next increment : feed-concentrate | | | | |
| channel pressures : bar | | | | |
| PCF : food-concentrate channel | 30.2720 | 30.1443 | 30.0130 | 29.8779 |
| pressures : bar | | | | |
| Trans membrane pressure : bar | 30.4356 | 30.3296 | 30.2192 | 30.1041 |
| [symbol] pressure difference over | 5.20 | 5.31 | 5.42 | 5.53 |
| Hydralic Head loss of Feed- | 0.0222 | 0.0213 | 0.0204 | 0.0196 |
| Concentrate Channel | | | | |
| Concentration in Feed- | 40.602 | 41.430 | 42.292 | 43.191 |
| Concentration Channel | | | | |
| Osmotic Pressure in Feed- | 5.20 | 5.31 | 5.42 | 5.53 |
| Concentration Channel | | | | |
| Premeate Flow Rate per increment | | | | |
| Permeate Flow Rate per increment | 3.59E−05 | 3.95E−05 | 3.59E−05 | 3.59E−05 |
| Permeate Flow Rate per increment | 2.16 | 2.16 | 2.16 | 2.18 |
| Pressure at the Permeate | 1.00 | 1.00 | 1.00 | 1.00 |
| side of Membrane | | | | |
| Pcf - Calculate the average schite | 0.35 | 0.14 | 0.14 | 0.14 |
| concentration in the | | | | |
| permeate : mg/ [symbol] | | | | |
| Active Membrane Area of | 3.9822 | 3.9822 | 3.9822 | 3.9822 |
| Element : sqm | | | | |
| w : the with [symbol] undetermined by | 4.4247 | 4.4247 | 4.4247 | 4.4247 |
| divinding the membrane area by | | | | |
| the elements length : m | | | | |
| Osmotic Pressure of the Permeate | 0.0000 | 0.0000 | 0.0000 | 0.0000 |
| side of Membrane | | | | |
| [symbol] : Diffusion coefficient for | 1.3500E−09 | 1.3500E−09 | 1.3500E−05 | 1.3500E−05 |
| solute in water : m2/s | | | | |
| Reynolds Number in Feed- | 832 | 795 | 779 | 763 |
| Concentrate Channel | | | | |
| Schimt Number in Feed- | 750 | 750 | 750 | 750 |
| Concentrate Channel | | | | |
| Concentration Polarization | 1.49375E−05 | 1.468 [symbol] E−05 | 1.44495E−05 | 1.41908E−05 |
| mass transfer coefficient | | | | |

| | | | Refrence: MWH Global, | | |
|---|---|---|---|---|---|
| | | | Inc. revised by | | |
| | | | John C. Crittenden, R. | | |
| | | | Rhodes Trussell, David W. | | |
| | | | Hand, Kerry J. Howe, | | |
| | | | George Tchobanoglous; | | |
| | | | Water Treatment: Principles | | |
| | | | of Design: 2nd edition: | | |
| | Incre- | | United States of America, 2005; | | |
| | ment | | Chapter 12, Chapter 17, | | |
| Description | Z | Unit | Chapter 20 to Chapter 22. | 1 | 2 |
| Part of Eq: 17-54 for Concentration | | Unitless | Eq. 17.54 | −5 | −5.58 |
| Polaration Concentration Polarization Factor | β_{Z} | | ${β}_{Z} = Rej ( {e}^{\frac{- {J}_{W , Z}}{{k}_{CP , Z}}} ) + ( 1$ | 6.88E−03 | 6.56E−03 |
| Jw : volmetric flux of water : 1/ | J_{W,Z} | L/m2 · h | J_{W,Z} Eq: 17.48 = | 324.90 | 324.90 |
| h · sqm | | | kw_{W,Z}[(PCF_{FZ} − P_{P.3}) − | | |
| | | | (β_{Z} = π_{PC,2} − π_{P,Z})] | | |
| Kw : Mass transfer coefficient for | kw_{w,Z} L/2 · h · bar | | Eq. 17.9 | 10.61 | 10.61 |
| water flux: L/sqm · h · bar | | | ${kw}_{W , Z} = \frac{{J}_{W , Z}}{\begin{matrix}[ ( {PCF}_{F , Z} - {P}_{P , Z} ) - \\ ( {β}_{Z} * {π}_{PC , Z} - π \text{?} ) ]\end{matrix}}$ | | |
| ks : Solute mass transfer | ks_{S,Z} | m/h | Eq. 17.10 | 2.30E−04 | 2.30E−04 |
| coefficient for solute flux (Eq. 17.10): t/sqm · h | | | ${k}_{S , Z} = \frac{{J}_{S , Z}}{( Δ C )}$ | | |
| Solute Flux of Membrane | J_{S,Z} | mg/m2 · h | Eq. 17.49 | 57 | 56 |
| | | | J_{S,Z} = kₛ(β_{Z}, C_{PC,Z} − C_{P,Z}) | | |
| Solute Transport across | M_{Z} | mg/s | M_{S,2} = J_{S,2}(w)(dz) | 0.006 | 0.006 |
| Membrane | | | | | |
| Rej: The fraction of material | Rej_{Z} | Unitless | | 1.00 | 1.00 |
| remove from permeate stream: | | | | | |
| dimensionless | | | | | |

| Description | 3 | 4 | 5 | 6 | 7 | 8 | 9 | 10 |
|---|---|---|---|---|---|---|---|---|
| Part of Eq. 17-54 for | −5.57 | −5.76 | −5.85 | −5.94 | −6.04 | −6.14 | −6.25 | −6.36 |
| Concentration | | | | | | | | |
| Polarization | | | | | | | | |
| Concentration | 6.25E−03 | 5.96E−03 | −5.68E−03 | 5.42E−03 | 5.18E−03 | 4.95E−03 | 4.73E−03 | 4.53E− |
| Polarization Factor | | | | | | | | 03 |
| Jw : volmetric flux of | 324.30 | 324.50 | 324.96 | 324.50 | 324.90 | 324.90 | 124.90 | 324.9 [symbol] |
| water : 1/h · sqm | | | | | | | | |
| Kw : Mass transfer | 10.62 | 10.01 | 10.62 | 10.01 | 10.61 | 10.61 | 10.01 | 10.61 |
| coefficient for water | | | | | | | | |
| flux: L/sqm · h · bar | | | | | | | | |
| Ks : Solute mass | 2.30E−04 | 2.30E−04 | 2.30E−04 | 2.30E−04 | 2.30E−04 | 2.30E−04 | 2.30E−04 | 2.30E− |
| transfer coefficient for | | | | | | | | 04 |
| solute flux (Eq 17.10): | | | | | | | | |
| L/sqm · h | | | | | | | | |
| Solute Flux of | 54 | 52 | 51 | 50 | 48 | 47 | 46 | 45 |
| Membrane | | | | | | | | |
| Solute Transport | 0.006 | 0.006 | 0.005 | 0.005 | 0.005 | 0.006 | 0.006 | 0.005 |
| across Membrane | | | | | | | | |
| Rej: The fraction of | 3.00 | 1.00 | 100 | 1.00 | 1.00 | 3.00 | 1.00 | 1.00 |
| material | | | | | | | | |
| remove from permeste | | | | | | | | |
| stream: dimensionless | | | | | | | | |

[symbol]

indicates data missing or illegible when filed

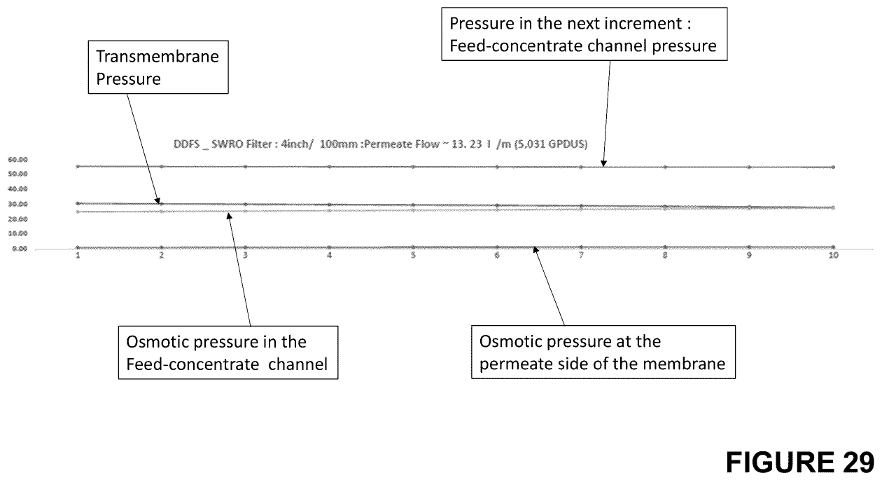

At a permeate flow of 123.04 L/m at an operational pressure of 900 psi (62.5 bar) at about 20° C. Reynolds number of 862, concentration polarization factor of 0.01, and transmembrane pressure of 30.6 bar, the following pressures (bar) measured and plotted in FIG. 29:
pressure in the next increment: feed-concentration channel pressure)
transmembrane pressure
osmotic pressure in the feed-concentrate channel
osmotic pressure at the permeate side of the membrane

| | Increment | | | | | |
|---|---|---|---|---|---|---|
| Pressure | 1 | 2 | 3 | 4 | 5 | 6 |
| Next | 36.5242 | 36.5156 | 36.4897 | 36.4648 | 36.4408 | 36.4177 |
| increment: | | | | | | |
| feed- | | | | | | |
| concentrate | | | | | | |
| channel | | | | | | |
| Trans | 36.5841 | 36.1294 | 35.6581 | 35.1691 | 34.6615 | 34.1341 |
| membrane | | | | | | |
| Osmotic in | 24.99 | 25.44 | 25.91 | 26.40 | 26.90 | 27.43 |
| feed- | | | | | | |
| concentrate | | | | | | |
| channel | | | | | | |
| Osmotic at | 71.2 × 10⁻² | 6.91 × 10⁻² | 6.71 × 10⁻² | 6.51 × 10⁻² | 6.33 × 10⁻² | 6.16 × 10⁻² |
| the | | | | | | |
| permeate | | | | | | |
| side of | | | | | | |
| membrane | | | | | | |

| | Increment | | | |
|---|---|---|---|---|
| Pressure | 7 | 8 | 9 | 10 |
| Next | 36.3956 | 36.3743 | 36.3538 | 36.3342 |
| increment: | | | | |
| feed- | | | | |
| concentrate | | | | |
| channel | | | | |
| Trans | 33.5858 | 33.0153 | 32.4212 | 31.8020 |
| membrane | | | | |
| Osmotic in | 27.97 | 28.54 | 29.14 | 29.75 |
| feed- | | | | |
| concentrate | | | | |
| channel | | | | |
| Osmotic at | 6.00 × 10⁻² | 5.85 × 10⁻² | 5.71 × 10⁻² | 5.58 × 10⁻² |
| the | | | | |
| permeate | | | | |
| side of | | | | |
| membrane | | | | |

### Example 11

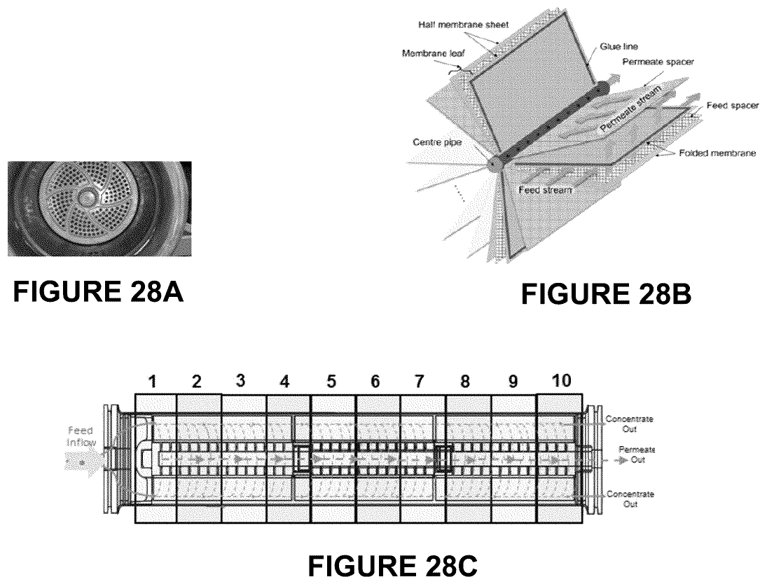

This example was performed by passing water through a 4 inch/100 mm filter element described herein using a permeate flow of about 13.23 L/m (5,031 GPD), pore size of about 0.001 microns, and membrane area of about 11.1179 m². FIGS. 28A-28C show a prototype of the filter element as a front view along the x-axis of the central tube (A), computerized version of the filter element as a cross-sectional side view along the x-axis (B) showing the central pipe, permeate spacer, feed spaces, folded membrane, half-membrane sheet, membrane leaf, and glue line, with arrows showing the flow of the permeate and feed streams, and block diagram of a side view along the x-axis (C). Arrows illustrate the water flow within the filter element. See, MWH Global cited above. The parameters identified in the following tables were then obtained.

| | | | Reference : MWH Global, | | |
|---|---|---|---|---|---|
| | | | Inc. revised by John C. | | |
| | | | Crittenden, R. Rhodes Trussell, | | |
| | | | David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America, | | |
| | ment | | 2005 ; Chapter 12, Chapter 37, | | |
| Description | Z | Unit | Chapter 20 to Chapter 22. | 1 | 2 |
| Mass feed flow in Feed- | Q_{FC,Z} | m3/ [symbol] | Eq. 17.4 | 0.0344 | 0.0043 |
| Concentrate Channel | | | Q_{F,C,Z} = Q_{F} − Q_{P,Z} | | |
| Mass Feed Row in Feed- | Q_{PC,Z} | m3/day | Eq. 17.4 | 381.18 | 374.22 |
| Concentrate Channel | | | Q_{PC,z} = Q_{F} − Q_{P,Z} | | |
| r: Recovery : [symbol] | r_{.RecoveryZ} | unitless | r_{Recovery} = Q_{P,Z}/Q [symbol] | 1. [symbol] | 1. [symbol] |
| Velocity in Feed- | V_{Z} | m/s | Eq. 17.4 | 0.2.218 | 0.2667 |
| Concentrate Channel | | | ${V}_{Z} = \frac{{Q}_{FC , Z}}{hW}$ | | |
| Qfeed_inlet: Energy Use : Kw per hour/m\hat{ }3 : Power = {(Q [symbol] SG [symbol] TOM/102 [symbol] | | | | 1. [symbol] | 1. [symbol] |
| Pnj/Mnj [symbol] 24 h : 1.58 Q = Feed flow in [symbol] tter in sec (Qco + Qpd) ; SG = Fluid spec gravity | | | | | |
| (kg/ [symbol] ) = 1 ; T [symbol] = Total head developed in meter water (Pfo)(2 Psi × 0.70307 m water) ; | | | | | |
| Pump efficiency Pn is % : Meter efficiency Mn in % : | | | | | |
| Determine the pressure in | P [symbol] | bar | Eq. 17.20 & 57 | 38.28 | 38.20 |
| the next increment : feed | | | P_{PC,Z} = P [symbol] − | | |
| concentrate channel | | | δ [symbol] , P_{z}^{z} dz | | |
| pressure : bar | | | | | |
| PCF : feed-concentrate | PCF_{fC,Z} | bar | Eq. 17.20 | 13.48 | 13.19 |
| channel pressures : bar | | | PCF_{FC,2} = P [symbol] − 0.5h [symbol] − | | |
| | | | P_{P} − π_{FC} + π_{P} | | |
| Trans membrane | ΔP_{NETT} | bar | Eq. 17.8 | 13.50 | 13.23 |
| pressure : bar | | | ΔP_{NETT,Z} = (PCF_{P,Z} − | | |
| | | | (z_{PC,Z} = [symbol] _{P,2}) | | |

| Description | 3 | 4 | 5 | 6 | 7 | 8 | 9 | 10 |
|---|---|---|---|---|---|---|---|---|
| Mass Feed Flow in Feed- | 0.0042 | 0.0042 | 0.0041 | 0.0040 | 0.0039 | 0.0038 | 0.0038 | 0.0037 |
| Concentrate Channel | | | | | | | | |
| Mass Feed Flow in Feed- | 367.05 | 359.96 | 352.92 | [symbol] | [symbol] 38.78 | [symbol] 31.73 | 324.65 | 317.57 |
| Concentrate Channel | | | | | | | | |
| r : Recovery : Qp/QF | 1.93% | 1.96% | 2.00% | 2.04% | 2.09% | 2.13% | 2.18% | 2.33% |
| Velocity in Feed- | 0.2627 | 0.2506 | 0.2536 | 0.2466 | 0.2435 | 0.2365 | 0.2314 | 0.2264 |
| Concentrate Channel | | | | | | | | |
| Qfeed_inlet: Energy Use : | 1.52 | 1.49 | 1.49 | 1.42 | 1.39 | 1.36 | 1.38 | 1.30 |
| Kw per hour/m\hat{ }3 : Power = | | | | | | | | |
| [(Q * SG * TDH/102 * | | | | | | | | |
| Pn)/Mn]* 24 h/Q = Feed | | | | | | | | |
| flow in litter in sec | | | | | | | | |
| (Qco + Qpo); SG = Fluid | | | | | | | | |
| spec [symbol] [symbol] _9 TDH = | | | | | | | | |
| Total head developed in | | | | | | | | |
| [symbol] | | | | | | | | |
| Determine the pressure in the | 38.13 | 38.06 | 37.99 | 37.92 | 37.86 | 37.80 | 37.74 | 37.69 |
| next increment : Feed-concentrate | | | | | | | | |
| channel pressures : bar | | | | | | | | |
| PCF : feed-concentrate channel | 7.30 | 7.30 | 7.30 | 7.30 | 7.30 | 7.30 | 7.30 | 7.30 |
| pressures : bar | | | | | | | | |
| Trans membrane | 12.95 | 12.68 | 12.40 | 12.12 | 11.84 | 11.50 | 11.15 | 10.79 |
| pressure : bar | | | | | | | | |

| | | | Reference : MWH Global, | | |
|---|---|---|---|---|---|
| | | | Inc. revised by John C. | | |
| | | | Crittenden, R. Rhodes | | |
| | | | Trussell, David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America, | | |
| | ment | | 2005 ; Chapter 12, Chapter 37, | | |
| Description | Z | Unit | Chapter 20 to Chapter 22. | 1 | 2 |
| Osmotic pressure difference | Δπ_{NETT,2} | bar | Δπ_{NETT,Z} = | 23.92 | 24.12 |
| [symbol] membrane : bar | | | (π_{SC,Z} − π_{F,Z}) | | |
| Hydralic Head loss of Feed- | h [symbol] | bar | Eq. 17.57 | 0.0797 | 0.0767 |
| Concentate Channel | | | h [symbol] = δ_{Hz} · V₂² dz | | |
| Concentration in Feed- | C_{PC,Z} | mg/L | Eq. 17.53 | [symbol] | 36.2 [symbol] |
| Concentration Channel | | | $\text{?} = \frac{\text{?}}{{Q}_{FC , Z}}$ | | |
| Osmotic Pressure in Feed- | π_{PC,Z} | bar | Eq. 17.7 | 24.78 | 25.08 |
| Concencentration Channel | | | π_{PC,z} = EQCHT | | |
| Permeate Flow Rate per | | | | | |
| increment | | | | | |
| Permeate Flow Rate | Q_{P,Z} | m3/s | Q_{P,Z} = J_{W,s}(W)(dz) | 8.18E−05 | 8.18E−05 |
| per increment | | | | | |
| Permeate Flow Rate | Q_{P,Z} | m3/day | Q_{P,Z} = J_{W,s}(W)(dz) | 7.07 | 7.07 |
| per increment | | | | | |
| Permeate Flow Rate | Q_{P,Z} | L/m | Q_{P,X} = J_{W,s}(W)(dz) | 4.91 | 4.91 |
| per increment | | | | | |
| Permeate at the Permeate | P_{P,Z} | bar | Measured from | 7.07 | 7.07 |
| side of Membrane | | | Experiment | 0.86 | 0.88 |
| Car : Calculate the average | C_{P,Z} | mg/L | Eq. 17.98 | 1247.22 | 1307.93 |
| solute concentration in the permeate : mg/t | | | ${C}_{P , Z} = \frac{\text{?}}{h \text{?}}$ | | |

| Description | 3 | 4 | 5 | 6 |
|---|---|---|---|---|
| Osmotic pressure | 24.32 | 24.52 | 24.23 | 24.94 |
| difference | | | | |
| over membrane : bar | | | | |
| Hydratic Head Loss | 0.0739 | 0.0710 | 0.0683 | 0.0056 |
| of Feed- | | | | |
| Concentrate Channel | | | | |
| Concentrate in feed- | 36.063 | 37.038 | 37.894 | 37.781 |
| Concentrate Channel | | | | |
| Osmotic Pressure | 25.26 | 25.51 | 25.77 | 26.06 |
| in Feed- | | | | |
| Concentrate Channel | | | | |
| Permeate Flow Rate | | | | |
| per increment | | | | |
| Permeate Flow Rate | 8.38E−05 | 8.38E−05 | 8. [symbol] E−05 | 8.15E−05 |
| per increment | | | | |
| Permeate Flow Rate | 7.07 | 7.07 | 7.07 | 7.07 |
| per increment | | | | |
| Permeate Flow Rate | 4.91 | 4.91 | 4.91 | 4.91 |
| per increment | | | | |
| Pressure at the | 0.86 | 0.86 | 0.86 | 0.86 |
| Permeate | | | | |
| side of Membrane | | | | |
| Cpz : Calculation | 1372.29 | 1443.38 | 1375.00 | 1594.23 |
| the average | | | | |
| solute concentration in | | | | |
| the permeate : mg/L | | | | |
| Description | 7 | 8 | 9 | 10 |
| Osmotic pressure | 25.16 | 25.44 | 25.74 | 26.04 |
| difference | | | | |
| over membrane : bar | | | | |
| Hydratic Head Loss | 0.0029 | 0.0603 | 0.0578 | 0.0553 |
| of Feed- | | | | |
| Concentrate Channel | | | | |
| Concentrate in feed- | 38.181 | 38,892 | 39,020 | 89,480 |
| Concentrate Channel | | | | |
| Osmotic Pressure | 26.31 | 26.00 | 26.89 | 27.20 |
| in Feed- | | | | |
| Concentrate Channel | | | | |
| Permeate Flow Rate | | | | |
| per increment | | | | |
| Permeate Flow Rate | 8.18E−05 | 8.18E−05 | 8.18E−05 | 8.38E−05 |
| per increment | | | | |
| Permeate Flow Rate | 7.07 | 7.07 | 7.07 | 7.07 |
| per increment | | | | |
| Permeate Flow Rate | 4.91 | 4.91 | 4.91 | 4.91 |
| per increment | | | | |
| Pressure at the | 0.86 | 0.86 | 0.86 | 0.86 |
| Permeate | | | | |
| side of Membrane | | | | |
| Cpz : Calculation | 1679.38 | 1371.04 | 1869.86 | 1976.38 |
| the average | | | | |
| solute concentration in | | | | |
| the permeate : mg/L | | | | |

| | | | Reference : MWH Global, | | |
|---|---|---|---|---|---|
| | | | Inc. revised by John C. | | |
| | | | Crittenden, R. Rhodes | | |
| | | | Trussell, David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America , | | |
| | ment | | 2005 ; Chapter 12, Chapter 17, | | |
| Description | Z | Unit | Chapter 20 to Chapter 22. | 1 | 2 |
| Active Membrane Area of | | sqm | | 11.1179 | 11.1179 |
| Element : sqm | | | | | |
| w : The with can | | m | Eq. 17.4 | 11.3448 | 11.3448 |
| bedetarmined by divinding the | | | $w = \frac{a}{L}$ | | |
| membrane area by the elements length : m | | | | | |
| Osmotic Pressure at the | π_{P,Z} | bar | Eq. 17.7 | 0.86 | 0.90 |
| Permeate side of Membrane | | | π_{PC,Z} = iØCRT | | |
| DL : Diffusion coefficient for | | | | 1.3500E−09 | 1.3500E- |
| solute in water : m2/s | | | | | 09 |
| Reynolds Number in Feed- | Re_{reynolds} | Unitless | Eq. 17.36 | 186 | 182 |
| Concentrate Channel | | | $Re = \frac{ρ ν {d}_{H}}{μ}$ | | |
| Schimt Number in Feed- | Sc_{Schmidt} | Unitless | Eq. 17.37 | 750 | 750 |
| Concentrate Channel | | | $Sc = \frac{μ}{ρ {D}_{L}}$ | | |
| Concentration Polarization | k_{CP,Z} | m/s | Eq. 17.35 | 2.90230E−05 | 2.25492E− |
| mass transfer coefficient | | | $\begin{matrix}{k}_{CP , Z} = 0.023 \cdot \frac{{D}_{L}}{{d}_{H}} \cdot \\ {( Re )}^{0.83} {Sc}^{0.33}\end{matrix}$ | | 05 |
| Part of Eq: 17-54 for | | Unitless | Eq. 17.54 | −0.29866 | −0.29866 |
| Concentration Polaration Concentration Polarization | β_{,Z} | | ${β}_{Z} = Rej ( {e}^{\frac{- {J}_{W , Z}}{{k}_{CP , Z}}} ) + ( 1 - Rej )$ | 0.75 | 0.75 |
| Factor | | | | | |

| Description | 3 | 4 | 5 | 6 |
|---|---|---|---|---|
| Active Membrane Area of | 11.1179 | 11.1179 | 11.1179 | 11.1179 |
| Element : sqm | | | | |
| w : The with can bedetarmined | 11.3448 | 11.3448 | 11.3448 | 11.3448 |
| by divinding the membrane | | | | |
| area by the elements length : m | | | | |
| Osmotic Pressure at the | 0.95 | 0.99 | 1.04 | 1.10 |
| Permeate side of Membrane | | | | |
| DL : Diffusion coefficient | 1.3500E−09 | 1.3500E-09 | 1.3500E−09 | 1.3500E−09 |
| for solute in water : m2/s | | | | |
| Reynolds Number in Feed- | 179 | 175 | 172 | 168 |
| Concentrate Channel | | | | |
| Schimt Number in Feed- | 750 | 750 | 750 | 750 |
| Concentrate Channel | | | | |
| Concentration Polarization | 2.21951E−05 | 2.18398E−05 | 2.14833E−05 | 2.11256E−05 |
| mass transfer coefficient | | | | |
| Part of Eq: 17-54 for | −0.29866 | −0.29866 | −0.29866 | −0.29866 |
| Concentration Polaration | | | | |
| Concentration Polarization Factor | 0.75 | 0.75 | 0.75 | 0.75 |
| Description | 7 | 8 | 9 | 10 |
| Active Membrane Area of | 11.1179 | 11.1179 | 11.1179 | 11.1179 |
| Element : sqm | | | | |
| w : The with can bedetarmined | 11.3448 | 11.3448 | 11.3448 | 11.3448 |
| by divinding the membrane | | | | |
| area by the elements length : m | | | | |
| Osmotic Pressure at the | 1.16 | 1.16 | 1.16 | 1.16 |
| Permeate side of Membrane | | | | |
| DL : Diffusion coefficient | 1.3500E−09 | 1.3500E−09 | 1.3500E−09 | 1.3500E−09 |
| for solute in water : m2/s | | | | |
| Reynolds Number in Feed- | 165 | 161 | 158 | 155 |
| Concentrate Channel | | | | |
| Schimt Number in Feed- | 750 | 750 | 750 | 750 |
| Concentrate Channel | | | | |
| Concentration Polarization | 2.07666E−05 | 2.04064E−05 | 2.00448E−05 | 1.96819E−05 |
| mass transfer coefficient | | | | |
| Part of Eq: 17-54 for | −0.29866 | −0.29866 | −0.29866 | −0.29866 |
| Concentration Polaration | | | | |
| Concentration Polarization Factor | 0.75 | 0.75 | 0.75 | 0.75 |

| | | | Reference : MWH Global, | | |
|---|---|---|---|---|---|
| | | | Inc. revised by John C. | | |
| | | | Crittenden, R. Rhodes Trussell, | | |
| | | | David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America, | | |
| | ment | | 2005 ; Chapter 12, Chapter 17, | | |
| Description | Z | Unit | Chapter 20 to Chapter 22. | 1 | 2 |
| Jw : volmetric flux of | J_{W,t} | t/m2,h | Eq. 17.48 | 84.35 | 84.35 |
| water : t/hagan | | | J_{W,t} = [symbol] _{W,Z}{(PCF_{P,Z} − | | |
| | | | P_{P,Z}) − (β₂ [symbol] k [symbol] − π [symbol] )} | | |
| Kw : Mass transfer | kw_{w,Z} | L/m2 · | Eq. 17.9 | 4.48 | 4.50 |
| coefficient for water flux: L/sqm · h · bar | | h · bar | ${kw}_{W , Z} = \frac{{J}_{W , Z}}{\begin{matrix}[ ( {PCP}_{F , Z} - {P}_{P , Z} ) - \\ ( {β}_{z} * {π}_{FC , Z} - {π}_{P , Z} ) ]\end{matrix}}$ | | |
| [symbol] Sedate mass transfer | ks_{S,Z} | L/mZ · h | Eq. 17.10 | 2.77 | 2.77 |
| coefficient for solute flux ( [symbol] 17.30): [symbol] /sqr · h | | | ${k}_{S , Z} = \frac{{J}_{S , Z}}{( Δ C )}$ | | |
| Solute Flux of Member area | [symbol] _{S,Z} | m2/m2 · | Eq. 17.49 | 74.775 | 75.356 |
| | | h | J [symbol] = k [symbol] (β [symbol] ·C_{PC,Z} − C_{P,Z}) | | |
| Solute Transport across | M_{Z} | mg/s | [symbol] = [symbol] | 73 | 73 |
| Membrane | | | | | |
| Solute Transport across | M_{Z} | % | Increase factor of solute | | |
| Membrane | | | over membrane | 0.1 [symbol] | 0.2 [symbol] |
| Rej: The fraction of material | Rej_{z} | Unitless | | 96.82% | 96.82% |
| [symbol] from permeate stream: [symbol] | | | | | |

| Description | 3 | 4 | 5 | 6 | 7 | 8 | 9 | 10 |
|---|---|---|---|---|---|---|---|---|
| Jw : volmetric flux of | 84. [symbol] | 84.55 | 86.35 | 84.35 | 84.35 | 84.35 | 86.56 | 86. [symbol] |
| water : 1/h ·0 sqm | | | | | | | | |
| Kw : Mass transfer | 4.59 | 4.54 | 4.70 | 4.76 | 4.62 | 4. [symbol] | 4.98 | 5.07 |
| coefficient for water flux: | | | | | | | | |
| L/sqm · ft · bar | | | | | | | | |
| Ks : Solute mass transfer | 2.77 | 2.77 | 2.77 | 2.77 | 2.77 | 2.77 | 2.77 | 2.77 |
| coefficient for solute | | | | | | | | |
| flux [symbol] 17.30 [symbol] [symbol] sqm · | | | | | | | | |
| h | | | | | | | | |
| Solute Flux of Membrane | 75.948 | 76.550 | 72.263 | 29.786 | 7.4 [symbol] | 79.063 | 79.7 [symbol] | 80.580 |
| Solute Transport across | 74 | 74 | 75 | 75 | 76 | 76 | 77 | 78 |
| Membrane | | | | | | | | |
| Solute Transport across | 0.2 [symbol] | 0.22% | 0.24% | 9.25% | 9.27% | 0.29% | 0.33% | 0.33% |
| Membrane | | | | | | | | |
| Rej: The fraction of | 96.82% | 96.82% | 96.82% | 96.82% | 96.82% | 96.82% | 96.82% | 96.82% |
| material | | | | | | | | |
| remove from permeate | | | | | | | | |
| stream:dimensionless | | | | | | | | |

[symbol]

indicates data missing or illegible when filed

At a feed TDS of 35,000 ppm, feed flow of 835.3 m³/day (107,785 GPD), feed pressure of 28.5 bar at about 25° C., Reynolds number of 168, concentration polarization factor of 0.78, transmembrane pressure of 12.2 bar, and energy use of 0.34 Kw/hr/m³, the following pressures (bar) measured and plotted in FIG. 29:
pressure in the next increment: feed-concentration channel pressure)
transmembrane pressure
osmotic pressure in the feed-concentrate channel
osmotic pressure at the permeate side of the membrane

| | Increment | | | | | | | | | |
|---|---|---|---|---|---|---|---|---|---|---|
| Pressure | 1 | 2 | 3 | 4 | 5 | 6 | 7 | 8 | 9 | 10 |
| Next increment: | 55.11 | 55.04 | 54.98 | 54.92 | 54.87 | 54.81 | 54.76 | 54.71 | 54.67 | 54.62 |
| feed-concentrate | | | | | | | | | | |
| channel | | | | | | | | | | |
| Trans membrane | 30.33 | 30.07 | 29.81 | 29.54 | 29.28 | 29.01 | 28.74 | 28.41 | 28.07 | 27.72 |
| Osmotic in feed- | 24.78 | 25.02 | 25.26 | 25.51 | 25.77 | 26.04 | 26.31 | 26.60 | 26.89 | 27.20 |
| concentrate | | | | | | | | | | |
| channel | | | | | | | | | | |
| Osmotic at the | 0.86 | 0.90 | 0.95 | 0.99 | 1.04 | 1.10 | 1.16 | 1.16 | 1.16 | 1.16 |
| permeate side of | | | | | | | | | | |
| membrane | | | | | | | | | | |

This example may also be performed by increasing the membrane area by 3 m², i.e., to about 14 m² or lowering the membrane area by about 5 m², i.e., to about 6 m². In some embodiments, the feed-channel height or spacer height will vary. In other embodiments, the membrane sheet or leaf will have a fixed thickness. In further embodiments, the feed-channel height or spacer height will vary and the membrane sheet or leaf will have a fixed thickness. Thus, the larger membrane area equates to a smaller the feed channel or spacer height.

### Example 12

This example was performed by passing water through an 8 inch/200 mm filter element described herein using a permeate flow of about 26.05 L/m (9,910 GPD), pore size of about 0.001 microns, and membrane area of about 29.0466 m². See, FIGS. 28A-28C and MWH Global, Inc. cited above. The parameters identified in the following tables were then obtained.

| | | | Reference : MWH Global, | | |
|---|---|---|---|---|---|
| | | | Inc. revised by John C. | | |
| | | | Crittenden, R. Rhodes | | |
| | | | Trussell, David W. Hand, | | |
| | | | Kerry J. Howe, George | | |
| | | | Tchobanoglous ; Water | | |
| | | | Treatment: Principles of | | |
| | | | Design ; 2nd edition ; | | |
| | Incre- | | United States of America, | | |
| | ment | | 2005 ; Chapter 12, Chapter 17, | | |
| Description | Z | Unit | Chapter 20 to Chapter 22. | 1 | 2 |
| Mass Feed Flow in Feed- | Q_{FC,Z} | m3/s | Eq. 17.4 | 2.40E−03 | 2.35E−03 |
| Concentrate Channel | | | Q_{F,C,z} = Q_{F} − Q_{P,Z} | | |
| Mass Feed Flow in Feed- | Q_{FC,Z} | m3/day | Eq. 17.4 | 207.06 | 203.23 |
| Concentrate Channel | | | Q_{FC,z} = Q_{F} − Q_{P,Z} | | |
| r: Recovery : [symbol] | r_{.RecoveryZ} | uinitless | r_{Recovery} = Q_{P,Z}/Q_{F,Z} | 1.85% | 1.88% |
| Velocity in Feed - | V_{,Z} | m/s | Eq. 17.4 | 0.1078 | 0.1058 |
| Concentrate Channel | | | ${V}_{Z} = \frac{{Q}_{FC , Z}}{hW}$ | | |
| Qfeed_inlet: Energy Use : Kw per hour/m\hat{ }3 | | | | 2.56 | 2.51 |
| Determine the pressure in | P_{,FC,Z} | bar | Eq. 17.20 & 57 | 43.26 | 43.22 |
| the next increment : feed- | | | P_{FC,Z} = P_{F} − δ_{H,L} · V_{Z.}² dz | | |
| concentrate channel pressure : | | | | | |
| bar | | | | | |
| PCF : feed-concentrate | PCF_{FC,Z} | bar | Eq. 17.20 | 18.75 | 18.78 |
| channel pressures : bar | | | PCF_{FC,Z} = P_{F} − 0.5h_{L,Z} − | | |
| | | | P_{P} − π_{FC} + π_{P} | | |
| Trans membrane | ΔP_{NETT} | bar | Eq. 17.8 | 18.73 | 18.72 |
| pressure : bar | | | ΔP_{NETT,Z} = (PCF_{F,Z} − P_{P,Z}) − | | |
| | | | (π_{FC,Z} − π_{P,Z}) | | |

| Description | 3 | 4 | 5 | 6 |
|---|---|---|---|---|
| Mass Feed Flow in Feed- | 2.31E−03 | 2.26E−03 | 2.22E−03 | 2.18E−03 |
| Concentrate Channel | | | | |
| Mass Feed Flow in Feed- | 199.41 | 195.58 | 191.75 | 187.92 |
| Concentrate Channel | | | | |
| r : Recovery : Qp/Qf | 1.92% | 1.96% | 2.00% | 2.04% |
| Velocity in Feed - | 0.1038 | 0.1018 | 0.0998 | 0.0978 |
| Concentrate Channel | | | | |
| Qfeed_inlet: Energy Use : | 2.46 | 2.41 | 2.36 | 2.32 |
| Kw per hour/m\hat{ }3 | | | | |
| Determine the pressure in | 43.18 | 43.15 | 43.11 | 43.08 |
| the next increment : feed- | | | | |
| concentrate channel | | | | |
| pressures : bar | | | | |
| PCF : feed-concentrate | 18.81 | 18.84 | 18.87 | 18.91 |
| channel pressures : bar | | | | |
| Trans membrane | 18.71 | 18.70 | 18.70 | 18.70 |
| pressure : bar | | | | |
| Description | 7 | 8 | 9 | 10 |
| Mass Feed Flow in Feed- | 2.13E−03 | 2.09E−03 | 2.04E−03 | 2.00E−03 |
| Concentrate Channel | | | | |
| Mass Feed Flow in Feed- | 184.09 | 180.27 | 176.44 | 172.61 |
| Concentrate Channel | | | | |
| r : Recovery : Qp/Qf | 2.08% | 2.12% | 2.17% | 2.22% |
| Velocity in Feed - | 0.0959 | 0.0939 | 0.0919 | 0.0899 |
| Concentrate Channel | | | | |
| Qfeed_inlet: Energy Use : | 2.27 | 2.22 | 2.17 | 2.12 |
| Kw per hour/m\hat{ }3 | | | | |
| Determine the pressure in | 43.05 | 43.01 | 42.99 | 42.96 |
| the next increment : feed- | | | | |
| concentrate channel | | | | |
| pressures : bar | | | | |
| PCF : feed-concentrate | 18.95 | 18.94 | 18.93 | 18.93 |
| channel pressures : bar | | | | |
| Trans membrane | 18.71 | 18.67 | 18.63 | 18.60 |
| pressure : bar | | | | |

| | | | Reference : MWH Global, | | |
|---|---|---|---|---|---|
| | | | Inc. revised by John C. | | |
| | | | Crittenden, R. Rhodes | | |
| | | | Trussell, David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America, | | |
| | ment | | 2005 ; Chapter 12, Chapter 37, | | |
| Description | Z | Unit | Chapter 20 to Chapter 22. | 1 | 2 |
| Osmotic pressure difference | Δπ_{NETT,Z} | bar | Δπ_{NETT,Z} = | 23.70 | 23.68 |
| over membrane : bar | | | (π_{FC,Z} − π_{P,Z}) | | |
| Hydralic Head Loss of Feed- | h_{L,Z} | bar | Eq. 17.57 | 0.0409 | 0.0394 |
| Concentate Channel | | | h_{L,Z} = δ_{H,L} · V_{z.}² dz | | |
| Concentration in Feed- | C_{FC,Z} | mg/L | Eq. 17.53 | 35,621 | 35,628 |
| Concentration Channel | | | ${C}_{FC , Z} = \frac{{Q}_{F} \cdot {C}_{F -} {M}_{S , Z}}{{Q}_{FC , Z}}$ | | |
| Osmotic Pressure in Feed- | π_{FC,Z} | bar | Eq. 17.7 | 24.55 | 24.55 |
| Concencentration Channel | | | π_{PC,z} = iØCHT | | |
| Permeate Flow Rate per | | | | | |
| increment | | | | | |
| Permeate Flow Rate | Q_{P,Z} | m3/s | Q_{P,Z} = J_{W,z}(W)(dz) | 4.43E−05 | 4.43E−05 |
| per increment | | | | | |
| Permeate Flow Rate | Q_{P,Z} | m3/day | Q_{P,Z} = J_{W,z}(W)(dz) | 3.83 | 3.83 |
| per increment | | | | | |
| Permeate Flow Rate | Q_{P,Z} | L/m | Q_{P,Z} = J_{W,z}(W)(dz) | 2.66 | 2.66 |
| per increment | | | | | |
| Permeate at the Permeate | P_{P,Z} | bar | Measured from | 0.83 | 0.83 |
| side of Membrane | | | Experiment | | |
| Pcf : Calculate the average | C_{P,Z} | mg/L | Eq. 17.58 | 1228.69 | 1275.89 |
| solute concentration in the permeate : mg/L | | | ${C}_{P , Z} = \frac{{J}_{S , Z}}{{J}_{W , Z}}$ | | |

| Description | 3 | 4 | 5 | 6 |
|---|---|---|---|---|
| Osmotic pressure difference | 23.65 | 23.62 | 23.58 | 23.55 |
| over membrane : bar | | | | |
| Hydratic Head Loss of | 0.0380 | 0.0365 | 0.0351 | 0.0337 |
| Feed-Concentrate Channel | | | | |
| Concentrate in Feed- | 35,636 | 35,644 | 35,652 | 35,661 |
| Concentrate Channel | | | | |
| Osmotic Pressure in Feed- | 24.56 | 24.57 | 24.57 | 24.58 |
| Concentrate Channel | | | | |
| Permeate Flow Rate per | | | | |
| increment | | | | |
| Permeate Flow Rate | 4.43E−05 | 4.43E−05 | 4.43E−05 | 4.43E−05 |
| per increment | | | | |
| Permeate Flow Rate | 3.83 | 3.83 | 3.83 | 3.83 |
| per increment | | | | |
| Permeate Flow Rate | 2.66 | 2.66 | 2.66 | 2.66 |
| per increment | | | | |
| Pressure at the Permeate | 0.83 | 0.83 | 0.83 | 0.83 |
| side of Membrane | | | | |
| Pcf : Calculation | 1325.86 | 1378.84 | 1435.07 | 1494.82 |
| the average | | | | |
| solute concentration in | | | | |
| the permeate : mg/L | | | | |
| Description | 7 | 8 | 9 | 10 |
| Osmotic pressure difference | 23.21 | 23.52 | 23.53 | 23.53 |
| over membrane : bar | | | | |
| Hydratic Head Loss of | 0.0324 | 0.0310 | 0.0297 | 0.0284 |
| Feed-Concentrate Channel | | | | |
| Concentrate in Feed- | 35,671 | 35,681 | 35,692 | 35,704 |
| Concentrate Channel | | | | |
| Osmotic Pressure in Feed- | 24.58 | 24.59 | 24.60 | 24.61 |
| Concentrate Channel | | | | |
| Permeate Flow Rate per | | | | |
| increment | | | | |
| Permeate Flow Rate | 4.43E−05 | 4.43E−05 | 4.43E−05 | 4.43E−05 |
| per increment | | | | |
| Permeate Flow Rate | 3.83 | 3.83 | 3.83 | 3.83 |
| per increment | | | | |
| Permeate Flow Rate | 2.66 | 2.66 | 2.66 | 2.66 |
| per increment | | | | |
| Pressure at the Permeate | 0.83 | 0.83 | 0.83 | 0.83 |
| side of Membrane | | | | |
| Pcf : Calculation | 1558.38 | 1626.10 | 1698.34 | 1774.52 |
| the average | | | | |
| solute concentration in | | | | |
| the permeate : mg/L | | | | |

| | | | Reference : MWH Global, | | |
|---|---|---|---|---|---|
| | | | Inc. revised by John C. | | |
| | | | Crittenden, R. Rhodes Trussell, | | |
| | | | David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America , | | |
| | ment | | 2005 ; Chapter 12, Chapter 17, | | |
| Description | Z | Unit | Chapter 20 to Chapter 22. | 1 | 2 |
| Active Membrane Area of | | sqm | | 29.0466 | 29.0466 |
| Element : sqm | | | | | |
| w : The with can | | m | Eq. 17.4 | 29.6394 | 29.6394 |
| bedetarmined by divinding the membrane | | | $w = \frac{a}{L}$ | | |
| area by the elements length : m | | | | | |
| Osmotic Pressure at the | π_{P,Z} | bar | Eq. 17.7 | 0.85 | 0.88 |
| Permeate side of Membrane | | | π_{PC,Z} = iØCRT | | |
| DL : Diffusion coefficient | | | | 1.35E−09 | 1.35E−09 |
| for solute in water : m2/s | | | | | |
| Reynolds Number in Feed- | Re_{reynolds} | Unitless | Eq. 17.36 | 161 | 158 |
| Concentrate Channel | | | $Re = \frac{ρ v {d}_{H}}{μ}$ | | |
| Schimt Number in Feed- | Sc_{Schmidt} | Unitless | Eq. 17.37 | 750 | 750 |
| Concentrate Channel | | | $Sc = \frac{μ}{ρ {D}_{L}}$ | | |
| Concentration Polarization | k_{CP,Z} | m/s | Eq. 17.35 | | |
| mass transfer coefficient | | | ${k}_{CP , Z} = 0.023 \cdot \frac{{D}_{L}}{{d}_{H}} \cdot {( Re )}^{0.83} {Sc}^{0.33}$ | 1.25E−05 | 1.23E−05 |
| Part of Eq: 17-54 for | Unitless | Eq. 17.54 | Eq. 17.54 | | |
| concentration Concentration Polarization Factor | β_{,Z} | Unitless | ${β}_{Z} = Rej ( {e}^{\frac{- {J}_{W , Z}}{{k}_{CP , Z}}} ) + ( 1 - Rej )$ | −0.41710 0.67 | −0.41710 0.67 |

| Description | 3 | 4 | 5 | 6 |
|---|---|---|---|---|
| Active Membrane Area of | 29.0466 | 29.0466 | 29.0466 | 29.0466 |
| Element : sqm | | | | |
| w : The with can bedetarmined by | 29.6394 | 29.6394 | 29.6394 | 29.6394 |
| divinding the membrane area by | | | | |
| the elements length : m | | | | |
| Osmotic Pressure at the π_{P,Z} | 0.91 | 0.95 | 0.99 | 1.03 |
| Permeate side of Membrane | | | | |
| DL : Diffusion coefficient | 1.35E−09 | 1.35E−09 | 1.35E−09 | 1.35E−09 |
| for solute in water : m2/s | | | | |
| Reynolds Number in Feed- Re_{reynolds} | 155 | 152 | 149 | 146 |
| Concentrate Channel | | | | |
| Schimt Number in Feed- Sc_{Schmidt} | 750 | 750 | 750 | 750 |
| Concentrate Channel | | | | |
| Concentration Polarization k_{CP,Z} | 1.21E−05 | 1.19E−05 | 1.17E−05 | 1.15E−05 |
| mass transfer coefficient | | | | |
| Part of Eq: 17-54 for Concentration | −0.41710 | −0.41710 | −0.41710 | −0.41710 |
| Concentration Polarization β_{,Z} | 0.67 | 0.67 | 0.67 | 0.67 |
| Factor | | | | |
| Description | 7 | 8 | 9 | 10 |
| Active Membrane Area of | 29.0466 | 29.0466 | 29.0466 | 29.0466 |
| Element : sqm | | | | |
| w : The with can bedetarmined | 29.6394 | 29.6394 | 29.6394 | 29.6394 |
| by divinding the membrane | | | | |
| area by the elements length : m | | | | |
| Osmotic Pressure at the π_{P,Z} | 1.07 | 1.07 | 1.07 | 1.07 |
| Permeate side of Membrane | | | | |
| DL : Diffusion coefficient | 1.35E−09 | 1.35E−09 | 1.35E−09 | 1.35E−09 |
| for solute in water : m2/s | | | | |
| Reynolds Number in Feed- Re_{reynolds} | 143 | 141 | 138 | 135 |
| Concentrate Channel | | | | |
| Schimt Number in Feed- Sc_{Schmidt} | 750 | 750 | 750 | 750 |
| Concentrate Channel | | | | |
| Concentration Polarization k_{CP,Z} | 1.13E−05 | 1.12E−05 | 1.10E−05 | 1.08E−05 |
| mass transfer coefficient | | | | |
| Part of Eq: 17-54 for Concentration | −0.41710 | −0.41710 | −0.41710 | −0.41710 |
| Concentration Polarization β_{,Z} | 0.67 | 0.67 | 0.67 | 0.67 |
| Factor | | | | |

| | | | Reference : MWH Global, | | |
|---|---|---|---|---|---|
| | | | Inc. revised by John C. | | |
| | | | Crittenden, R. Rhodes Trussell, | | |
| | | | David W. Hand, | | |
| | | | Kerry J. Howe, George | | |
| | | | Tchobanoglous ; Water | | |
| | | | Treatment: Principles of | | |
| | | | Design : 2nd edition ; | | |
| | Incre- | | United States of America, 2005 ; | | |
| | ment | | Chapter 12, Chapter 17, | | |
| Description | Z | Unit | Chapter 20 to Chapter 22. | 1 | 2 |
| Jw : volmetric flux of | J_{W,Z} | L/m2 · h | Eq. 17.48 | 53.81 | 53.81 |
| water : I/h · sqm | | | J_{W,Z} = kw_{W,Z}[(PCF_{F,Z} − | | |
| | | | P_{P,Z}) − (β_{Z} * π_{FC,Z} − π_{P,Z})] | | |
| Kw : Mass transfer | kw_{w,Z} | L/m2 · | Eq. 17.9 | 23.05 | 22.49 |
| coefficient for water flux: L/sqm · h · bar | | h · bar | ${kw}_{W , Z} = \frac{{J}_{W , Z}}{\begin{matrix}[ ( {PCF}_{F , Z} - {P}_{P , Z} ) - \\ ( {β}_{Z} * {π}_{FC , Z} - {π}_{P , Z} ) ]\end{matrix}}$ | | |
| Ks : Solute mass transfer | ks_{S,Z} | L/m2 · h | Eq. 17.10 | 1.76 | 1.76 |
| coefficient for solute flux (Eq 17.10): L/sqm · h | | | ${k}_{S , Z} = \frac{{J}_{S , Z}}{( Δ C )}$ | | |
| Solute Flux of Member | J_{S,Z} | mg/m2 · h | Eq. 17.49 | 39,776,453 | 39,701,827 |
| | | | J_{S,Z} = kₛ(β_{Z} · C_{FC,Z} − C_{P,Z}) | | |
| Solute Transport across | M_{Z} | mg/s | M_{S,Z} = J_{S,Z}(w)(dz) | 32748.60 | 32687.16 |
| Membrane | | | | | |
| Solute Transport across | M_{Z} | % | Increase factor of solute | 0.19% | 0.20% |
| Membrane | | | over membrane | | |
| Rej: The fraction of | Rej_{z} | Unitless | | 96.93% | 96.93% |
| material remove from | | | | | |
| permeate stream: | | | | | |
| dimensionless | | | | | |

| Description | 3 | 4 | 5 | 6 |
|---|---|---|---|---|
| Jw : volmetric flux of | 53.81 | 53.81 | 53.81 | 53.81 |
| water : 1/h · sqm | | | | |
| Kw : Mass transfer coefficient | 21.94 | 21.37 | 20.81 | 20.24 |
| for water flux: L/sqm · ft · bar | | | | |
| Ks : Solute mass transfer | 1.76 | 1.76 | 1.76 | 1.76 |
| coefficient for solute | | | | |
| flux (Eq. 17.10): L/sqm · h | | | | |
| Solute Flux of Membrane | 39,622,838 | 39,539,097 | 39,450,236 | 39,355,829 |
| Solute Transport across | 32622.13 | 32553.18 | 32480.02 | 32402.30 |
| Membrane | | | | |
| Solute Transport across | 0.21% | 0.22% | 0.24% | 0.25% |
| Membrane | | | | |
| Rej: The fraction of material | 96.93% | 96.93% | 96.93% | 96.93% |
| remove from permeate | | | | |
| stream:dimensionless | | | | |
| Description | 7 | 8 | 9 | 10 |
| Jw : volmetric flux of | 53.81 | 53.81 | 53.81 | 53.81 |
| water : 1/h · sqm | | | | |
| Kw : Mass transfer coefficient | 19.67 | 19.75 | 19.84 | 19.93 |
| for water flux: L/sqm · ft · bar | | | | |
| Ks : Solute mass transfer | 1.76 | 1.76 | 1.76 | 1.76 |
| coefficient for solute | | | | |
| flux (Eq. 17.10): L/sqm · h | | | | |
| Solute Flux of Membrane | 39,255,405 | 39,148,440 | 39,034,353 | 38,912,496 |
| Solute Transport across | 32319.62 | 32231.55 | 32137.62 | 32037.29 |
| Membrane | | | | |
| Solute Transport across | 0.27% | 0.29% | 0.31% | 0.33% |
| Membrane | | | | |
| Rej: The fraction of material | 96.93% | 96.93% | 96.93% | 96.93% |
| remove from permeate | | | | |
| stream:dimensionless | | | | |

[symbol]

indicates data missing or illegible when filed

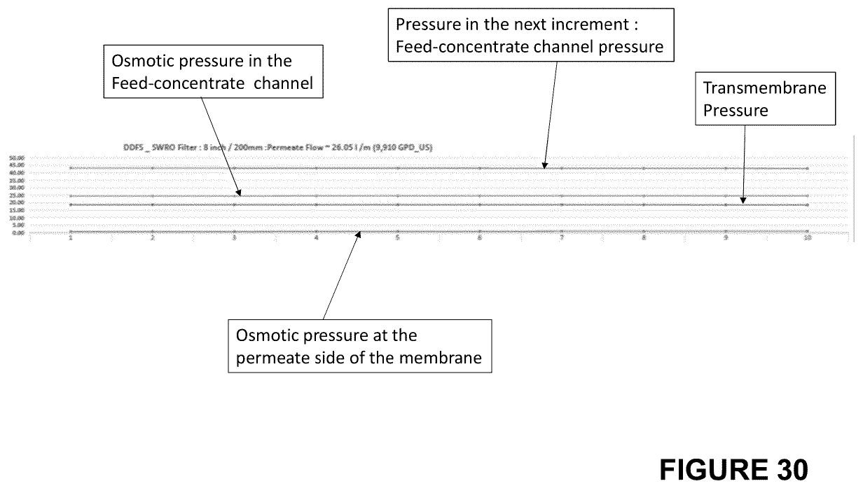

At a feed flow of 283.3 L/m (107,785 GPD), operational pressure of 624 psi (43.2 bar) at about 20° C., Reynolds number of 147, concentration polarization factor of 0.67, and transmembrane pressure of 18.73 bar, the following pressures (bar) measured and plotted in FIG. 30:
pressure in the next increment: feed-concentration channel pressure)
transmembrane pressure
osmotic pressure in the feed-concentrate channel
osmotic pressure at the permeate side of the membrane

| | Increment | | | | | | | | | |
|---|---|---|---|---|---|---|---|---|---|---|
| Pressure | 1 | 2 | 3 | 4 | 5 | 6 | 7 | 8 | 9 | 10 |
| Next increment: | 43.26 | 43.22 | 43.18 | 43.15 | 43.11 | 43.08 | 43.05 | 43.01 | 42.99 | 42.96 |
| feed-concentrate | | | | | | | | | | |
| channel | | | | | | | | | | |
| Trans membrane | 18.73 | 18.72 | 18.71 | 18.70 | 18.70 | 18.70 | 18.71 | 18.67 | 18.63 | 18.60 |
| Osmotic in feed- | 24.55 | 24.56 | 24.56 | 24.57 | 24.57 | 24.58 | 24.58 | 24.59 | 24.60 | 24.61 |
| concentrate | | | | | | | | | | |
| channel | | | | | | | | | | |
| Osmotic at the | 0.85 | 0.88 | 0.91 | 0.95 | 0.99 | 1.03 | 1.07 | 1.07 | 1.07 | 1.07 |
| permeate side of | | | | | | | | | | |
| membrane | | | | | | | | | | |

This example also may be performed by increasing the membrane area by about 15 m², i.e., about 34 m² or by lowering the membrane area by about 10 m², i.e., to about 15 m².

When ranges are used herein, all combinations, and subcombinations of ranges for specific embodiments therein are intended to be included.

The disclosures of each patent, patent application, and publication cited or described in this document are hereby incorporated herein by reference, in its entirety.

Those skilled in the art will appreciate that numerous changes and modifications can be made to the preferred embodiments of the invention and that such changes and modifications can be made without departing from the spirit of the invention. It is, therefore, intended that the appended claims cover all such equivalent variations as fall within the true spirit and scope of the invention.

What is claimed:

1. A reverse osmosis filter element for separating a first component from a fluid mixture comprising the first component and a second component, the filter element comprising:
multiple self-supporting membrane vanes (28) attached substantially perpendicularly to a tube (401) and spaced apart about the tube (401) to provide a minimum hydraulic diameter of the filter element of at least about 1 mm, each membrane vane comprising at least one porous supporting strip (200), each strip comprising a reverse osmosis membrane layer (100) disposed thereon:
a permeate flow channel (210) defined by an inner surface of the at least one porous supporting strip (200); and
a feed water flow channel (300) dispersed around the membrane vane (28).

2. The filter element of claim 1, wherein the multiple self-supporting membrane vanes comprise about 8 to about 96 membrane vanes, about 8 to about 24 membrane vanes, about 35 to about 52 membrane vanes, or about 79 to about 96 membrane vanes.

3. The filter element of any of the preceding claims, wherein the height of each of the membrane vanes is about 28 to about 100 mm, about 21 to about 31 mm, about 37 to about 57 mm, or about 84 to about 104 mm.

4. The filter element of any of the preceding claims, wherein an active membrane area of the filter element is about 0.4 to about 16 m², about 0.4, 0.90 to about 0.96 m², about 3.65 to about 3.8 m², or about 15.25 to about 15.6 m².

5. The filter element of any of the preceding claims, wherein a thickness of each of the at least one porous supporting strips is about 1.5 to about 2.5 mm or 1.9 mm.

6. The filter element of any of the preceding claims, wherein the tube is a supporting structure of the membrane vanes.

7. The filter element of any of the preceding claims, wherein the tube comprises an inner canal (400).

8. The filter element of claim 7, wherein an outer diameter of an inner canal side is about 30 to about 250 mm, about 35 to about 55 mm, about 80 to about 120 mm, or about 180 to about 22 mm.

9. The filter element of any of the preceding claims, wherein the tube comprises holes along the length of the tube and said membrane vanes are positioned over said holes.

10. The filter element of any of the preceding claims, wherein a pore size of the reverse osmosis membrane layer is about 0.001μ to about 10μ.

11. The filter element of any of the preceding claims, wherein a tensile strength of the reverse osmosis membrane layer is about 25,000 to about 50,000 psi.

12. The filter element of any of the preceding claims, wherein a yield strength at 0.2% offset of the reverse osmosis membrane layer is about 15,000 to about 30,000 psi.

13. The filter element of any of the preceding claims, wherein an elongation of the reverse osmosis membrane layer is about 5 to about 20%.

14. The filter element of any of the preceding claims, wherein a tensile modulus of elasticity of the reverse osmosis membrane layer is about 10×10⁶ to about 15×10⁶ psi.

15. The filter element of any of the preceding claims, wherein a pore size of the at least one porous supporting strip is larger than a pore size of the reverse osmosis membrane layer.

16. The filter element of any of the preceding claims, wherein the pore size of the at least one porous supporting strip is about 0.1 to about 50μ.

17. The filter element of any of the preceding claims, wherein a total cross sectional area of the membrane vanes is about 0.0015 to about 0.04 m², about 0.00170 to about 0.0018 m², about 0.0093 to about 0.0099 m², or about 0.038 to about 0.40 m².

18. The filter element of any of the preceding claims, wherein the at least one porous supporting strip and the reverse osmosis membrane layer are fused along three sides.

19. The filter element of any of the preceding claims, wherein the reverse osmosis membrane layer has a thickness of about 1 to about 4 mm.

20. The filter element of any of the preceding claims, wherein each reverse osmosis membrane layer is laminated onto each of the at least one porous supporting strips, and wherein each porous laminated membrane vane has a thickness of about 1 to about 4 mm.

21. The filter element of any of the preceding claims, wherein an average hydraulic diameter is about 2 to about 5 mm or 2.28 mm to 4.68 mm.

22. The filter element of any of the preceding claims, wherein a diameter of the filter element is about 50 to about 500 mm.

23. The filter element of any of the preceding claims, wherein a total active membrane area of each of the at least one porous supporting strips is about 0.4 to about 1 m².

24. The filter element of any of the preceding claims, which has enhanced concentrate flow movement and potential energy recovery.

25. The filter element of any of the preceding claims, wherein no spacer elements are positioned within the feed water flow channel or the permeate flow channel.

26. The filter element of any of the preceding claims, wherein said reverse osmosis membrane layer has a monolithic, controlled permeability media comprising multiple layers of stainless steel wire mesh.

27. The filter element of any of the preceding claims, wherein said at least one porous supporting strip comprises stainless steel.

28. The filter element of claim 27, wherein said stainless steel supporting strips comprise a wire mesh.

29. The filter element of claim 28, wherein said stainless steel wire mesh is laminated by precision sintering and calendaring.

30. The filter element of claim 28, wherein said stainless steel supporting strips comprise 100% AISI type 316 stainless steel.

31. The filter element of claim 1, wherein said reverse osmosis membrane layer (100) comprises a corrosion resisting alloy.

32. The filter element of claim 1, wherein said reverse osmosis membrane layer (100) comprises carbon composites, ceramic composites, polymer type composites, polyamide, or combinations thereof.

33. The filter element of any of the preceding claims, wherein said membrane vanes do not wind around said tube.

34. The filter element of any of the preceding claims, which can withstand pressures up to about 100 psi.

35. The filter element of any of the preceding claims, wherein the membrane vanes are equally spaced apart about a circumference of the tube (401), and wherein the spacing of the membrane vanes provides the minimum hydraulic diameter of the filter element of about 2.4 mm.

36. A method for preparing the filter element of claim 1, said method comprising:
(i) applying a first reverse osmosis membrane layer (L2) to a first porous supporting strip to form a first porous membrane supporting strip;
(ii) applying a second reverse osmosis membrane layer (L2) to a second porous supporting strip to form a second porous membrane supporting strip;
(iii) fusing said first and second porous membrane supporting strips to form a membrane vane; and
(iv) attaching said membrane vane to a tube, wherein the membrane vane is positioned over holes on said tube.

37. The method of claim 36, wherein step (iii) is performed using an epoxy infusion process.

38. The method of claim 36 or 37, wherein step (iii) creates a waterproof seal.

39. The method of claim 36, wherein the edges of said first and second porous membrane supporting strips are fused using epoxy.

40. The method of claim 36, further comprising sealing the feed water flow channel (300) with end covers (215).

41. A method of filtering components of a fluid mixture, said method comprising passing said fluid mixture through at least one filter element of any one of claims 1 to 28 in a pressure vessel.

42. The method of claim 41, wherein a feed concentration of the fluid mixture is about 1,000 to about 50,000 ppm per filter element.

43. The method of claim 41, wherein an area per filter element is about 0.1 to about 25 m².

44. The method of claim 41, wherein a permeate flow rate per element is about 2 to about 500 m³/day.

45. The method of claim 41, comprising about 5 filter elements, wherein a net driving pressure is about 2 to about 25 bar.

46. The method of claim 41, comprising at least about 8 filter elements.

47. The method of claim 41, wherein a total length of the filter elements is about 1000 mm.

48. The method of claim 41, further comprising a means for applying a pressure.

49. The method of claim 48, further comprising about 5 filter elements, wherein a total length of the filter elements is about 1000 mm, a diameter of each filter element is about 75 to about 125 mm, a feed concentration is about 1400 to about 1600 ppm, a permeate flow rate per filter element is about 10 to about 20 m³ day, an area per filter element is about 0.75 to about 1.25 m², and a pressure is about 2 to about 3 bar.

50. The method of claim 48, further comprising about 5 filter elements, wherein a total length of the filter elements is about 1000 mm, a diameter of each filter element is about 175 to about 225 mm, a feed concentration is about 1400 to about 1600 ppm, a permeate flow rate per filter element is about 55 to about 70 m³ day, an area per filter element is about 3 to about 5 m², and a pressure is about 2 to about 3 bar.

51. The method of claim 48, further comprising about 5 filter elements, wherein a total length of the filter elements is about 1000 mm, a diameter of each filter element is about 375 to about 425 mm, a feed concentration is about 1400 to about 1600 ppm, a permeate flow rate per filter element is about 240 to about 260 m³ day, an area per filter element is about 10 to about 20 m², and a pressure is about 2 to about 3 bar.

52. The method of claim 48, further comprising about 5 filter elements, wherein a total length of the filter elements is about 1000 mm, a diameter of each filter element is about 75 to about 125 mm, a feed concentration is about 14000 to about 16000 ppm, a permeate flow rate per filter element is about 5 to about 12 m³ day, an area per filter element is about 0.75 to about 1.25 m², and a pressure is about 7 to about 13 bar.

53. The method of claim 48, further comprising about 5 filter elements, wherein a total length of the filter elements is about 1000 mm, a diameter of each filter element is about 175 to about 225 mm, a feed concentration is about 14000 to about 16000 ppm, a permeate flow rate per filter element is about 30 to about 40 m³ day, an area per filter element is about 3 to about 5 m², and a pressure is about 7 to about 13 bar.

54. The method of claim 48, further comprising about 5 filter elements, wherein a total length of the filter elements is about 1000 mm, a diameter of each filter element is about 375 to about 425 mm, a feed concentration is about 14000 to about 16000 ppm, a permeate flow rate per filter element is about 130 to about 140 m³ day, an area per filter element is about 10 to about 20 m², and a pressure is about 7 to about 13 bar.

55. The method of claim 48, further comprising about 5 filter elements, wherein a total length of the filter elements is about 1000 mm, a diameter of each filter element is about 75 to about 125 mm, a feed concentration is about 30000 to about 40000 ppm, a permeate flow rate per filter element is about 2 to about 3.5 m³ day, an area per filter element is about 0.75 to about 1.25 m², and a pressure is about 17 to about 23 bar.

56. The method of claim 48, further comprising about 5 filter elements, wherein a total length of the filter elements is about 1000 mm, a diameter of each filter element is about 175 to about 225 mm, a feed concentration is about 30000 to about 40000 ppm, a permeate flow rate per filter element is about 7 to about 15 m³ day, an area per filter element is about 3 to about 5 m², and a pressure is about 17 to about 23 bar.

57. The method of claim 48, further comprising about 5 filter elements, wherein a total length of the filter elements is about 1000 mm, a diameter of each filter element is about 375 to about 425 mm, a feed concentration is about 30000 to about 40000 ppm, a permeate flow rate per filter element is about 40 to about 50 m³ day, an area per filter element is about 10 to about 20 m², and a pressure is about 17 to about 23 bar.

58. The method of any one of claims 41 to 57, wherein the fluid mixture comprises brackish water.

59. The method of any one of claims 41 to 58, wherein said pressure vessel comprises about 5 filter elements, a diameter of the pressure vessel is about 50 mm to about 500 mm, and about 0.05 to about 1 Kw/h/m³ of energy is consumed.

60. The method of any one of claims 41 to 59, wherein said pressure vessel comprises about 5 filter elements, a diameter of the pressure vessel is about 50 mm to about 500 mm, and about 1 to about 5 psi (5 to 35 kPa) of hydraulic pressure is lost.

61. A system for filtering a fluid mixture, said system comprising:
(a) a low-pressure pump (10);
(b) at least one pretreatment filter (12);
(c) a high-pressure pump (14);
(d) at least one filter element (16) of any one of claims 1 to 34; and
(e) a vessel (18) for collected filtered fluid mixture.

62. The system of claim 61, further comprising an energy recovery device (24).

63. The system of claim 62, wherein said energy recovery device (24) is in fluid communication with said low-pressure pump and said high-pressure pump via a first conduit (26) and a second conduit (28), respectively.

64. The system of claim 61, further comprising an energy storage device (26).

65. The system of claim 61, wherein said energy storage device is in fluid communication with said at least one filter element via storage conduit (30).

66. The system of claim 61, further comprising a device (36) for recycling the fluid mixture.

67. The system of any of claims 61 to 66, wherein said energy recovery device (24) is in fluid communication with said energy storage device (24), said device (36), or combinations thereof via a first recovery conduit (32) or a second recovery conduit (34).

68. A reverse osmosis filter element for separating a first component from a fluid mixture comprising the first component and a second component, the filter element comprising:
at least two membrane (filtering) vanes attached to a permeate conduit and spaced apart to provide a minimum hydraulic diameter between adjacent membrane (filtering) vanes of about 2, each membrane (filtering) vane comprising a reverse osmosis membrane layer disposed on a porous substrate, the reverse osmosis membrane oriented to be adjacent to the fluid mixture when in use; and
at least one permeate flow channel within each membrane (filtering) vane, the permeate flow channel disposed adjacent to the porous substrate, the permeate flow channel in fluidic communication with the permeate conduit.

69. A method of generating electricity from salty water, said method comprising the steps of:
filtering said salty water through at least one filter element of any one of claims 1 to 28 in a pressure vessel to give rise to a permeate containing less salt than said salty water,
pumping the salty water and permeate in a reverse electrodialysis process, wherein the salty water and permeate flow under pressure through a stack of alternating cation and anion exchange membranes such that a chemical potential difference between the salty water and permeate generates an electric potential (voltage) over each membrane, wherein a total electric potential of the system is the sum of the potential differences over all membranes.

70. A reverse electrodialysis system for generating electricity from salty water, the system comprising:
one or more filter elements according to any one of claims 1 to 28 disposed in a pressure vessel, wherein filtering said salty water through the pressure vessel gives rise to a permeate containing less salt than said salty water,
a stack of alternating cation and anion exchange membranes disposed in a reverse electrodialysis vessel, wherein pumping the salty water and permeate through the reverse electrodialysis vessel gives rise to a chemical potential difference between the salty water and permeate thereby generating an electric potential (voltage) over each membrane, wherein a total electric potential of the system is the sum of the potential differences over all membranes.
